(19) United States
(12) Patent Application Publication
(10) Pub. No.: US 2026/0107264 A1
(43) Pub. Date: Apr. 16, 2026

(54) METHODS, PROCEDURES, AND APPARATUS FOR LOW PEAK-TO-AVERAGE-POWER RATIO (PAPR) PREAMBLE TRANSMISSION FOR DISTRIBUTED RESOURCE UNITS (DRUS)

(71) Applicant: InterDigital Patent Holdings, Inc., Wilmington, DE (US)

(72) Inventors: Alphan Sahin, Westbury, NY (US); Mahmoud Saad, Montreal (CA); Mrugen Deshmukh, Raleigh, NC (US); Hanqing Lou, Syosset, NY (US); Ying Wang, Easton, PA (US); Rui Yang, Greenlawn, NY (US)

(73) Assignee: InterDigital Patent Holdings, Inc., Wilmington, DE (US)

(21) Appl. No.: 18/917,825

(22) Filed: Oct. 16, 2024

(51) Int. Cl. H04W 72/0453; H04L 5/00

(52) U.S. Cl. CPC H04W 72/0453; H04L 5/0094

(57) ABSTRACT

A STA receives information indicating a distribution bandwidth and a set of distributed resource units (DRUs) from a plurality of DRU allocations for the distribution bandwidth. The STA determines a first DRU long training field (LTF) sequence associated with a first DRU of the set of DRUs. The first DRU LTF includes a first component and a second component which are a first complementary sequence based on a Golay complementary pair (GCP). The STA determines a second DRU LTF sequence associated with a second DRU of the set, including a third component and at least a fourth component, which are a second complementary sequence based on the GCP. The STA transmits, to an AP, a frame including a physical layer (PHY) preamble including the first DRU LTF and the second DRU LTF, which are associated with a third DRU having a size based on the first and the second DRUs.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration.

### SUMMARY

In an example, a STA receives information indicating a distribution bandwidth and a set of distributed resource units (DRUs) from a plurality of DRU allocations for the distribution bandwidth. Further, each DRU of the set of DRUs includes respective subcarriers. Also, subcarriers of the set of DRUs are interleaved with respect to each other. Additionally or alternatively, the STA is a non-AP STA.

The STA determines a first DRU long training field (LTF) sequence associated with a first DRU of the set of DRUs. In addition, the first DRU LTF sequence includes a first component and at least a second component. Moreover, the first component and the at least second component are a first complementary sequence based on a Golay complementary pair (GCP).

Further, the STA determines a second DRU LTF sequence associated with a second DRU of the set of DRUs. Also, the second DRU LTF sequence includes a third component and at least a fourth component. Additionally, the third component and the at least fourth component are a second complementary sequence based on the GCP.

Moreover, the STA transmits, to an AP, a frame including a physical layer (PHY) preamble including the first DRU LTF sequence and the second DRU LTF sequence. Further, the first DRU LTF sequence and the second DRU LTF sequence are associated with a third DRU having a size based on the first and the second DRUs.

Additionally or alternatively, the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}). Further, the second complementary sequence based on the GCP comprises a seed GCP including complimentary seed sequences (sₐ, s_{b}).

Also, each of the complimentary seed sequences is respectively multiplied by a second complex number (w_{a,2}) and a third complex number (w_{b,2}). Moreover, the first and the second complementary sequences are a complementary pair.

Additionally or alternatively, sₐ=(1, 1, 1, 1i, −1, 1, 1, −1i,1, −1, 1,−1i,1i) and s_{b}=(11i−1−1−11i−1 11−1i−11−1i). Additionally or alternatively, the distribution bandwidth is 20 megahertz (Mhz). Additionally or alternatively, the distribution bandwidth is 40 Mhz. Additionally or alternatively, the distribution bandwidth is 80 Mhz.

Additionally or alternatively, the first DRU is a 26-tone DRU. Additionally or alternatively, the second DRU is a 26-tone DRU. Additionally or alternatively, the third DRU is a 52-tone DRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal power diagram illustrating an example of how orthogonal frequency division multiplexed (OFDM) signals using the complementary sequences (CSs) in a Golay complementary pair (GCP) (a, b) complement each other; and

FIG. 3 is a flowchart diagram illustrating an example of a determination and transmission of a distributed resource unit (DRU) long training field (LTF) sequence using CSs.

### DETAILED DESCRIPTION

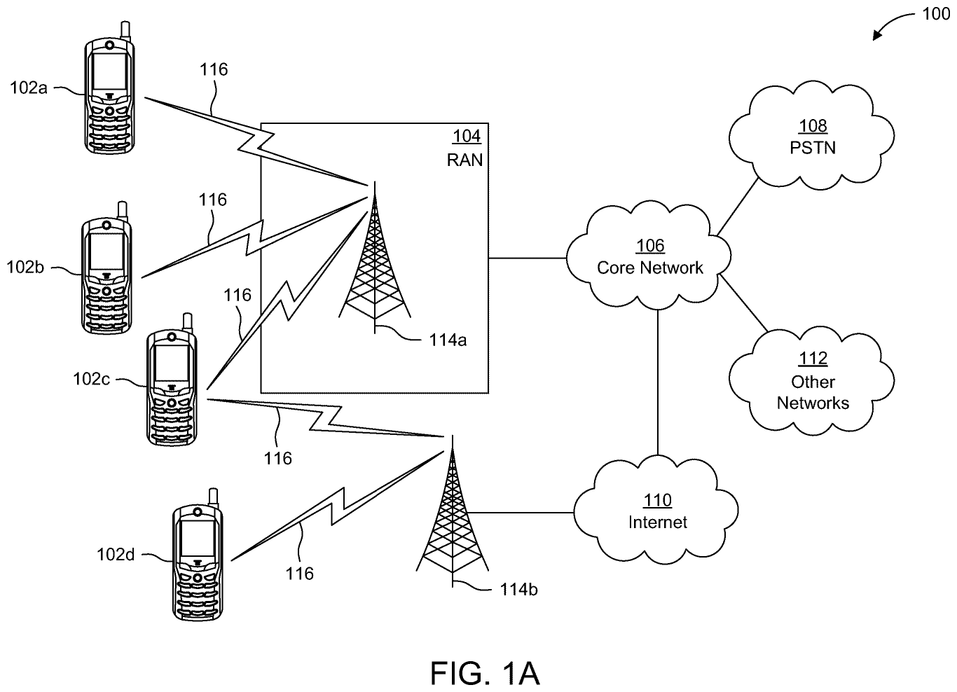

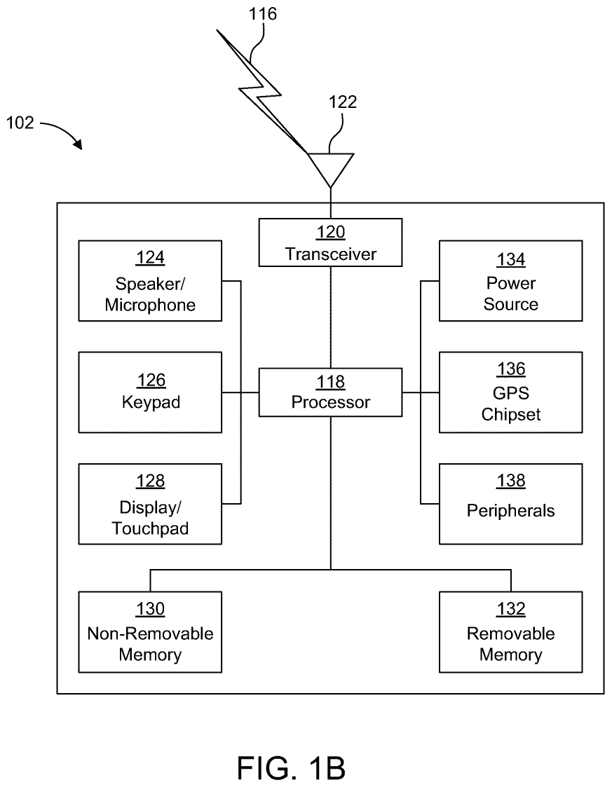

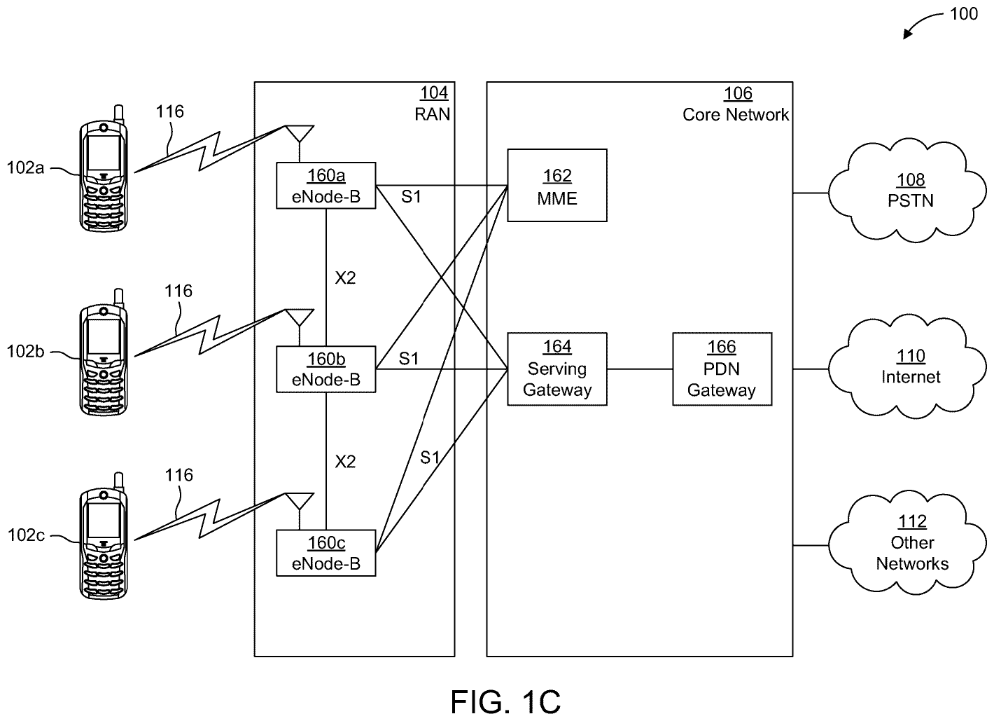

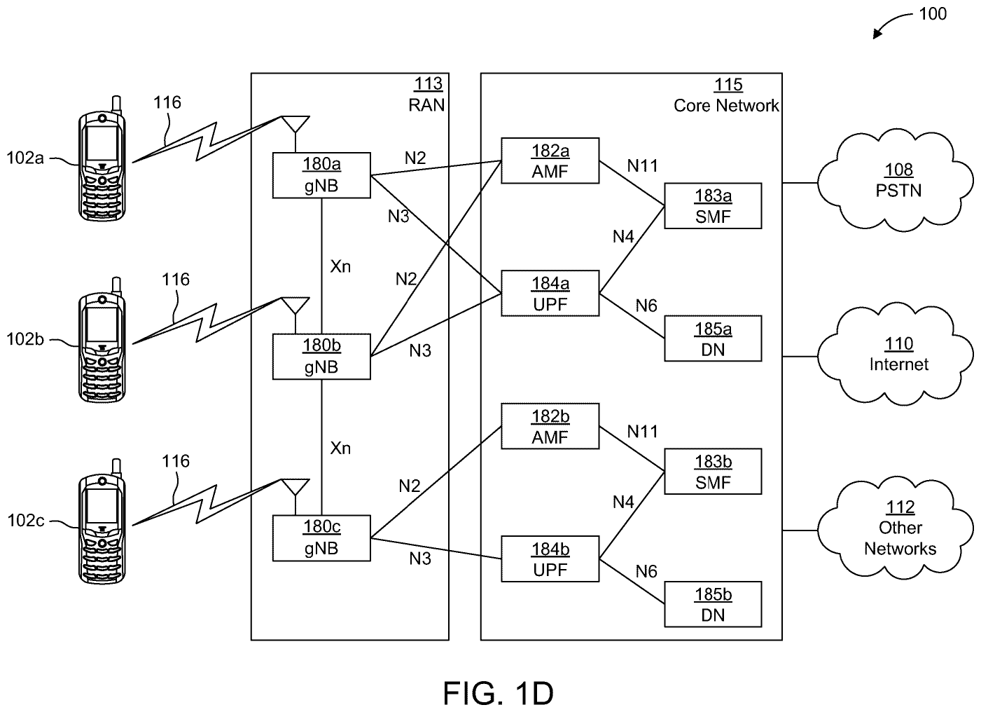

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), avehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 megahertz (MHz) wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as binary phase shift keying (BPSK), QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

For an 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC layer.

As noted above, in 802.11 ax, High Efficiency (HE) Wireless STAs may support 20 MHz, 40 MHz, 80 MHz, and/or 160 MHz wide channels capable of transmission over 2.4 GHz, 5 GHz, and 6 GHz frequency bands using both OFDMA and MU-MIMO capabilities. OFDMA subcarrier modulation in HE STAs includes formats such as BPSK, QPSK, 16-QAM, 64-QAM, 256-QAM, and 1024-QAM. The evolution of 802.11 to EHT or (802.11be) STAs extend to having 320 MHz wide channels.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, 802.11ah, 802.11AX, and 802.11be, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

The IEEE 802.11 Ultra High Reliability (UHR), or 802.11bn, Study Group was formed as the next major revision to the IEEE 802.11 standards following 802.11be (HEW), which is noted above. UHR explores the possibility of improving reliability, supporting further reduced low latency traffic, further increasing peak throughput, improving power saving capabilities, and improving efficiency of the IEEE 802.11 network over HEW.

In IEEE 802.11bn, agreements include the use of a distributed-tone resource unit (DRU) to overcome power spectral density (PSD) in unlicensed channels. With DRUs, the stations (STAs) or users are assigned to the subcarriers (i.e., tones) of orthogonal frequency-division multiple access (OFDMA) that are distributed across a bandwidth, e.g., 20 MHz, 40 MHz, and 80 MHz. It is desirable that the design of DRUs should satisfy several conditions to enable reliable and efficient communications, such as in the following.

The DRU may include distributed tones across the channel bandwidth. The tone allocation for each DRU configuration should spread across the channel bandwidth, e.g., 20 MHz, 40 MHz, or 80 MHz so that it can maximally utilize the transmit power under PSD limitations.

Also, the DRU may include a nested tone allocation. The tone allocation for DRUs should support resource-demanding STAs, i.e., STAs that need a higher number of tones, without blocking other STAs, i.e., no intentional multi-user interference in the uplink during multiple access. One efficient way of addressing this issue is a nested tone allocation where a higher-level DRU (a higher level DRU is a DRU that has a larger number of tones than a lower one) is a combination of lower-level DRUs. For example, if there are four non-intersecting DRU tone allocations with the same number of tones (e.g., 52 tones), the tones for an STA requiring more resources (e.g., 106 tones) may include the tones allocated for two low-level DRUs, but it should not contain any subcarrier indices allocated for the other two low-level DRUs (i.e., the last two low-rank DRUs) in order to not to block other STAs' access to the spectrum. Note that the high-level DRU may include two extra tones not used in any of the four low-level DRUs to reach 106 tones in total. The same procedure can be applied to generate higher-level DRUs, e.g., by combining DRUs with 106 tones. Note that nested DRU tone allocation was proposed in several studies for IEEE 802.11bn.

Further, the DRU may include allow peak-to-average-power ratio (PAPR). To improve the link distance while reducing the adjacent channel interference due to the hardware non-linearity (e.g., power amplifier (PA)), the transmitted signals (for each DRU configuration) should not have large power fluctuations in the time domain as the signals can be clipped or distorted. This is particularly important for fixed signals in transmission (like preambles such as an long-training field (LTF) in IEEE 802.11 networks) that are repeatedly transmitted at each Wi-Fi packet (i.e., physical layer protocol data unit (PPDU)) to aid channel estimation or synchronization. Also, many null data packet transmissions (NDP) in 802.11 for acknowledgment (ACK) signaling purposes exist and use these preambles. Hence, having a low PAPR design is crucial for preambles or reference signals, as they are transmitted in almost every PPDU.

A PAPR is defined as the peak power within one OFDM symbol normalized by the average signal power, expressed in decibels (dB). In general, a lower PAPR is desired for efficient performance of a system. Thus, an LTF sequence that causes the lowest possible PAPR when transmitted using a DRU is considered an optimal DRU-LTF.

Moreover, the DRU may include direct current (DC) tones. The DRU design should also support zero-valued subcarriers at the center of the channel bandwidth. These tones are often called DC tones in OFDM-based communication systems.

One of the challenging problems for DRU is to design fixed signals or preambles, e.g., an LTF, to support DRUs, namely a DRU-LTF, in 802.11 networks, under the constraints above. Designing a low PAPR OFDM signal for a fixed sequence is a well-studied problem in the literature. However, it becomes a challenging design problem when it is considered with the aforementioned nested tone allocation that supports multiple DRUs at various levels. The challenge arises because it is desirable to have a “master” sequence that leads to a low PAPR value when it is parsed for each possible DRU configuration (at all levels) based on the nested tone allocation. An exhaustive search for an optimal sequence for minimum PAPR for DRU configurations is intractable due to the length of these sequences. For instance, in 802.11bn, for a distribution bandwidth of 20 MHz, the sequence length is 242. If each element of this LTF sequence takes the value 1 or the value−1 (i.e., the sequence is BPSK modulated), the search space of such sequence contains 2²⁴²≈7×10⁷² sequences, intractable to evaluate. Evaluation would take longer than the known age of the universe. Accordingly, such a brute force approach is clearly infeasible for practical use in wireless communication. The embodiments and examples provided herein addresses this problem by constructing this sequence by using complementary sequences. This sequence may be used in Wi-Fi but may also be used in other current and future wireless systems.

In embodiments and examples provided herein, a tone may refer to one subcarrier used in DL or UL transmission. A DRU is a resource unit whose subcarriers are spread over a certain bandwidth which is larger than the effective bandwidth occupied by this resource unit. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone while at the same time conforming with the PSD regulations.

Further, a DRU may also be referred to as a tone distributed (TD) RU (TD-RU) or a distributed RU, and still be consistent with the embodiments and examples provided herein. Also, a distribution bandwidth may refer to a bandwidth in which the tones of a set of one or more DRUs are spread on.

A specific DRU may be expressed as xDRUy and may refer to a DRU of x-tones distributed over a distribution bandwidth of y. For example 26DRU20 may refer to a DRU of 26 tones distributed over a distribution bandwidth of 20 MHz. In an example, a 26DRU20 is a 26-tone resource unit (effective bandwidth is ˜2 MHz) with a DRU allocation spread over a distribution bandwidth of 20 MHz. In another example, a 106DRU80 is a 106-tone resource unit (effective bandwidth is ˜8 MHz) with a DRU allocation spread over a distribution bandwidth of 80 MHz. A 20 MHz channel may include up to nine 26DRU20 DRU allocations, four 52DRU20 DRU allocations, or two 106DRU20 DRU allocations. For proper transmission, a channel bandwidth should accommodate the effective bandwidth of the DRUs as well as bandwidth needed for guard, null and DC subcarriers. Further, a specific DRU with a specific tone distribution pattern z may be expressed as xDRUy_z. For example 26DRU20_1 may refer to a DRU of 26 tones evenly distributed over a distribution bandwidth of 20 MHz with a tone distribution pattern 1.

Examples of a sequence, OFDM signal and PAPR definitions are provided in the following. Let pₐ(z) denote a polynomial representation of the sequence a=(a₀, a₁, . . . , a_{N-1}) as:

$${p}_{a} ( z ) = {a}_{N - 1} {z}^{N - 1} + {a}_{N - 2} {z}^{N - 2} + … + {a}_{0} \qquad Eq . 1$$

The following interpretations can be made: The order of z^{k} encodes the position of aₖ in the sequence a. Up sampling the sequence a with a factor of l (denoted as ⬆ₗ {a}):

$${p}_{( {{a}_{0} \underbrace{0 , 0 , … , 0}}_{l - 1 zeros} , {{a}_{1} \underbrace{0 , 0 , … , 0}}_{l - 1 zeros} , … {{a}_{N} \underbrace{0 , 0 , … , 0}}_{l - 1 zeros} )} ( z ) = {p}_{a} ( {z}^{l} ) \qquad Eq . 2$$

Padding m zeros to the beginning of the sequence a (denoted as shiftₘ{a}):

$${p}_{( {\underbrace{0 , 0 , … , 0}}_{m zeros} , a )} ( z ) = {p}_{a} ( z ) {z}^{m} \qquad Eq . 3$$

If the polynomial pₐ(z) is evaluated at

$$z = {e}^{\frac{j 2 π t}{T}}$$

for 0≤t<T, an OFDM signal can be expressed as

$${{x}_{a} ( t ) := {z}^{m} {p}_{a} ( z ) \vert}_{z = {e}^{\frac{j 2 π t}{T}}} \qquad Eq . 4$$

where T is the OFDM symbol duration, and the elements of a, i.e., a₀, a₁, . . . , a_{N-1}, are mapped to the OFDM subcarrier indices m, m+1, . . . m+N−1, respectively. Throughout the disclosure, the indeterminate z will be associated with the time variable t via

$$z = {e}^{\frac{j 2 π t}{T}} ,$$

when it is clear from the context.

Let xₐ(t) be an OFDM symbol. The peak-to-average-power ratio (PAPR) of xₐ(t) can be defined as:

$$PAPR ( {x}_{a} ( t ) ) := \frac{{max}_{t} ( {\vert {x}_{a} ( t ) \vert}^{2} )}{E [ {\vert {x}_{a} ( t ) \vert}^{2} ]} = \frac{{max}_{t} ( {\vert {x}_{a} ( t ) \vert}^{2} )}{{‖ a ‖}_{2}^{2}} = \frac{{max}_{\vert z \vert = 1} ( {p}_{a} ( z ) {p}_{{a}^{*}} ( {z}^{- 1} ) )}{{‖ a ‖}_{2}^{2}} \qquad Eq . 5$$

as E[|xₐ(t)|²] is mean power and equal to

$${‖ a ‖}_{2}^{2} := {\sum }_{n} {\vert {a}_{n} \vert}^{2}$$

(the norm of) based on Parseval's theorem. Further:

$${\vert {x}_{a} ( t ) \vert}^{2} = {p}_{a} ( z ) {p}_{{a}^{*}} ( {z}^{- 1} ) = {ρ}_{a} ( 0 ) + {\sum }_{k = 1}^{N - 1} {ρ}_{a}^{+} ( k ) {z}^{k} + {\sum }_{k = 1}^{N - 1} {ρ}_{a}^{-} ( k ) {z}^{- k} = {ρ}_{a} ( 0 ) + 2 {\sum }_{k = 1}^{N - 1} \vert {ρ}_{a}^{+} ( k ) \vert cos ( 2 π tk + {∠ρ}_{a}^{+} ( k ) ) \qquad Eq . 6$$

for

$$z = {e}^{\frac{j 2 π t}{T}}$$

for 0≤t<T.

The embodiments and examples provided herein also use the notation “:” to indicate the values that are regularly spaced. For example, [12:9:120] is the list of numbers [12 21 30 39 48 57 66 75 84 93 102 111120], starting at 12 and incrementing by 9 until the end number 120 is reached.

Examples and embodiments provided herein include Golay complementary pairs (GCPs), complementary sequences, and construction of the same. The pair of (a, b) is called a GCP if:

$${ρ}_{a} ( k ) + {ρ}_{b} ( k ) = \{ \begin{matrix}0 , & k \neq 0 \\ {‖ a ‖}_{2}^{2} + {‖ b ‖}_{2}^{2} , & k = 0\end{matrix} \qquad Eq . 7$$

where ρₐ(k) is the aperiodic auto-correlation function (AACF) of a sequence a of length N, given by:

$${ρ}_{a} ( k ) {=}^{Δ} \{ \begin{matrix}{ρ}_{a}^{+} ( k ) , & k \geq 0 \\ {{ρ}_{a}^{+} ( - k )}^{*} , & k < 0\end{matrix} for {ρ}_{a}^{+} ( k ) {=}^{Δ} \{ \begin{matrix}{\sum }_{i = 0}^{N - k - 1} {a}_{i}^{*} {a}_{i + k} , & 0 \leq k \leq N - 1 \\ 0 , & otherwise\end{matrix} \qquad Eq . 8$$

The sequence a=(a₀, a₁, . . . , a_{N-1}) is defined as a Golay sequence or complementary sequence (CS) if there exists another sequence b=(b₀, b₁, . . . , b_{N-1}) that complements a as ρₐ(k)+ρ_{b} (k)=0, k≠0.

By using the definition of a GCP, a GCP (a, b) satisfies the following identity:

$${\vert {p}_{a} ( z ) \vert}^{2} + {\vert {p}_{b} ( z ) \vert}^{2} = {p}_{a} ( z ) {p}_{{a}^{*}} ( {z}^{- 1} ) + {p}_{b} ( z ) {p}_{{b}^{*}} ( {z}^{- 1} ) = {ρ}_{a} ( 0 ) + {ρ}_{b} ( 0 ) = {‖ a ‖}_{2}^{2} + {‖ b ‖}_{2}^{2} \qquad Eq . 9$$

This identity implies that two OFDM signals generated by using the CSs in a GCP (a, b) complement each other in the sense that the sum of the instantaneous signal powers of the OFDM signals adds up to a constant, i.e.,

$${‖ a ‖}_{2}^{2} + {‖ b ‖}_{2}^{2} .$$

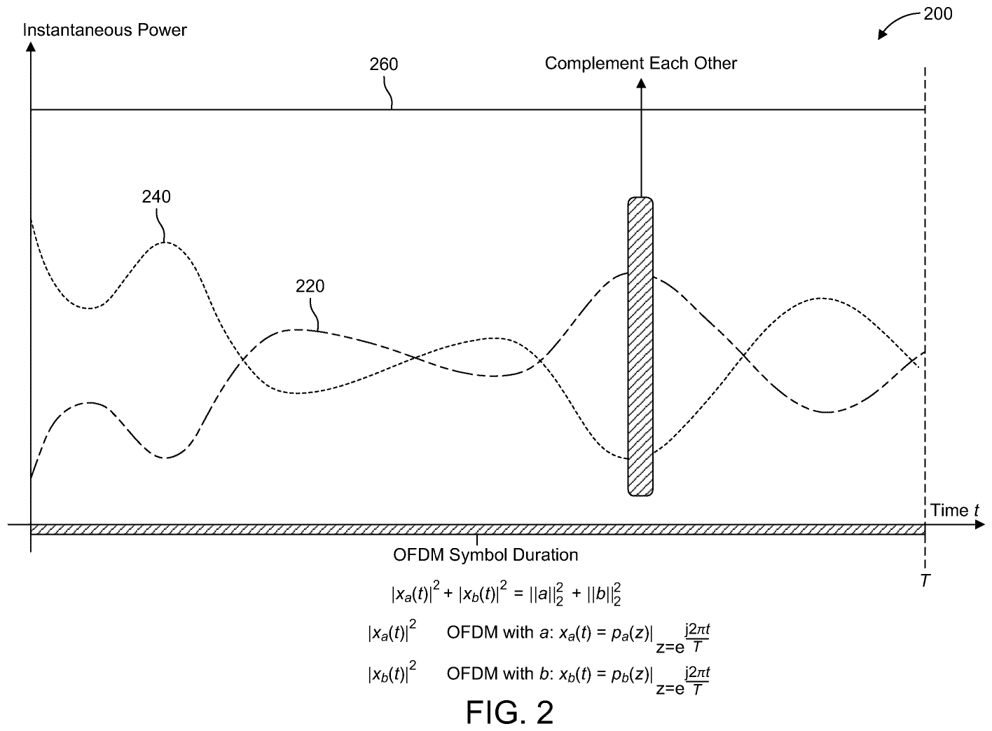

FIG. 2 is a signal power diagram illustrating an example of how OFDM signals using the CSs in a GCP (a, b) complement each other. As shown in signal power diagram, the sum of the instantaneous power of two OFDM signals, 220, 240, add up to a constant 260. Accordingly, the two OFDM signals, 220, 240 complement each other.

If

$${‖ a ‖}_{2}^{2} = {‖ b ‖}_{2}^{2} ,$$

one can infer that:

$$PAPR ( {x}_{a} ( t ) ) = \frac{{max}_{\vert z \vert = 1} ( {p}_{a} ( z ) {p}_{{a}^{*}} ( {z}^{- 1} ) )}{{‖ a ‖}_{2}^{2}} \leq \frac{{‖ a ‖}_{2}^{2} + {‖ b ‖}_{2}^{2}}{{‖ a ‖}_{2}^{2}} {\underbrace{=}}_{{‖ a ‖}_{2}^{2} = {‖ b ‖}_{2}^{2}} \frac{2 {‖ a ‖}_{2}^{2}}{{‖ a ‖}_{2}^{2}} = 2 \qquad Eq . 10$$

Thus, the OFDM signals generated from CSs have PAPR less than or equal to 2, i.e., approximately 3 dB. Note that

$${‖ a ‖}_{2}^{2} = {‖ b ‖}_{2}^{2} = N$$

if the elements of the sequence a and b of length N are on the unit circle.

Examples are provided herein of constructing complementary sequences. Let a and b be GCP of length N and α, β are arbitrary complex numbers. Then, the sequences c and d represented by:

$${p}_{c} ( z ) = {p}_{α \times a} ( {z}^{k} ) + {p}_{β \times b} ( {z}^{k} ) {z}^{m} \qquad Eq . 11$$

$${p}_{d} ( z ) = {p}_{\overline{β} \times a} ( {z}^{k} ) + {p}_{- \overline{α} \times b} ( {z}^{k} ) {z}^{m} \qquad Eq . 12$$

construct a GCP, where α̅ and β̅ are the complex conjugates of α and β, respectively. This construction can be interpreted as c and d. Specifically, After the first sequence α×a and the second sequence β×b are up-sampled with the factor k, m zeros are padded to the up-sampled first and second sequences to the end and the beginning, respectively. The point-to-point sum of elements leads to sequence c. Also, After the first sequence β̅×α and the second sequence −α̅×b are up-sampled with the factor k, m zeros are padded to the up-sampled first and second sequences to the end and the beginning, respectively. The point-to-point sum of elements leads to sequence d.

In an example, a=(1, 1), b=(1, −1), k=2, m=5, α=1i, β=−2i, α̅=−1i, β̅=2i

$${p}_{a} ( z ) = 1 + z , {p}_{b} ( z ) = 1 - z \qquad Eq . 13$$

$${p}_{a} ( {z}^{2} ) = 1 + {z}^{2} , {p}_{b} ( z ) = 1 - {z}^{2} \qquad Eq . 14$$

$${p}_{c} ( z ) = {p}_{α a} ( {z}^{2} ) + {p}_{β b} ( {z}^{2} ) {z}^{5} = α + α {z}^{2} + β {z}^{5} - β {z}^{7} = 1 i + 1 {iz}^{2} - 2 {iz}^{5} + 2 {iz}^{7} \qquad Eq . 15$$

$${p}_{d} ( z ) = {p}_{\overline{β} a} ( {z}^{k} ) + {p}_{\overline{α} b} ( {z}^{k} ) {z}^{m} = \overline{β} + \overline{β} {z}^{2} - \overline{α} {z}^{5} + \overline{α} {z}^{7} = 2 i + 2 {iz}^{2} + 1 {iz}^{5} - 1 {iz}^{7} \qquad Eq . 16$$

Hence, c=(1i, 0, 1i, 0,0, −2i, 0,2i) and d=(2i, 0,2i, 0,0, 1i, 0, −1i). Moreover, the following is a MATLAB example:

$$a = [ \begin{matrix}1 & 1\end{matrix} ] {.}^{′} ;$$

$$b = [ \begin{matrix}1 & - 1\end{matrix} ] {.}^{′} ;$$

$$alpha = + 1 i ;$$

$$beta = - 2 i ;$$

$$k = 2 ;$$

$$m = 5 ;$$

$$c = [ upsample ( {alpha}^{*} a , k ) ; zeros ( m , 1 ) ] + [ zeros ( m , 1 ) ; upsample ( {beta}^{*} b , k ) ] ;$$

$$d = [ upsample ( {cong ( beta )}^{*} a , k ) ; zeros ( m , 1 ) ] - [ zeros ( m , 1 ) ; upsample ( {conj ( alpha )}^{*} b , k ) ] ;$$

Nested tone allocations are provided in examples herein. Let

$${T}_{i}^{( l )}$$

denote the set of tones (i.e., subcarrier indices) allocated for the ith DRU at the lth level for l ∈{1, . . . ≢, i=1, . . . }, Uₗ, where Uₗ is the number of DRUs at the lth level. For a given level l, all DRUs at the same level have the same number of tones, i.e.,

$$\vert {T}_{i}^{( l )} \vert = {R}_{l} , ∀ i ,$$

where Rᵢ is the number of tones (i.e., OFDM subcarriers or resources) at the DRU. Also, for a nested tone allocation,

$${T}_{i}^{( l )}$$

can consist of all tones of some DRUs at a lower level lᵢ<1. Further, for the nested tone allocation,

$${T}_{i}^{( l )}$$

can include some extra tones that are not used at any DRU at a lower level

$${l}_{i} < 1. {E}_{i}^{( l )}$$

denotes the set of extra tones for

$${E}_{i}^{( l )} ∩ {E}_{j}^{( l )} = ∅ , i \neq j , ∀ i , ∀ j .$$

Embodiments and examples of nested complementary sequences for DRU LTF design are provided herein. Let xₛ_{_{l,i}}(t) denote the OFDM signal for a preamble (e.g., LTF) transmission for the ith DRU at the lth level as.

$${{x}_{{s}_{l , i}} ( t ) = {z}^{{m}_{l , i}} {p}_{{s}_{l , i}} ( z ) \vert}_{z = {e}^{\frac{j 2 π t}{T}}} for {m}_{l , i} = {min}_{m ∈ {T}_{i}^{( l )}} m \qquad Eq . 17$$

where p_{l,i}(z) be the polynomial representation of the sequence s_{l,i} carried at the OFDM subcarriers of the ith DRU at the lth level, where the elements of s_{l,i} are mapped to the OFDM subcarriers starting from m_{l,i}th in the subcarrier index.

Importantly, to achieve low-PAPR OFDM signals for a preamble transmission for all DRUs, i.e., xₛ_{_{l,i}}(t), ∀l, ∀i, in a nested tone configuration, the sequences carried at the OFDM subcarrier at the first level of DRUs, i.e., pₛ_{_{1,i}}(z), ∀i ∈{1, . . . , U₁}, may be chosen by using a seed GCP (sₐ,s_{b}) and altering them as w_{a,i}×sₐ and w_{b,i}×s_{b} with some complex numbers w_{a,i} and w_{b,i} such that the sequence carried at the tones at the level l≥1 may form a CS by using its GCP at another DRU at the (l−1)th layer, obeying the following formulas:

$${p}_{c} ( z ) = {p}_{α \times a} ( {z}^{k} ) + {p}_{β \times b} ( {z}^{k} ) {z}^{m} \qquad Formula ( 1 )$$

$${p}_{d} ( z ) = {p}_{\overline{β} \times a} ( {z}^{k} ) + {p}_{- \overline{α} \times b} ( {z}^{k} ) {z}^{m} \qquad Formula ( 2 )$$

for some arbitrary complex numbers α,β, and integers k and m. This embodiment implies that the sequences for any two lower DRUs form a GCP.

In an example, to facilitate carrier frequency offset estimation (e.g., in an uplink multi-user multi-input-multi-output (MIMO) scenario), every other element of the seed sequences may be multiplied with −1 (e.g., for the transmission at another stream) as rotating every other element of the seed sequences in a GCP leads to another GCP. Hence, the PAPR properties of the CSs are retained.

In another example, the seed GCP may be multiplied with some data symbols (e.g., QPSK) to transmit information. For example, only one sequence in a pair may be multiplied with a QPSK symbol, while the other one may be kept as a reference or pilot symbol.

In a further example, there may be some of the tones function as pilots, e.g., single-stream pilots in 802.11 WLAN, such that the values on these pilots may be need to be flipped (i.e., multiplied by −1) while the rest of values on the other tones are kept constant (or vice versa). These specific pilots can be used for carrier frequency estimation in uplink multi-user scenarios. Hence, PAPR should be still kept low under this constraint. In one implementation, the corresponding the location of pilots may be chosen such that the PARP benefit of CSs does not degrade substantially.

In an example, a UHR DRU-LFT design may use QPSK in a 20 MHz distribution bandwidth. A DRU tone plan may include one more DRU tone allocations or DRU allocations. Consider a DRU tone allocation given in Table 1, below.

TABLE 1
An example of a DRU table for a nested tone allocation
Data and pilot subcarrier indices for Distributed Tone RUs (DRUs) in a 20 MHz UHR PPDU

| DRU type | DRU index and subcarrier range | | | | |
|---|---|---|---|---|---|
| 26-tone DRU | DRU1 | DRU2 | DRU3 | DRU4 | DRU5 |
| i = 1:9 | [−120:9:−12, | [−116:9:−8, 8:9:116] | [−118:9:−10, | [−114:9:−6, | [−112:9:−4 , |
| | 4:9:112] | | 6:9:114] | 10:9:118] | 12:9:120] |
| | DRU6 | DRU7 | DRU8 | DRU9 | |
| | [−119:9:−11, | [−115:9:−7, 9:9:117] | [−117:9:−9, 7:9:115] | [−113:9:−5, | |
| | 5:9:113] | | | 11:9:119] | |

| | | |
|---|---|---|
| 52-tone DRU | DRU1 | DRU2 |
| i = 1:4 | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone DRU | DRU1 | DRU2 |
| i = 1:2 | 26-tone [DRU1~4], [−3, 2] | 26-tone [DRU6~9], [−2, 3] |

Based on Table 1 and the notation in this disclosure, we can show the nested tone allocation as in Table 2.

TABLE 2
Nested tone allocation based on Table 1, and provided notation

| 1^{st} level DRUs (R₁ = 26, U₁ = 9) | 2^{nd} level DRUs (R₂ = 52, U₂ = 4) | 3^{rd} level DRUs (R₃ = 106, U₃ = 2) |
|---|---|---|
| ${T}_{1}^{( 1 )} = \{ - 1 \; 20 : 9 : - 12 , 4 : 9 : 112 \}$ | ${T}_{1}^{( 2 )} = {T}_{1}^{( 1 )} ⋃ {T}_{2}^{( 1 )}$ | ${T}_{1}^{( 3 )} = {T}_{1}^{( 2 )} ⋃ {T}_{2}^{( 2 )} ⋃ {E}_{1}^{( 3 )}$ |
| ${T}_{2}^{( 1 )} = \{ - 1 \; 16 : 9 : - 8 , 8 : 9 : 116 \}$ | | ${E}_{1}^{( 3 )} = \{ - 3 , 2 \}$ |
| ${T}_{3}^{( 1 )} = \{ - 1 \; 18 : 9 : - 10 , 6 : 9 : 114 \}$ | ${T}_{2}^{( 2 )} = {T}_{3}^{( 1 )} ⋃ {T}_{4}^{( 1 )}$ | |
| ${T}_{4}^{( 1 )} = \{ - 1 \; 14 : 9 : - 6 , 10 : 9 : 118 \}$ | | |
| ${T}_{5}^{( 1 )} = \{ - 1 \; 12 : 9 : - 4 , 12 : 9 : 120 \}$ | | |
| ${T}_{6}^{( 1 )} = \{ - 1 \; 19 : 9 : - 11 , 5 : 9 : 113 \}$ | ${T}_{3}^{( 2 )} = {T}_{6}^{( 1 )} ⋃ {T}_{7}^{( 1 )}$ | ${T}_{2}^{( 3 )} = {T}_{3}^{( 2 )} ⋃ {T}_{4}^{( 2 )} ⋃ {E}_{2}^{( 3 )}$ |
| ${T}_{7}^{( 1 )} = \{ - 1 \; 15 : 9 : - 7 , 9 : 9 : 117 \}$ | | ${E}_{2}^{( 3 )} = \{ - 2 , 3 \}$ |
| ${T}_{8}^{( 1 )} = \{ - 1 \; 17 : 9 : - 9 , 7 : 9 : 115 \}$ | ${T}_{4}^{( 2 )} = {T}_{8}^{( 1 )} ⋃ {T}_{9}^{( 1 )}$ | |
| ${T}_{9}^{( 1 )} = \{ - 1 \; 13 : 9 : - 5 , 11 : 9 : 119 \}$ | | |

As can be seen in Table 2, 2^{nd}-level DRUs may consist of 1^{st}-level DRUs. Similarly, a 3^{rd}-level DRU may consist of several 2^{nd}-level DRUs. Also, DRU may include some extra tones

$$( i . e . , the ones in {E}_{1}^{( 3 )} and {E}_{2}^{( 3 )} )$$

that are not used at any other lower-level DRUs. Now, we are looking for a master sequence that leads to a low PAPR value for xₛ_{_{l,i}}(t), for all possible l and i, without any exhaustive search for the nested tone allocation in Table 2.

An example construction of a CS based on the proposed method is provided in the following. Consider the following seed GCP: sₐ=(1, 1, 1, 1i, −1, 1, 1, −i, 1, −1, 1, −1i, 1i), s_{b}=(11i−1−1−11i−1 11−1i−11−1i).

Based on the proposed method, w_{a,i} and w_{b,i} for i=1, . . . ,9, at the first level may be chosen as in Table 3 such that they form a CS obeying (1) and (2) when the corresponding sequences are combined at a higher-level DRU (i.e., the main design criteria for w_{a,i} and w_{b,i} for i=1, . . . ,9, which depends on how the DRUs are combined at the higher layers, i.e., Table 2).

TABLE 3
An example of choices of w_{a, i} and w_{b, i}
based on a proposed solution (20 MHz)

| i | w_{a, i} | w_{b, i} |
|---|---|---|
| 1 | 1 | 1 |
| 2 | 1 | −1 |
| 3 | 1 | 1 |
| 4 | −1 | 1 |
| 5 | 1 | 1 |
| 6 | 1 | 1 |
| 7 | 1 | −1 |
| 8 | −1 | −1 |
| 9 | 1 | −1 |

Examples are provided herein of CSs and GCPs at different levels. As shown in Table 4, the seed GCP, along with the choices of w_{a,i} and w_{b,i}, leads to the CSs (based on formula (1) and formula (2)) for the first-level DRUs while preparing GCPs for the second-level.

TABLE 4
The CSs at the first-level DRUs form GCP for the second-level DRUs (20 MHZ)

| | pₛ_{_{1,i}} (z) = | m_{1,i} | Is s_{1,i} | Does a GCP exist for the next |
|---|---|---|---|---|
| | p_{w}_{_{a,i}}ₛ_{ₐ} (z⁹) + | | is | level based on the formulas in |
| 1^{st}-level DRU tone indices | p_{w}_{_{b,i}}ₛ_{_{b}} (z⁹)z¹²⁴ | | CS? | (1) or (2)? |
| ${T}_{1}^{( 1 )} = \{ - 1 \; 20 : 9 : - 12 , 4 : 9 : 112 \}$ | pₛ_{_{1,1}} (z) = p_{w}_{_{a,i}}ₛ_{ₐ}(z⁹) + p_{w}_{_{b,i}}ₛ_{_{b}}(z⁹)z¹²⁴ | −120 | Yes | (c, d) = (s_{1,1}, s_{1,2}) is a GCP as (a, b) = (sₐ, s_{b}) is a GCP and (α, β) = (1,1) |
| ${T}_{2}^{( 1 )} = \{ - 1 \; 16 : 9 : - 8 , 8 : 9 : 116 \}$ | pₛ_{_{1,2}} (z) = p₊ₛ_{ₐ}(z⁹) + p₋ₛ_{_{b}} (z⁹)z¹²⁴ | −116 | Yes | |
| ${T}_{3}^{( 1 )} = \{ - 1 \; 18 : 9 : - 10 , 6 : 9 : 114 \}$ | pₛ_{_{1,3}} (z) = p₊ₛ_{ₐ}(z⁹) + p₊ₛ_{_{b}} (z⁹)z¹²⁴ | −118 | Yes | (c, d) = (s_{1,4}, s_{1,3}) is a GCP as (a, b) = (sₐ, s_{b}) is a GCP and (α, β) = (−1,1) |
| ${T}_{4}^{( 1 )} = \{ - 114 : 9 : - 6 , 10 : 9 : 118 \}$ | pₛ_{_{1,4}} (z) = p₋ₛ_{ₐ}(z⁹) + p₊ₛ_{_{b}} (z⁹)z¹²⁴ | −114 | Yes | |
| ${T}_{5}^{( 1 )} = \{ - 112 : 9 : - 4 , 12 : 9 : 120 \}$ | pₛ_{_{1,5}} (z) = | −112 | Yes | |
| | p₊ₛ_{ₐ} (z⁹) + p₊ₛ_{_{b}} (z⁹)z¹²⁴ | | | |
| ${T}_{6}^{( 1 )} = \{ - 1 \; 19 : 9 : - 11 , 5 : 9 : 113 \}$ | pₛ_{_{1,6}} (z) = p₊ₛ_{ₐ}(z⁹) + p₊ₛ_{_{b}} (z⁹)z¹²⁴ | −119 | Yes | (c, d) = (s_{1,6}, s_{1,7}) is a GCP as (a, b) = (sₐ, s_{b}) is a GCP and (α, β) = (1,1) |
| ${T}_{7}^{( 1 )} = \{ - 1 \; 15 : 9 : - 7 , 9 : 9 : 117 \}$ | pₛ_{_{1,7}} (z) = p₊ₛ_{ₐ} (z⁹) + p₋ₛ_{_{b}} (z⁹)z¹²⁴ | −115 | Yes | |
| ${T}_{8}^{( 1 )} = \{ - 1 \; 17 : 9 : - 9 , 7 : 9 : 115 \}$ | pₛ_{_{1,8}} (z) = p₋ₛ_{ₐ}(z⁹) + p₋ₛ_{_{b}} (z⁹)z¹²⁴ | −117 | Yes | (c, d) = (s_{1,9}, s_{1,8}) is a GCP as (a, b) = (sₐ, s_{b}) is a GCP and (α, β) = (−1,1) |
| ${T}_{9}^{( 1 )} = \{ - 1 \; 13 : 9 : - 5 , 11 : 9 : 119 \}$ | pₛ_{_{1,9}} (z) = p₊ₛ_{ₐ}(z⁹) + p₋ₛ_{_{b}} (z⁹)z¹²⁴ | −113 | Yes | |

As shown in Table 5, the sequences at the first-level DRUs form CSs (based on formula (1) and formula (2)) for the second-level DRUs while preparing GCPs for the third level.

TABLE 5
The CSs at the first-level DRUs lead to the CSs for the second-level
DRUs while preparing GCP for the third level (20 MHz)

| | | | | Does a GCP exist for the next |
|---|---|---|---|---|
| 2^{nd}-level DRU | | | Is s_{2,i} is | level based on the formulas in |
| tone indices | pₛ_{_{2,i}} (z) | m_{2,i} | CS? | (1) or (2)? |
| ${T}_{1}^{( 2 )} = {T}_{1}^{( 1 )} ⋃ {T}_{2}^{( 1 )}$ | pₛ_{_{2,1}}(z) = | −120 | Yes | (c,d) = (s_{2,1}, s_{2,2}) is a GCP |
| | pₛ_{_{1,1}} (z) + pₛ_{_{1,2}} (z)z⁴ | | | because (a, b) = |
| ${T}_{2}^{( 2 )} = {T}_{3}^{( 1 )} ⋃ {T}_{4}^{( 1 )}$ | pₛ_{_{2,2}} (z) = | −118 | Yes | (s_{1,1}, s_{1,2}) = (s_{1,3}, −s_{1,4}) is |
| | pₛ_{_{1,3}}(z) + pₛ_{_{1,4}} (z)z⁴ | | | a GCP and α, β = (1,1) |
| ${T}_{3}^{( 2 )} = {T}_{6}^{( 1 )} ⋃ {T}_{7}^{( 1 )}$ | ps_{_{2,4}}(z) = | −119 | Yes | (c,d) = (s_{2,4}, s_{2,3}) is a GCP |
| | pₛ_{_{1,6}} (z) + pₛ_{_{1,7}} (z)z⁴ | | | because (a, b) = |
| ${T}_{4}^{( 2 )} = {T}_{8}^{( 1 )} ⋃ {T}_{9}^{( 1 )}$ | pₛ_{_{2,4}} (z) = | −117 | Yes | (s_{1,9}, s_{1,8}) = (s_{1,7}, −s_{1,6}) is |
| | pₛ_{_{1,8}} (z) + pₛ_{_{1,9}} (z)z⁴ | | | a GCP and α, β = (1, −1) |

As shown in Table 6, the sequences at the second-level DRUs form the CSs (based on formula (1) and formula (2)) for the third-level DRUs. The third level is the final level in this example.

TABLE 6
CSs at the
second-level DRUs lead to CSs for third-level DRUs (20 MHz)

| 3^{rd}-level DRU | | | Is s_{3,i} |
|---|---|---|---|
| tone indices | pₛ_{_{3,i}} (z) | m_{3,i} | is CS? |
| $\begin{matrix}{T}_{1}^{( 2 )} ⋃ {T}_{2}^{( 2 )} \\ ( excluding {E}_{1}^{( 3 )} )\end{matrix}$ | pₛ_{_{3,1}}(z) = pₛ_{_{2,1}}(z) + pₛ_{_{2,2}}(z)z² | −120 | Yes |
| $\begin{matrix}{T}_{2}^{( 2 )} ⋃ {T}_{4}^{( 2 )} \\ ( excluding {E}_{2}^{( 3 )} )\end{matrix}$ | pₛ_{_{3,2}}(z) = pₛ_{_{2,3}}(z) + pₛ_{_{2,4}}(z)z² | −119 | Yes |

In summary, the master sequence for a 20 MHz DRU LTF may be tabulated as in Table 7, based on Table 3-Table 6.

TABLE 7
The values of the master sequence at the specific tones (20 MHz)

| | | | | The values at the tone |
|---|---|---|---|---|
| | | | | indices (the sequence |
| | | | | elements are mapped |
| | | | | starting from the |
| | | | | smallest index to the |
| i | Tone indices | w_{a, i} | w_{b, i} | highest tone index) |
| 1 | {−120:9:−12, 4:9:112} | 1 | 1 | (w_{a, i} × sₐ, w_{b, i} × s_{b}) |
| 2 | {−116:9:−8, 8:9:116} | 1 | −1 | (w_{a, i} × sₐ, w_{b, i} × s_{b}) |
| 3 | {−118:9:−10, 6:9:114} | 1 | 1 | (w_{a, i} × sₐ, w_{b, i} × s_{b}) |
| 4 | {−114:9:−6, 10:9:118} | −1 | 1 | (w_{a, i} × sₐ, w_{b, i} × s_{b}) |
| 5 | {−112:9:−4, 12:9:120} | 1 | 1 | (w_{a, i} × sₐ, w_{b, i} × s_{b}) |
| 6 | {−119:9:−11, 5:9:113} | 1 | 1 | (w_{a, i} × sₐ, w_{b, i} × s_{b}) |
| 7 | {−115:9:−7, 9:9:117} | 1 | −1 | (w_{a, i} × sₐ, w_{b, i} × s_{b}) |
| 8 | {−117:9:−9, 7:9:115} | −1 | −1 | (w_{a, i} × sₐ, w_{b, i} × s_{b}) |
| 9 | {−113:9:−5, 11:9:119} | 1 | −1 | (w_{a, i} × sₐ, w_{b, i} × s_{b}) |
| | Extra tones | | | (1i, 1, −1, 1i) |
| | {−3, −2, 2, 3} | | | |

As noted, sₐ=(1, 1, 1, 1i, −1, 1, 1, −1i, 1, −1, 1, −1i, 1i), s_{b}=(11i−1−1−11i−1, 1, 1−1i−11−1i).

The master sequence can also be shown as a vector:

DLTF_{-122:122} = [ ...
0 0 1 1 1 −1 1 1 −1 1 1 1 1 1 −1 1 1 −1 1 1 1 1 1 −1 1 1 −1 1 1 1i 1i 1i −1i 1i 1i −1i 1i 1i −1 −1 −1 1 −1 −1 1 −1 −1 1 1 1 −1 1 1 −1
1 1 1 1 1 −1 1 1 −1 1 1 −1i −1i −1i 1i −1i −1i 1i −1i −1i 1 1 1 −1 1 1 −1 1 1 −1 −1 −1 1 −1 −1 1 −1 −1 1 1 1 −1 1 1 −1 1 1 −1i −1i −1i
1i 1i −1i −1i 1i −1i −1i 1i 1i 1i −1i 1i 1i −1i 1i 1i [symbol] 0 0 0 [symbol] 1 1 1 −1 −1 −1 1 −1 1 1i 1i 1i −1i −1i −1i 1i −1i li −1 −1 −1 1 1
1 −1 1 −1 −1 −1 −1 1 1 1 −1 1 −1 −1 −1 −1 1 1 1 −1 1 −1 1i 1i 1i −1i −1i −1i 1i −1i 1i −1 −1 −1 1 1 1 −1 1 −1 1 1 1 −1 −1 −1 1 −1 1 1
1 1 −1 −1 −1 1 −1 1 −1i −1i −1i 1i 1i 1i −1i 1i −1i −1 −1 −1 1 1 1 −1 1 −1 1 1 1 −1 −1 −1 1 1 1 −1 −1 −1 1 −1 1 −1i −1i −1i 1i 1i 1i −1i 1i −1i 0 0]

where the enlarged ones are the extra symbols. Note that this sequence may be multiplied with a coefficient on the unit circle, such as e^{jπ/4} or e^{-jπ/4}, to rotate the elements so that the elements of the sequence are in a specific constellation, e.g., QPSK modulation like e^{jπ/4}×{1, 1i, −1, −1i}. The values on the extra tone indices may be chosen to minimize PAPR further via random search.

Under the examples provided herein, all DRUs lead to low PAPR and cubic metric (CM) results, as can be seen in Table 8.

TABLE 8
PAPR results for 20 MHz DRU LTF based on the proposed methodology

| DRU Index: | 1 | 2 | 3 | 4 | 5 | 6 | 7 | 8 | 9 |
|---|---|---|---|---|---|---|---|---|---|
| DRU26 | 3.01 | 3.01 | 3.01 | 3.01 | 3.01 | 3.01 | 3.01 | 3.01 | 3.01 |

| | | | | |
|---|---|---|---|---|
| DRU52 | 3.01 | 3.01 | 3.01 | 3.01 |

| | | |
|---|---|---|
| DRU106 | 3.77 | 3.83 |

The MATLAB results are also given as a reference below.

tonesDRU26{1} = [−120:9:−12, 4:9:112];
tonesDRU26{2} = [−116:9:−8, 8:9:116];
tonesDRU26{3} = [−118:9:−10, 6:9:114];
tonesDRU26{4} = [−114:9:−6, 10:9:118];
tonesDRU26{5} = [−112:9:−4, 12:9:120];
tonesDRU26{6} = [−119:9:−11, 5:9:113];
tonesDRU26{7} = [−115:9:−7, 9:9:117];
tonesDRU26{8} = [−117:9:−9, 7:9:115];
tonesDRU26{9} = [−113:9:−5, 11:9:119];
Ga13 = [1 1 1 1i −1 1 1 −1i 1 −1 1 −1i 1i];
Gb13 = [1 1i −1 −1 −1 1i −1 1 1 −1i −1 1 −1i];
tones = [−122:122];
masterSequence = zeros(1,numel(tones));
masterSequence(tonesDRU26{1}+123) = [Ga13 Gb13];
masterSequence(tonesDRU26{2}+123) = [Ga13 −Gb13];
masterSequence(tonesDRU26{3}+123) = [Ga13 Gb13];
masterSequence(tonesDRU26{4}+123) = [−Ga13 Gb13];
% %
masterSequence(tonesDRU26{5}+123) = [Ga13 Gb13];
% %
masterSequence(tonesDRU26{6}+123) = [Ga13 Gb13];
masterSequence(tonesDRU26{7}+123) = [Ga13 −Gb13];
masterSequence(tonesDRU26{8}+123) = [−Ga13 −Gb13];
masterSequence(tonesDRU26{9}+123) = [Ga13 −Gb13];
extra106 = [−3 −2 2 3].′;
masterSequence(extra106+123) = [1i 1 −1 1i];

In another example, a UHR DRU-LFT design may use QPSK in a 20 MHz distribution bandwidth for single stream pilots. Consider a DRU tone allocation given in Table 9 below.

TABLE 9
An example of a DRU table for a nested tone allocation
Data and pilot subcarrier indices for Distributed
Tone RUs (DRUs) in a 20 MHz UHR PPDU

| DRU type | DRU index and subcarrier range | | | | |
|---|---|---|---|---|---|
| 26-tone DRU | DRU1 | DRU2 | DRU3 | DRU4 | DRU5 |
| i = 1:9 | [−121:9:−13, | [−117:9:−9, | [−119:9:−11, | [−115:9:−7, | [−113:9:−5, |
| | 5:9:113] | 9:9:117] | 7:9:115] | 11:9:119] | 13:9:121] |
| | DRU6 | DRU7 | DRU8 | DRU9 | |
| | [−120:9:−12, | [−116:9:−8, | [−118:9:−10, | [−114:9:−6, | |
| | 6:9:114] | 10:9:118] | 8:9:116] | 12:9:120] | |

| | | |
|---|---|---|
| 52-tone DRU | DRU1 | DRU2 |
| i = 1:4 | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone DRU | DRU1 | DRU2 |
| i = 1:2 | 26-tone [DRU1~4], [−4, 3] | 26-tone [DRU6~9], [−3, 4] |

Based on Table 9 and the notation provided herein, we can show the nested tone allocation as in Table 10.

TABLE 10
Nested tone allocation based on Table 9 and the provided notation

| 1^{st} level DRUs | 2^{nd} level DRUs | 3^{rd} level DRUs |
|---|---|---|
| (R₁ = 26, U₁ = 9) | (R₂ = 52, U₂ = 4) | (R₃ = 106, U₃ = 2) |
| $\begin{matrix}{T}_{1}^{( 1 )} = \\ \{ - 121 : 9 : - 13 , 5 : 9 : 113 \}\end{matrix}$ | ${T}_{1}^{( 2 )} = {T}_{1}^{( 1 )} ⋃ {T}_{2}^{( 1 )}$ | $\begin{matrix}{T}_{1}^{( 3 )} = \\ {T}_{1}^{( 2 )} ⋃ {T}_{2}^{( 2 )} ⋃ {E}_{1}^{( 3 )}\end{matrix}$ |
| $\begin{matrix}{T}_{2}^{( 1 )} = \\ \{ - 117 : 9 : - 9 , 9 : 9 : 117 \}\end{matrix}$ | | ${E}_{1}^{( 3 )} = \{ - 4 , 3 \}$ |
| $\begin{matrix}{T}_{3}^{( 1 )} = \\ \{ - 119 : 9 : - 11 , 7 : 9 : 115 \}\end{matrix}$ | ${T}_{2}^{( 2 )} = {T}_{3}^{( 1 )} ⋃ {T}_{4}^{( 1 )}$ | |
| $\begin{matrix}{T}_{4}^{( 1 )} = \\ \{ - 115 : 9 : - 7 , 11 : 9 : 119 \}\end{matrix}$ | | |
| $\begin{matrix}{T}_{5}^{( 1 )} = \\ \{ - 113 : 9 : - 5 , 13 : 9 : 121 \}\end{matrix}$ | | |
| $\begin{matrix}{T}_{6}^{( 1 )} = \\ \{ - 120 : 9 : - 12 , 6 : 9 : 114 \}\end{matrix}$ | ${T}_{3}^{( 2 )} = {T}_{6}^{( 1 )} ⋃ {T}_{7}^{( 1 )}$ | $\begin{matrix}{T}_{2}^{( 3 )} = \\ {T}_{3}^{( 2 )} ⋃ {T}_{4}^{( 2 )} ⋃ {E}_{2}^{( 3 )}\end{matrix}$ |
| $\begin{matrix}{T}_{7}^{( 1 )} = \\ \{ - 116 : 9 : - 8 , 10 : 9 : 118 \}\end{matrix}$ | | ${E}_{2}^{( 3 )} = \{ - 3 , 4 \}$ |
| $\begin{matrix}{T}_{8}^{( 1 )} = \\ \{ - 118 : 9 : - 10 , 8 : 9 : 116 \}\end{matrix}$ | ${T}_{4}^{( 2 )} = {T}_{8}^{( 1 )} ⋃ {T}_{9}^{( 1 )}$ | |
| $\begin{matrix}{T}_{9}^{( 1 )} = \\ \{ - 114 : 9 : - 6 , 12 : 9 : 120 \}\end{matrix}$ | | |

An example construction of a CS based on the proposed method, master sequence, and pilots is provided herein. Consider the following seed GCP: sₐ=(1, 1, 1, 1i, −1, 1, 1, −1i, 1, −1, 1, −1i,1i) s_{b}=(−1, 1i, −1i, −1, 1i, 1i, −1i, −1i, −1i, 1, 1i)

Note at S_{b} in this example is equal to the sequence used in the previous example, i.e. (1 1i−1−1−11i−111−1i−11−1i) after is 1) reversed in order (of elements of the sequence), 2) complex conjugated, and 3) multiplied with i:=\sqrt{−1} as: S_{b}=1i× conjugate(reverseTheOrder(1, 1i, −1, −1, −1, i, −1, 1, 1, −1i, −1, 1, −1i))=(−1, 1i, −1i).

This example shows that the seed pair can be prepared in various ways without effecting the pair being a GCP.

Similar to the previous example, based on the proposed method, w_{a,i} and w_{b,i} for i=1, . . . ,9, at the first level may be chosen a such that they form a CS obeying (1) and (2) when the corresponding sequences are combined at a higher-level DRU (i.e., the main design criteria for w_{a,i} and w_{b,i} for i=1, . . . ,9, which depends on how the DRUs are combined at the higher layers) as given in Table 11.

TABLE 11
The values of the master sequence at the specific tones (20 MHz)

| | | | | The values at the |
|---|---|---|---|---|
| | | | | tone indices (the |
| | | | | sequence elements |
| | | | | are mapped starting |
| | | | | from the smallest |
| | | | | index to the highest |
| i | Tone indices | w_{a,i} | w_{b,i} | tone index) |
| 1 | $\begin{matrix}{T}_{1}^{( 1 )} = \\ \{ - 121 : 9 : - 13 , 5 : 9 : 113 \}\end{matrix}$ | 1 | 1 | (w_{a,i} × sₐ, w_{b,i} × s_{b}) |
| 2 | $\begin{matrix}{T}_{2}^{( 1 )} = \\ \{ - 117 : 9 : - 9 , 9 : 9 : 117 \}\end{matrix}$ | 1 | −1 | (w_{a,i} × sₐ, w_{b,i} × s_{b}) |
| 3 | $\begin{matrix}{T}_{3}^{( 1 )} = \\ \{ - 119 : 9 : - 11 , 7 : 9 : 115 \}\end{matrix}$ | 1 | 1 | (w_{a,i} × sₐ, w_{b,i} × s_{b}) |
| 4 | $\begin{matrix}{T}_{4}^{( 1 )} = \\ \{ - 115 : 9 : - 7 , 11 : 9 : 119 \}\end{matrix}$ | −1 | 1 | (w_{a,i} × sₐ, w_{b,i} × s_{b}) |
| 5 | $\begin{matrix}{T}_{5}^{( 1 )} = \\ \{ - 113 : 9 : - 5 , 13 : 9 : 121 \}\end{matrix}$ | 1 | 1 | (w_{a,i} × sₐ, w_{b,i} × s_{b}) |
| 6 | $\begin{matrix}{T}_{6}^{( 1 )} = \\ \{ - 120 : 9 : - 12 , 6 : 9 : 114 \}\end{matrix}$ | 1 | 1 | (w_{a,i} × sₐ, w_{b,i} × s_{b}) |
| 7 | $\begin{matrix}{T}_{7}^{( 1 )} = \\ \{ - 116 : 9 : - 8 , 10 : 9 : 118 \}\end{matrix}$ | 1 | −1 | (w_{a,i} × sₐ, w_{b,i} × s_{b}) |
| 8 | $\begin{matrix}{T}_{8}^{( 1 )} = \\ \{ - 118 : 9 : - 10 , 8 : 9 : 116 \}\end{matrix}$ | −1 | −1 | (w_{a,i} × sₐ, w_{b,i} × s_{b}) |
| 9 | $\begin{matrix}{T}_{9}^{( 1 )} = \\ \{ - 114 : 9 : - 6 , 12 : 9 : 120 \}\end{matrix}$ | 1 | −1 | (w_{a,i} × sₐ, w_{b,i} × s_{b}) |
| | Extra tones {−4 −3 3 4} | | | (−1i −1i 1 1) |

The master sequence can also be shown as a vector:

DLTF_{-122:122} = [ ...
0 1 1 1 −1 1 1 −1 1 1 1 1 1 −1 1 1 −1 1 1 1 1 1 −1 1 1 −1 1 1 1i 1i 1i −1i 1i 1i −1i 1i 1i −1 −1 −1 1 −1 −1 1 −1 −1 1 1 1 −1 1 1 −1
1 1 1 1 1 −1 1 1 −1 1 1 −1i −1i −1i 1i −1i −1i 1i −1i −1i 1 1 1 −1 1 1 −1 1 1 −1 −1 −1 1 −1 −1 1 −1 −1 1 1 1 −1 1 1 −1 1 1 −1i −1i −1i
1i −1i −1i 1i −1i −1i 1i 1i 1i −1i 1i 1i −1i 1i 1i −1i −1i 0 0 0 0 0 1 1 −1 −1 −1 1 1 1 −1 1 −1 1i 1i 1i −1i −1i −1i 1i −1i 1i −1i −1i −1i 1i
1i 1i −1i 1i −1i −1 −1 −1 1 1 1 −1 1 −1 1i 1i 1i −1i −1i −1i 1i −1i 1i 1i 1i 1i −1i −1i −1i 1i −1i 1i −1i −1i −1i 1i 1i 1i −1i 1i −1i 1 1 1 −1 −1
−1 1 −1 1−1i −1i −1i 1i 1i 1i −1i 1i −1i −1i −1i −1i 1i 1i 1i −1i 1i −1i −1i −1i −1i 1i 1i 1i −1i 1i −1i 1 1 1 −1 −1 −1 1 −1 1 1i 1i 1i −1i
−1i −1i 1i −1i 1i 0]

Note that this sequence may be multiplied with a coefficient on the unit circle, such as e^{jπ/4} or e^{-jπ/4}, to rotate the elements so that the elements of the sequence are in a specific constellation, e.g., QPSK modulation like e^{jπ/4}×{1, 1i, −1,−1i}.

For example, for this tone plan, single-stream pilot indices may be chosen as in Table 12 or Table 12. The difference between these pilot indices is that Alternative 1 may consists of tone at the edge of bandwidth, while Alternative 2 does not have pilot indices at the edges.

TABLE 12
Pilot indices (20 MHz)- Alternative 1

| | Single stream pilot indices for DRU transmission |
|---|---|
| DRU size | over 20 MHz, pilot tones starting from smallest i |
| DRU26, i = | [−94 32], [−117 117], [−92 34], [−115 119], [−86 40], |
| {1 . . . 9} | [−93 33], [−116 118], [−91 35], [−114 120] |
| DRU52, i = | [−67 −49 81 113], [−65 −47 83 115], [−66 −48 82 114], |
| {1, 2, 3, 4} | [−64 −46 84 116] |
| DRU106, i = | [−85 −58 99 117], [−102 −80 33 114] |
| {1, 2} | |

TABLE 13
Pilot indices (20 MHz) -Alternative 2 (Pilots
are not at the edge of the bandwidth)

| | Single stream pilot indices for DRU transmission |
|---|---|
| DRU size | over 20 MHz, pilot tones starting from smallest i |
| DRU26, i = | [−94 32], [−27 90], [−92 34], [−25 92], [−86 40], |
| {1 . . . 9} | [−93 33], [−26 91], [−91 35], [−24 93] |
| DRU52, i = | [−67 −49 81 113], [−65 −47 83 115], [−66 −48 82 114], |
| {1, 2, 3, 4} | [−64 −46 84 116] |
| DRU106, i = | [−103 −58 54 99], [−102 −80 33 114] |
| {1, 2} | |

In examples provided herein, all DRUs lead to low PAPR results.

TABLE 14
PAPR results without single-stream pilots and with single stream pilots
(Alternative 1) for 20 MHz DRU LTF based on the proposed methodology

| PAPR | | | | | | | | | |
|---|---|---|---|---|---|---|---|---|---|
| [dB] | 1 | 2 | 3 | 4 | 5 | 6 | 7 | 8 | 9 |
| DRU26 | 3.01, 3.94 | 2.96, 4.04 | 3.01, 3.94 | 2.96, 4.04 | 3.01, 3.94 | 3.01, 3.94 | 2.96, 4.04 | 3.01, 3.94 | 2.96, 4.04 |

| | | | | |
|---|---|---|---|---|
| DRU52 | 3.01, 4.35 | 3.01, 4.23 | 3.01, 4.35 | 3.01, 4.23 |

| | | |
|---|---|---|
| DRU106 | 3.91, 4.53 | 3.93, 4.62 |

TABLE 15
PAPR results without single-stream pilots and with single stream pilots
(Alternative 2) for 20 MHz DRU LTF based on the proposed methodology

| PAPR | | | | | | | | | |
|---|---|---|---|---|---|---|---|---|---|
| [dB] | 1 | 2 | 3 | 4 | 5 | 6 | 7 | 8 | 9 |
| DRU26 | 3.01, 3.94 | 2.96, 4.22 | 3.01, 3.94 | 2.96, 4.22 | 3.01, 3.94 | 3.01, 3.94 | 2.96, 4.22 | 3.01, 3.94 | 2.96, 4.22 |

| | | | | |
|---|---|---|---|---|
| DRU52 | 3.01, 4.35 | 3.01, 4.34 | 3.01, 4.35 | 3.01, 4.34 |

| | | |
|---|---|---|
| DRU106 | 3.94, 4.65 | 3.93, 4.62 |

The MATLAB implementation is also given as a reference below.

clear all
close all
clc
tonesDRU26{1} = [−121:9:−13, 5:9:113];
tonesDRU26{2} = [−117:9:−9, 9:9:117];
tonesDRU26{3} = [−119:9:−11, 7:9:115];
tonesDRU26{4} = [−115:9:−7, 11:9:119];
tonesDRU26{5} = [−113:9:−5, 13:9:121];
tonesDRU26{6} = [−120:9:−12, 6:9:114];
tonesDRU26{7} = [−116:9:−8, 10:9:118];
tonesDRU26{8} = [−118:9:−10, 8:9:116];
tonesDRU26{9} = [−114:9:−6, 12:9:120];
tonesDRU52{1} = sort([tonesDRU26{1:2}],‘ascend’);
tonesDRU52{2} = sort([tonesDRU26{3:4}],‘ascend’);
tonesDRU52{3} = sort([tonesDRU26{6:7}],‘ascend’);
tonesDRU52{4} = sort([tonesDRU26{8:9}],‘ascend’);
tonesDRU106{1} = sort([tonesDRU52{1:2}, −4, 3],‘ascend’);
tonesDRU106{2} = sort([tonesDRU52{3:4}, −3, 4],‘ascend’);
%alternative 1
pilotsDRU26{1} = [−94 32];
pilotsDRU26{2} = [−117 117];
pilotsDRU26{3} = [−92 34];
pilotsDRU26{4} = [−115 119];
pilotsDRU26{5} = [−86 40];
pilotsDRU26{6} = [−93 33];
pilotsDRU26{7} = [−116 118];
pilotsDRU26{8} = [−91 35];
pilotsDRU26{9} = [−114 120];
pilotsDRU52{1} = [−67 −49 81 113];
pilotsDRU52{2} = [−67 −49 81 113]+2;
pilotsDRU52{3} = [−67 −49 81 113]+1;
pilotsDRU52{4} = [−67 −49 81 113]+3;
pilotsDRU106{1} = [−85 −58 99 117];
pilotsDRU106{2} = [−103 −81 32 113]+1;
%alternative 2
pilotsDRU26{1} = [−94 32];
pilotsDRU26{2} = [−31 86]+4;
pilotsDRU26{3} = [−94 32]+2;
pilotsDRU26{4} = [−31 86]+6;
pilotsDRU26{5} = [−94 32]+8;
pilotsDRU26{6} = [−94 32]+1;
pilotsDRU26{7} = [−31 86]+5;
pilotsDRU26{8} = [−94 32]+3;
pilotsDRU26{9} = [−31 86]+7;
pilotsDRU52{1} = [−67 −49 81 113];
pilotsDRU52{2} = [−67 −49 81 113]+2;
pilotsDRU52{3} = [−67 −49 81 113]+1;
pilotsDRU52{4} = [−67 −49 81 113]+3;
pilotsDRU106{1} = [−103 −58 54 99];
pilotsDRU106{2} = [−103 −81 32 113]+1;
Ga13 = [1 1 1 1i −1 1 1 −1i 1 −1 1 −1i 1i];
Gb13 = 1i*conj(fliplr([1 1i −1 −1 −1 1i −1 1 1 −1i −1 1 −1i]));
tones = [−122:122];
masterSequence = zeros(1,numel(tones));
masterSequence(tonesDRU26{1}+123) = [Ga13 Gb13];
masterSequence(tonesDRU26{2}+123) = [Ga13 −Gb13];
masterSequence(tonesDRU26{3}+123) = [Ga13 Gb13];
masterSequence(tonesDRU26{4}+123) = [−Ga13 Gb13];
masterSequence(tonesDRU26{5}+123) = [Ga13 Gb13];
masterSequence(tonesDRU26{6}+123) = [Ga13 Gb13];
masterSequence(tonesDRU26{7}+123) = [Ga13 −Gb13];
masterSequence(tonesDRU26{8}+123) = [−Ga13 −Gb13];
masterSequence(tonesDRU26{9}+123) = [Ga13 −Gb13];
extra106 = [−4 −3 3 4].′;
masterSequence(extra106+123) = [−1i −1i 1 1];

In an example, a UHR DRU-LFT design may use QPSK in a 40 MHz distribution bandwidth. Consider a DRU tone allocation given in Table 16, below.

TABLE 16
An example of a DRU table for a nested tone allocation (40 MHz)
Data and pilot subcarrier indices for Distributed Tone RUs (DRUs) in a 40 MHz UHR TB PPDU

| DRU type | DRU index and subcarrier range | | | | | |
|---|---|---|---|---|---|---|
| 26-tone | DRU1 | DRU2 | DRU3 | DRU4 | DRU5 | DRU6 |
| DRU | [−242:18:−26, | [−233:18:−17, | [−238:18:−22, | [−229:18:−13, | [−225:18:−9, | [−240:18:−24, |
| i = 1:18 | 10:18:226] | 19:18:235] | 14:18:230] | 23:18:239] | 27:18:243] | 12:18:228] |
| | DRU7 | DRU8 | DRU9 | DRU10 | DRU11 | DRU12 |
| | [−231:18:−15, | [−236:18:−20, | [−227:18:−11, | [−241:18:−25, | [−232:18:−16, | [−237:18:−21, |
| | 21:18:237] | 16:18:232] | 25:18:241] | 11:18:227] | 20:18:236] | 15:18:231] |
| | DRU13 | DRU14 | DRU15 | DRU16 | DRU17 | DRU18 |
| | [−228:18:−12, | [−234:18:−18, | [−239:18:−23, | [−230:18:−14, | [−235:18:−19, | [−226:18:−10, |
| | 24:18:240] | 18:18:234] | 13:18:229] | 22:18:238] | 17:18:233] | 26:18:242] |

| | | | |
|---|---|---|---|
| 52-tone | DRU1 | DRU2 | DRU3 |
| DRU | [−242:9:−17, 10:9:235] | [−238:9:−13, 14:9:239] | [−240:9:−15, 12:9:237] |
| i = 1:8 | DRU4 | DRU5 | DRU6 |
| | [−236:9:−11, 16:9:241] | [−241:9:−16, 11:9:236] | [−237:9:−12, 15:9:240] |
| | DRU7 | DRU8 | |
| | [−239:9:−14, 13:9:238] | [−235:9:−10, 17:9:242] | |
| 106-tone | DRU1 | DRU2 | DRU3 |
| DRU | 26-tone [DRU1~4], [−8, 5] | 26-tone [DRU6~9], [−6, 7] | 26-tone [DRU10~13], [−7, 6] |
| i = 1:4 | DRU4 | | |
| | 26-tone [DRU15~18], [−5, 8] | | |
| 242-tone | DRU1 | DRU2 | |
| DRU | 106-tone [DRU1~2], 26-tone | 106-tone [DRU3~4], 26-tone | |
| i = 1:2 | DRU5, [−244, −4, 3, 9] | DRU14, [−243, −3, 4, 244] | |

The nested tone allocation is shown in Tabte 17.

TABLE 17
Nested tone allocation based on Table 16 and the provided notation (40 MHz)

| 1^{st} level DRUs | 2^{nd} level DRUs | 3^{rd} level DRUs | 4^{th} level DRUs |
|---|---|---|---|
| (R₁ = 26, U₁ = 18) | (R₂ = 52, U₂ = 8) | (R₃ = 106, U₃ = 4) | (R₄ = 242, U₄ = 2) |
| ${T}_{1}^{( 1 )} = \{ - 242 : 18 : - 26 , 10 : 18 : 226 \}$ | ${T}_{1}^{( 2 )} = {T}_{1}^{( 1 )} ⋃ {T}_{2}^{( 1 )}$ | ${T}_{1}^{( 3 )} = {T}_{1}^{( 2 )} ⋃ {T}_{2}^{( 2 )} ⋃ {E}_{1}^{( 3 )}$ | ${T}_{1}^{( 4 )} = {T}_{1}^{( 3 )} ⋃ {T}_{2}^{( 3 )} ⋃ {E}_{1}^{( 4 )}$ |
| ${T}_{2}^{( 1 )} = \{ - 233 : 18 : - 17 , 19 : 18 : 235 \}$ | | ${E}_{1}^{( 3 )} = \{ - 8 , 5 \}$ | ${E}_{1}^{( 4 )} = \{ {T}_{5}^{( 1 )} , - 244 , - 4 , 3 , 9 \}$ |
| ${T}_{3}^{( 1 )} = \{ - 238 : 18 : - 22 , 14 : 18 : 230 \}$ | ${T}_{2}^{( 2 )} = {T}_{3}^{( 1 )} ⋃ {T}_{4}^{( 1 )}$ | | |
| ${T}_{4}^{( 1 )} = \{ - 229 : 18 : - 13 , 23 : 18 : 239 \}$ | | | |
| ${T}_{5}^{( 1 )} = \{ - 225 : 18 : - 9 , 27 : 18 : 243 \}$ | | | |
| ${T}_{6}^{( 1 )} = \{ - 240 : 18 : - 24 , 12 : 18 : 228 \}$ | ${T}_{3}^{( 2 )} = {T}_{6}^{( 1 )} ⋃ {T}_{7}^{( 1 )}$ | ${T}_{2}^{( 3 )} = {T}_{3}^{( 2 )} ⋃ {T}_{4}^{( 2 )} ⋃ {E}_{2}^{( 3 )}$ | |
| ${T}_{7}^{( 1 )} = \{ - 231 : 18 : - 15 , 21 : 18 : 237 \}$ | | ${E}_{2}^{( 3 )} = \{ - 6 , 7 \}$ | |
| ${T}_{8}^{( 1 )} = \{ - 236 : 18 : - 20 , 16 : 18 : 232 \}$ | ${T}_{4}^{( 2 )} = {T}_{8}^{( 1 )} ⋃ {T}_{9}^{( 1 )}$ | | |
| ${T}_{9}^{( 1 )} = \{ - 227 : 18 : - 11 , 25 : 18 : 241 \}$ | | | |
| ${T}_{10}^{( 1 )} = \{ - 241 : 18 : - 25 , 11 : 18 : 227 \}$ | ${T}_{5}^{( 2 )} = {T}_{10}^{( 1 )} ⋃ {T}_{11}^{( 1 )}$ | ${T}_{3}^{( 3 )} = {T}_{5}^{( 2 )} ⋃ {T}_{6}^{( 2 )} ⋃ {E}_{4}^{( 3 )}$ | ${T}_{2}^{( 4 )} = {T}_{3}^{( 3 )} ⋃ {T}_{4}^{( 3 )} ⋃ {E}_{2}^{( 4 )}$ |
| ${T}_{11}^{( 1 )} = \{ - 232 : 18 : - 16 , 20 : 18 : 236 \}$ | | ${E}_{3}^{( 3 )} = \{ - 7 , 6 \}$ | ${E}_{2}^{( 4 )} = \{ {T}_{14}^{( 1 )} , - 243 , - 3 , 4 , 244 \}$ |
| ${T}_{12}^{( 1 )} = \{ - 237 : 18 : - 21 , 15 : 18 : 231 \}$ | ${T}_{6}^{( 2 )} = {T}_{12}^{( 1 )} ⋃ {T}_{13}^{( 1 )}$ | | |
| ${T}_{13}^{( 1 )} = \{ - 228 : 18 : - 12 , 24 : 18 : 240 \}$ | | | |
| ${T}_{14}^{( 1 )} = \{ - 234 : 18 : - 18 , 18 : 18 : 234 \}$ | | | |
| ${T}_{15}^{( 1 )} = \{ - 239 : 18 : - 23 , 13 : 18 : 229 \}$ | ${T}_{7}^{( 2 )} = {T}_{15}^{( 1 )} ⋃ {T}_{16}^{( 1 )}$ | ${T}_{4}^{( 3 )} = {T}_{7}^{( 2 )} ⋃ {T}_{8}^{( 2 )} ⋃ {E}_{4}^{( 3 )}$ | |
| ${T}_{16}^{( 1 )} = \{ - 230 : 18 : - 14 , 22 : 18 : 238 \}$ | | ${E}_{4}^{( 3 )} = \{ - 5 , 8 \}$ | |
| ${T}_{17}^{( 1 )} = \{ - 235 : 18 : - 19 , 17 : 18 : 233 \}$ | ${T}_{8}^{( 2 )} = {T}_{17}^{( 1 )} ⋃ {T}_{18}^{( 1 )}$ | | |
| ${T}_{18}^{( 1 )} = \{ - 226 : 18 : - 10 , 26 : 18 : 242 \}$ | | | |

As can be seen in Table 17, 2^{nd}-level DRUs may consist of 1^{st}-level DRUs. Similarly, a 3^{rd}-level DRU may consist of several 2^{nd}-level DRUs, and 4^{th}-level DRUs consists of 3^{rd}-level DRUs. Also, DRUs may include some extra tones (i.e., the ones in E₁₋₄⁽³⁾ and E_{1,2}⁽⁴⁾) Similar to 20 MHz, we are looking for a master sequence that leads to a low PAPR value for xₛ_{_{l,i}}(t), for all possible l and i, without any exhaustive search for the nested tone allocation in Table 17.

In another example, consider the following seed GCP: Sₐ=(1, 1, 1, 1i, −1, 1, 1, −1i,1, −, −1, 1), s_{b}=(1 1i−1−1−11i−1, 1, 1−1i 11−1i).

Based on the example methods provided herein, w_{a,i} and w_{b,i} for i=1, . . . , 18, at the first level may be chosen as in Table 18 such that they form a CS obeying (1) and (2) when the corresponding sequences are combined at a higher-level DRU.

TABLE 18
An example of choices of w_{a, i} and
w_{b, i} based on proposed solution (40 MHz)

| i | w_{a, i} | w_{b, i} |
|---|---|---|
| 1 | 1 | 1 |
| 2 | 1 | −1 |
| 3 | 1 | 1 |
| 4 | −1 | 1 |
| 5 | 1 | 1i |
| 6 | 1 | 1 |
| 7 | 1 | −1 |
| 8 | −1 | −1 |
| 9 | 1 | −1 |
| 10 | 1 | 1 |
| 11 | 1 | −1 |
| 12 | 1 | 1 |
| 13 | −1 | 1 |
| 14 | 1 | 1 |
| 15 | −1 | −1 |
| 16 | −1 | 1 |
| 17 | 1 | 1 |
| 18 | −1 | 1 |

As shown in Table 19, the seed GCP, along with the choices of w_{a,i} and w_{b,i}, leads to the CSs (based on (1) and (2)) via pₛ_{_{1,i}}(z)=p_{w}_{_{a,i}}ₛ_{ₐ}(z¹⁸)+p_{w}_{_{b,i}}ₛ_{_{b}}(z¹⁸)z²⁵² for the first-level DRUs while preparing GCPs for the second-level.

TABLE 19
The CSs at the first-level DRUs form GCP for the second-level DRUs (40 MHz)

| | | Is s_{1,i} | Does a GCP exist for the next level |
|---|---|---|---|
| 1^{st}-level DRU tone indices | m_{1,i} | a CS? | based on the formulas in (1) or (2)? |
| $\begin{matrix}{T}_{1}^{( 1 )} = \{ - 242 : 18 : - 26 , 10 : 18 : 226 \} \\ {T}_{2}^{( 1 )} = \{ - 233 : 18 : - 17 , 19 : 18 : 235 \}\end{matrix}$ | −242 −233 | Yes Yes | (c, d) = (s_{1,1}, s_{1,2}) is a GCP as (a, b) = (sₐ, s_{b}) is a GCP and (α, β) = (1, 1) |
| $\begin{matrix}{T}_{3}^{( 1 )} = \{ - 238 : 18 : - 22 , 14 : 18 : 230 \} \\ {T}_{4}^{( 1 )} = \{ - 229 : 18 : - 13 , 23 : 18 : 239 \}\end{matrix}$ | −238 −229 | Yes Yes | (c, d) = (s_{1,4}, s_{1,3}) is a GCP as (a, b) = (sₐ, s_{b}) is a GCP and (α, β) = (−1, 1) |
| ${T}_{5}^{( 1 )} = \{ - 225 : 18 : - 9 , 27 : 18 : 243 \}$ | −225 | Yes | |
| $\begin{matrix}{T}_{6}^{( 1 )} = \{ - 240 : 18 : - 24 , 12 : 18 : 228 \} \\ {T}_{7}^{( 1 )} = \{ - 231 : 18 : - 15 , 21 : 18 : 237 \}\end{matrix}$ | −240 −231 | Yes Yes | (c, d) = (s_{1,6}, s_{1,7}) is a GCP as (a, b) = (sₐ, s_{b}) is a GCP and (α, β) = (1, 1) |
| $\begin{matrix}{T}_{8}^{( 1 )} = \{ - 236 : 18 : - 20 , 16 : 18 : 232 \} \\ {T}_{9}^{( 1 )} = \{ - 227 : 18 : - 11 , 25 : 18 : 241 \}\end{matrix}$ | −236 −227 | Yes Yes | (c, d) = (s_{1,9}, s_{1,8}) is a GCP as (a, b) = (sₐ, s_{b}) is a GCP and (α, β) = (−1, 1) |
| $\begin{matrix}{T}_{10}^{( 1 )} = \{ - 241 : 18 : - 25 , 11 : 18 : 227 \} \\ {T}_{11}^{( 1 )} = \{ - 232 : 18 : - 16 , 20 : 18 : 236 \}\end{matrix}$ | −241 −232 | Yes Yes | (c, d) = (s_{1,10}, s_{1,11}) is a GCP as (a, b) = (sₐ, s_{b}) is a GCP and (α, β) = (1, 1) |
| $\begin{matrix}{T}_{12}^{( 1 )} = \{ - 237 : 18 : - 21 , 15 : 18 : 231 \} \\ {T}_{13}^{( 1 )} = \{ - 228 : 18 : - 12 , 24 : 18 : 240 \}\end{matrix}$ | −237 −228 | Yes Yes | (c, d) = (s_{1,13}, s_{1,12}) is a GCP as (a, b) = (sₐ, s_{b}) is a GCP and (α, β) = (−1, 1) |
| ${T}_{14}^{( 1 )} = \{ - 234 : 18 : - 18 , 18 : 18 : 234 \}$ | −234 | Yes | |
| $\begin{matrix}{T}_{15}^{( 1 )} = \{ - 239 : 18 : - 23 , 13 : 18 : 229 \} \\ {T}_{16}^{( 1 )} = \{ - 230 : 18 : - 14 , 22 : 18 : 238 \}\end{matrix}$ | −239 −230 | Yes Yes | (c, d) = (s_{1,15}, s_{1,16}) is a GCP as (a, b) = (sₐ, s_{b}) is a GCP and (α, β) = (−1, −1) |
| $\begin{matrix}{T}_{17}^{( 1 )} = \{ - 235 : 18 : - 19 , 17 : 18 : 233 \} \\ {T}_{18}^{( 1 )} = \{ - 226 : 18 : - 10 , 26 : 18 : 242 \}\end{matrix}$ | −235 −226 | Yes Ye | (c, d) = (s_{1,18}, s_{1,17}) is a GCP as (a, b) = (sₐ, s_{b}) is a GCP and (α, β) = (1, −1) |

As shown in Table 20, the sequences at the first-level DRUs form CSs (based on (1) and (2)) in the form of pₛ_{_{2,i}}(z)=pₐ(z)+p_{b}(z)z⁹ for the second-level DRUs while preparing GCPs for the third level.

TABLE 20
The CSs at the first-level DRUs lead to the CSs for the
second-level DRUs while preparing GCP for the third level (40 MHz)

| | | | Does a GCP exist for the |
|---|---|---|---|
| 2^{nd}-level DRU | | Is s_{2,i} | next level based on the |
| tone indices | m_{2,i} | a CS? | formulas in (1) or (2)? |
| ${T}_{1}^{( 2 )} = {T}_{1}^{( 1 )} ⋃ {T}_{2}^{( 1 )}$ | −242 | Yes | Yes |
| ${T}_{2}^{( 2 )} = {T}_{3}^{( 1 )} ⋃ {T}_{4}^{( 1 )}$ | −238 | Yes | |
| ${T}_{3}^{( 2 )} = {T}_{6}^{( 1 )} ⋃ {T}_{7}^{( 1 )}$ | −240 | Yes | Yes |
| ${T}_{4}^{( 2 )} = {T}_{8}^{( 1 )} ⋃ {T}_{9}^{( 1 )}$ | −236 | Yes | |
| ${T}_{5}^{( 2 )} = {T}_{10}^{( 1 )} ⋃ {T}_{11}^{( 1 )}$ | −241 | Yes | Yes |
| ${T}_{6}^{( 2 )} = {T}_{12}^{( 1 )} ⋃ {T}_{13}^{( 1 )}$ | −237 | Yes | |
| ${T}_{7}^{( 2 )} = {T}_{15}^{( 1 )} ⋃ {T}_{16}^{( 1 )}$ | −239 | Yes | Yes |
| ${T}_{8}^{( 2 )} = {T}_{17}^{( 1 )} ⋃ {T}_{18}^{( 1 )}$ | −235 | Yes | |

As shown in Table 21, the sequences at the second-level DRUs form CSs (based on (1) and (2)) in the form of pₛ_{_{2,i}}(z)=pₐ(z)+p_{b}(z)z⁶ for the third-level DRUs while preparing GCPs for the fourth level.

TABLE 21
The CSs at the second-level DRUs lead to the CSs for the
third-level DRUs while preparing GCP for the fourth level (40 MHz).

| | | | Does a GCP exist for the |
|---|---|---|---|
| 3rd-level DRU | | Is s_{3,i} | next level based on the |
| tone indices | m_{3,i} | a CS? | formulas in (1) or (2)? |
| ${T}_{1}^{( 2 )} ⋃ {T}_{2}^{( 2 )}$ | −242 | Yes | Yes |
| ${T}_{3}^{( 2 )} ⋃ {T}_{4}^{( 2 )}$ | −240 | Yes | |
| ${T}_{5}^{( 2 )} ⋃ {T}_{6}^{( 2 )}$ | −241 | Yes | Yes |
| ${T}_{7}^{( 2 )} ⋃ {T}_{8}^{( 2 )}$ | −239 | Yes | |

As shown in Table 22, the sequences at the third-level DRUs form the CSs (based on (1) and (2)) for the fourth-level DRUs (in the form of pₛ_{₄ᵢ}(z)=pₐ(z)+P_{b}(z)z² The fourth level is the final level in this example.

TABLE 22
CSs at the
third-level DRUs lead to CSs for fourth-level DRUs (40 MHz)

| 4th-level DRU tone indices | m_{4,i} | Is s_{4,i} is CS? |
|---|---|---|
| ${T}_{1}^{( 2 )} ⋃ {T}_{2}^{( 2 )} ⋃ {T}_{3}^{( 2 )} ⋃ {T}_{4}^{( 2 )}$ | −242 | Yes |
| ${T}_{3}^{( 2 )} ⋃ {T}_{4}^{( 2 )} ⋃ {T}_{3}^{( 2 )} ⋃ {T}_{4}^{( 2 )}$ | −241 | Yes |

In summary, the master sequence for 40 MHz DRU LTF may be tabulated as follows in Table 23:

TABLE 23
The values of the master sequence at the specific tones (40 MHz)

| | | | | The values at the tone indices (the sequence |
|---|---|---|---|---|
| | | | | elements are mapped starting from the |
| i | Tone indices | w_{a, i} | w_{b, i} | smallest index to the highest tone index) |
| 1 | [−242:18:−26, 10:18:226]; | 1 | 1 | (w_{a, i} × sₐ, w_{b, i} × s_{b}) |
| 2 | [−233:18:−17, 19:18:235]; | 1 | −1 | (w_{a, i} × sₐ, w_{b, i} × s_{b}) |
| 3 | [−238:18:−22, 14:18:230]; | 1 | 1 | (w_{a, i} × sₐ, w_{b, i} × s_{b}) |
| 4 | [−229:18:−13, 23:18:239]; | −1 | 1 | (w_{a, i} × sₐ, w_{b, i} × s_{b}) |
| 5 | [−225:18:−9, 27:18:243]; | 1 | 1i | (w_{a, i} × sₐ, w_{b, i} × s_{b}) |
| 6 | [−240:18:−24, 12:18:228]; | 1 | 1 | (w_{a, i} × sₐ, w_{b, i} × s_{b}) |
| 7 | [−231:18:−15, 21:18:237]; | 1 | −1 | (w_{a, i} × sₐ, w_{b, i} × s_{b}) |
| 8 | [−236:18:−20, 16:18:232]; | −1 | −1 | (w_{a, i} × sₐ, w_{b, i} × s_{b}) |
| 9 | [−227:18:−11, 25:18:241]; | 1 | −1 | (w_{a, i} × sₐ, w_{b, i} × s_{b}) |
| 10 | [−241:18:−25, 11:18:227]; | 1 | 1 | (w_{a, i} × sₐ, w_{b, i} × s_{b}) |
| 11 | [−232:18:−16, 20:18:236]; | 1 | −1 | (w_{a, i} × sₐ, w_{b, i} × s_{b}) |
| 12 | [−237:18:−21, 15:18:231]; | 1 | 1 | (w_{a, i} × sₐ, w_{b, i} × s_{b}) |
| 13 | [−228:18:−12, 24:18:240]; | −1 | 1 | (w_{a, i} × sₐ, w_{b, i} × s_{b}) |
| 14 | [−234:18:−18, 18:18:234]; | 1 | 1 | (w_{a, i} × sₐ, w_{b, i} × s_{b}) |
| 15 | [−239:18:−23, 13:18:229]; | −1 | −1 | (w_{a, i} × sₐ, w_{b, i} × s_{b}) |
| 16 | [−230:18:−14, 22:18:238]; | −1 | 1 | (w_{a, i} × sₐ, w_{b, i} × s_{b}) |
| 17 | [−235:18:−19, 17:18:233]; | 1 | 1 | (w_{a, i} × sₐ, w_{b, i} × s_{b}) |
| 18 | [−226:18:−10, 26:18:242]; | −1 | 1 | (w_{a, i} × sₐ, w_{b, i} × s_{b}) |
| | Extra tones: [−8:−5, 5:8] | | | (−1i −1i −1i 1i −1i −1i 1i −1i) |
| | Extra tones: [−244 −243 −4 −3 | | | (1i −1i 1 1 1 1i −1 1i) |
| | 3 4 9 244] | | | |

As noted: sₐ=(1, 1, 1, 1i, −1, 1, 1, −1i, 1, −1, 1, −1i, 1), s_{b}=(1 1i−1−1−11i−111−1i−11−1i).

The master sequence can also be shown as a vector:

DLTF_{-244:244} = [ ...
1i −1i 1 1 1 −1 1 1 −1 1 1 1 1 1 −1 −1 −1 1 −1 1 1 1 1 −1 1 1 −1 1 1 1 1 1 −1 −1 −1 1 −1 1 1 1 1 −1 1 1 −1 1 1 1 1 1 −1 −1 −1 1 −
1 1 1i 1i 1i −1i 1i 1i −1i 1i 1i 1i 1i 1i −1i −1i −1i 1i −1i 1i −1 −1 −1 1 −1 −1 1 −1 −1 −1 −1 −1 1 1 1 −1 1 −1 1 1 1 −1 1 1 −1 1 1 1 1
1 −1 −1 −1 1 −1 1 1 1 1 −1 1 1 −1 1 1 1 1 1 −1 −1 −1 1 −1 1 −1i −1i −1i 1i −1i −1i 1i −1i −1i −1i −1i −1i 1i 1i 1i −1i 1i −1i 1 1 1 −1 1
1 −1 1 1 1 1 1 −1 −1 −1 1 −1 1 −1 −1 −1 1 −1 −1 1 −1 −1 −1 −1 −1 1 1 1 −1 1 −1 1 1 1 −1 1 1 −1 1 1 1 1 1 −1 −1 −1 1 −1 1 −1i −1i −
1i 1i −1i −1i 1i −1i −1i −1i −1i −1i 1i 1i 1i −1i 1i −1i 1i 1i 1i −1i 1i 1i −1i 1i 1i 1i 1i 1i −1i −1i −1i 1i −1i 1i −1i −1i −1i 1i 1 1 0 0 0 0 0
1 1i −1i −1i 1i −1i −1 1 1 1 −1 1 1 −1 1 1 −1 −1 −1 1 1 1 −1 1 1i 1i 1i 1i −1i 1i 1i −1i 1i 1i −1i −1i −1i 1i 1i 1i −1i 1i −1 −1 −1 −1 1 −1
−1 1 −1 −1 1 1 1 −1 −1 −1 1 −1 −1i −1 −1 −1 1 −1 −1 1 −1 −1 1 1 1 −1 −1 −1 1 −1 −1i −1 −1 −1 1 −1 −1 1 −1 −1 1 1 1 −1 −1 −1 1 −1 −
1i 1i 1i 1i −1i 1i 1i −1i 1i 1i −1i −1i −1i 1i 1i 1i −1i 1i −1 −1 −1 −1 1 −1 −1 1 −1 −1 1 1 1 −1 −1 −1 1 −1 −1i 1 1 1 −1 1 1 −1 1 1 −1 −1
−1 1 1 1 −1 1 1i 1 1 1 −1 1 1 −1 1 1 −1 −1 −1 1 1 1 −1 1 1i −1i −1i −1i 1i −1i −1i 1i −1i −1i 1i 1i 1i −1i −1i −1i 1i −1i 1 −1 −1 −1 1 −1
−1 1 −1 −1 1 1 1 −1 −1 −1 1 −1 −1i 1 1 1 −1 1 1 −1 1 1 −1 −1 −1 1 1 1 −1 1 1i −1i −1i −1i 1i −1i −1i 1i −1i −1i 1i 1i 1i −1i −1i −1i 1i −
1i 1 1i]

Note that this sequence may be multiplied with a coefficient on the unit circle, such as e^{jπ/4} or e^{-jπ/4}, to rotate the elements so that the elements of the sequence are in a specific constellation, e.g., QPSK modulation like e^{jπ/4}×{1, 1i, −1, −1i}. The values on the extra tone indices may be chosen to minimize PAPR further via random search.

PAPR results for this design are given in Table 24, below.

TABLE 24
PAPR results for 40 MHz DRU LTF based on the proposed methodology

| PAPR [dB] | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| DRU26 | 3.01 | 3.01 | 3.01 | 3.01 | 3.00 | 3.01 | 3.01 | 3.01 | 3.01 | 3.01 | 3.01 | 3.01 | 3.01 | 3.01 | 3.01 | 3.01 | 3.01 | 3.01 |

| | | | | | | | | |
|---|---|---|---|---|---|---|---|---|
| DRU52 | 3.00 | 3.00 | 3.00 | 3.00 | 3.00 | 3.00 | 3.00 | 3.00 |

| | | | | |
|---|---|---|---|---|
| DRU106 | 3.84 | 3.82 | 3.84 | 3.82 |

| | | |
|---|---|---|
| DRU242 | 5.00 | 5.01 |

The MATLAB implementation is also given as a reference below.

tonesDRU26{1} = [−242:18:−26, 10:18:226];
tonesDRU26{2} = [−233:18:−17, 19:18:235];
tonesDRU26{3} = [−238:18:−22, 14:18:230];
tonesDRU26{4} = [−229:18:−13, 23:18:239];
tonesDRU26{5} = [−225:18:−9, 27:18:243];
tonesDRU26{6} = [−240:18:−24, 12:18:228];
tonesDRU26{7} = [−231:18:−15, 21:18:237];
tonesDRU26{8} = [−236:18:−20, 16:18:232];
tonesDRU26{9} = [−227:18:−11, 25:18:241];
tonesDRU26{10} = [−241:18:−25, 11:18:227];
tonesDRU26{11} = [−232:18:−16, 20:18:236];
tonesDRU26{12} = [−237:18:−21, 15:18:231];
tonesDRU26{13} = [−228:18:−12, 24:18:240];
tonesDRU26{14} = [−234:18:−18, 18:18:234];
tonesDRU26{15} = [−239:18:−23, 13:18:229];
tonesDRU26{16} = [−230:18:−14, 22:18:238];
tonesDRU26{17} = [−235:18:−19, 17:18:233];
tonesDRU26{18} = [−226:18:−10, 26:18:242];
Ga13 = [1 1 1 1i −1 1 1 −1i 1 −1 1 −1i 1i];
Gb13 = [1 1i −1 −1 −1 1i −1 1 1 −1i −1 1 −1i];
tones = [−244:244];
masterSequence = zeros(1,numel(tones));
masterSequence(tonesDRU26{1}+245) = [Ga13 Gb13];
masterSequence(tonesDRU26{2}+245) = [Ga13 −Gb13];
masterSequence(tonesDRU26{3}+245) = [Ga13 Gb13];
masterSequence(tonesDRU26{4}+245) = [−Ga13 Gb13];
%
masterSequence(tonesDRU26{5}+245) = [Ga13 1i*Gb13];
%
masterSequence(tonesDRU26{6}+245) = [Ga13 Gb13];
masterSequence(tonesDRU26{7}+245) = [Ga13 −Gb13];
masterSequence(tonesDRU26{8}+245) = [−Ga13 −Gb13];
masterSequence(tonesDRU26{9}+245) = [Ga13 −Gb13];
masterSequence(tonesDRU26{10}+245) = [Ga13 Gb13];
masterSequence(tonesDRU26{11}+245) = [Ga13 −Gb13];
masterSequence(tonesDRU26{12}+245) = [Ga13 Gb13];
masterSequence(tonesDRU26{13}+245) = [−Ga13 Gb13];
%
masterSequence(tonesDRU26{14}+245) = [Ga13 Gb13];
%
masterSequence(tonesDRU26{15}+245) = −[Ga13 Gb13];
masterSequence(tonesDRU26{16}+245) = −[Ga13 −Gb13];
masterSequence(tonesDRU26{17}+245) = −[−Ga13 −Gb13];
masterSequence(tonesDRU26{18}+245) = −[Ga13 −Gb13];
masterSequence([−8:−5,5:8]+245) = [−1i −1i −1i 1i −1i −1i 1i −1i];
masterSequence([−244 −243 −4 −3 3 4 9 244]+245) = [1i −1i 1 1 1 1i −1 1i];

In another example, a UHR DRU-LFT design may use QPSK in a 40 MHz distribution bandwidth for single stream pilots. Consider a DRU tone allocation in the previous example for 40 MHz given in Table 16 and Table 17.

Consider the following seed GCP: sₐ=(1, 1, 1,i, 1, 1, 1, 1i, 1, −1, 1, 1i, 1i), s_{b}=(−1 1i−1, −1, 1, −i, −i,−1i, −1i, 1, 1i).

Note that s_{b} in this example is equal to the sequence (1 1i−1−1−11i−111−1i−11−1i) after is 1) reversed in order (of elements of the sequence), 2) complex conjugated, and 3) multiplied with i \sqrt{−1}. Based on the proposed method, w_{a,i} and w_{b,i} for i=1, . . . , 18, at the first level may be chosen a such that they form a CS obeying (1) and (2) when the corresponding sequences are combined at a higher-level DRU as given in Table 25.

TABLE 25
The values of the master sequence at the specific tones (40 MHz).

| | | | | The values at the tone indices (the sequence |
|---|---|---|---|---|
| | | | | elements are mapped starting from the |
| i | Tone indices | w_{a, i} | w_{b, i} | smallest index to the highest tone index) |
| 1 | [−242:18:−26, 10:18:226]; | 1 | 1 | (w_{a, i} × sₐ, w_{b, i} × s_{b}) |
| 2 | [−233:18:−17, 19:18:235]; | 1 | −1 | (w_{a, i} × sₐ, w_{b, i} × s_{b}) |
| 3 | [−238:18:−22, 14:18:230]; | 1 | 1 | (w_{a, i} × sₐ, w_{b, i} × s_{b}) |
| 4 | [−229:18:−13, 23:18:239]; | −1 | 1 | (w_{a, i} × sₐ, w_{b, i} × s_{b}) |
| 5 | [−225:18:−9, 27:18:243]; | 1 | 1i | (w_{a, i} × sₐ, w_{b, i} × s_{b}) |
| 6 | [−240:18:−24, 12:18:228]; | 1 | 1 | (w_{a, i} × sₐ, w_{b, i} × s_{b}) |
| 7 | [−231:18:−15, 21:18:237]; | 1 | −1 | (w_{a, i} × sₐ, w_{b, i} × s_{b}) |
| 8 | [−236:18:−20, 16:18:232]; | −1 | −1 | (w_{a, i} × sₐ, w_{b, i} × s_{b}) |
| 9 | [−227:18:−11, 25:18:241]; | 1 | −1 | (w_{a, i} × sₐ, w_{b, i} × s_{b}) |
| 10 | [−241:18:−25, 11:18:227]; | 1 | 1 | (w_{a, i} × sₐ, w_{b, i} × s_{b}) |
| 11 | [−232:18:−16, 20:18:236]; | 1 | −1 | (w_{a, i} × sₐ, w_{b, i} × s_{b}) |
| 12 | [−237:18:−21, 15:18:231]; | 1 | 1 | (w_{a, i} × sₐ, w_{b, i} × s_{b}) |
| 13 | [−228:18:−12, 24:18:240]; | −1 | 1 | (w_{a, i} × sₐ, w_{b, i} × s_{b}) |
| 14 | [−234:18:−18, 18:18:234]; | 1 | 1 | (w_{a, i} × sₐ, w_{b, i} × s_{b}) |
| 15 | [−239:18:−23, 13:18:229]; | −1 | −1 | (w_{a, i} × sₐ, w_{b, i} × s_{b}) |
| 16 | [−230:18:−14, 22:18:238]; | −1 | 1 | (w_{a, i} × sₐ, w_{b, i} × s_{b}) |
| 17 | [−235:18:−19, 17:18:233]; | 1 | 1 | (w_{a, i} × sₐ, w_{b, i} × s_{b}) |
| 18 | [−226:18:−10, 26:18:242]; | −1 | 1 | (w_{a, i} × sₐ, w_{b, i} × s_{b}) |
| | Extra tones: [−8:−5, 5:8] | | | (−1i −1i −1i 1i 1i 1i 1i −1i) |
| | Extra tones: [−244 −243 −4 −3 | | | (−1 −1i 1i 1 1i 1i 1i 1i) |
| | 3 4 9 244] | | | |

The master sequence can be shown as a vector:

DLTF_{-244:244} = [ . . .
−1 −1i 1 1 1 −1 1 1 −1 1 1 1 1 1 −1 −1 −1 1 −1 1 1 1 1 −1 1 1 −1 1 1 1 1 1 −1 −1 −1 1 −1 1 1 1 1 −1 1 1 −1 1 1 1 1 1 −1 −1 −1 1 −1
1 1i 1i 1i −1i 1i 1i −1i 1i 1i 1i 1i 1i −1i −1i −1i 1i −1i 1i −1 −1 −1 1 −1 −1 1 −1 −1 −1 −1 −1 1 1 1 −1 1 −1 1 1 1 −1 1 1 −1 1 1 1 1 1
−1 −1 −1 1 −1 1 1 1 1 −1 1 1 −1 1 1 1 1 1 −1 −1 −1 1 −1 1 −1i −1i −1i 1i −1i −1i 1i −1i −1i −1i −1i −1i 1i 1i 1i −1i 1i −1i 1 1 1 −1 1 1 −
1 1 1 1 1 1 −1 −1 −1 1 −1 1 −1 −1 −1 1 −1 −1 1 −1 −1 −1 −1 −1 1 1 1 −1 1 −1 1 1 1 −1 1 1 −1 1 1 1 1 1 −1 −1 −1 1 −1 1 −1i −1i −1i
1i −1i −1i 1i −1i −1i −1i −1i −1i 1i 1i 1i −1i 1i −1i 1i 1i 1i −1i 1i 1i −1i 1i 1i 1i 1i 1i −1i −1i −1i 1i −1i 1i −1i −1i −1i 1i 1i 1 0 0 0 0 0 1i
1i 1i 1i 1i −1i 1i −1 −1 −1 1 −1 −1 1 −1 −1 1 1 1 −1 −1 −1 1 −1 −1 1i 1i 1i −1i 1i 1i −1i 1i 1i −1i −1i −1i 1i 1i 1i −1i 1i 1i −1i −1i −1i 1i
−1i −1i 1i −1i −1i 1i 1i 1i −1i −1i −1i 1i −1i −1i −1 −1 −1 1 −1 −1 1 −1 −1 1 1 1 −1 −1 −1 1 −1 −1 1i 1i 1i −1i 1i 1i −1i 1i 1i −1i −1i −1i 1i
1i 1i −1i 1i 1i 1i 1i 1i −1i 1i 1i −1i 1i 1i −1i −1i −1i 1i 1i 1i −1i 1i 1i −1i −1i −1i 1i −1i −1i 1i −1i −1i 1i 1i 1i −1i −1i −1i 1i −1i −1i 1 1 1
−1 1 1 −1 1 1 −1 −1 −1 1 1 1 −1 1 1 −1i −1i −1i 1i −1i −1i 1i −1i −1i 1i 1i 1i −1i −1i −1i −1i −1i 1i −1i −1i 1i −1i −1i 1i 1i
1i −1i −1i −1i 1i −1i −1i −1i −1i −1i 1i −1i −1i 1i −1i −1i 1i 1i 1i −1i −1i −1i 1i −1i −1i 1 1 1 −1 1 1 −1 1 1 −1 −1 −1 1 1 1 −1 1 1 1i 1i 1i
−1i 1i 1i −1i 1i 1i −1i −1i −1i 1i 1i 1i −1i 1i 1i 1i]

Note that that this sequence may be multiplied with a coefficient on the unit circle, such as e^{jπ/4} or e^{-jπ/4} to rotate the elements so that the elements of the sequence are in a specific constellation, e.g., QPSK modulation like e^{jπ/4}×{1, 1i, −1,−1i}.

For example, for this tone plan, single-stream pilot tone indices may be chosen as in Table 26 or Table 27. The difference between these pilot indices is that Alternative 1 may consists of tone at the edge of bandwidth, while Alternative 2 does not have pilot indices at the edges.

TABLE 26
Pilot indices (40 MHz) - Alternative 1

| | Single stream pilot indices for DRU transmission over 40 MHz, |
|---|---|
| DRU size | pilot tones starting from smallest i to larger i |
| DRU26, i = | [−188 64], [−233 235], [−184 68], [−229 239], [−171 81], [−186 66], [−231 237], [−182 |
| {1 . . . 18} | 70], [−227 241], [−187 65], [−232 236], [−183 69], [−228 240], [−180 72], [−185 67], |
| | [−230 238], [−181 71], [−226 242] |
| DRU52, i = | [−224 −125 28 127], [−202 −103 50 149], [−213 −114 39 138], [−191 −92 61 |
| {1, . . . , 8} | 160], [−169 −70 83 182], [−147 −48 105 204], [−158 −59 94 193], [−136 −37 |
| | 116 215], |
| DRU106, i = | [−188 −107 109 199], [−186 −150 111 129], [−187 −106 110 200], [−185 −149 112 |
| {1, 2, 3, 4} | 130] |
| DRU242, i = | [−227 −170 −22 −11 64 140 208 223], [−230 −169 −97 −86 15 65 87 220] |
| {1, 2} | |

TABLE 27
Pilot indices (40 MHz) - Alternative 2 (Pilots are not at the edge of the bandwidth)

| | Single stream pilot indices for DRU transmission over 40 MHz, |
|---|---|
| DRU size | pilot tones starting from smallest i to larger i |
| DRU26, i = | [−188 64], [−53 181] [−184 68], [−49 185] [−171 81] [−186 66] [−51 183] [−182 70] |
| {1 . . . 18} | [−47 187] [−187 65] |
| | [−52 182] [−183 69] [−48 186] [−180 72] [−185 67] [−50 184] [−181 71][−46 188] |
| DRU52, i = | [−197 −161 118 181], [−193 −157 122 185] [−195 −159 120 183] [−191 −155 124 |
| {1, . . . , 8} | 187] [−196 −160 119 182] [−192 −156 123 186] [−194 −158 121 184] [−190 −154 |
| | 125 188] |
| DRU106, i = | [−188 −107 109 199], [−186 −150 111 129], [−187 −106 110 200], [−185 −149 112 |
| {1, 2, 3, 4} | 130] |
| DRU242, i = | [−227 −170 −22 −11 64 140 208 223], [−230 −169 −97 −86 15 65 87 220] |
| {1, 2} | |

Note that all DRUs lead to low PAPR results in the examples provided herein.

TABLE 1
PAPR results without single-stream pilots and with single stream pilots for 40 MHz DRU LTF (Alternative 1) based on the proposed methodology

| PAPR | | | | | | | | | | | | | | | | | | |
|---|---|---|---|---|---|---|---|---|---|---|---|---|---|---|---|---|---|---|
| [dB] | 1 | 2 | 3 | 4 | 5 | 6 | 7 | 8 | 9 | 10 | 11 | 12 | 13 | 14 | 15 | 16 | 17 | 18 |
| DRU26 | 3.01, | 2.96, | 3.01, | 2.96, | 3.01, | 3.01, | 2.96, | 3.01, | 2.96, | 3.01, | 2.96, | 3.01, | 2.96, | 3.01, | 3.01, | 2.96, | 3.01, | 2.96, |
| | 3.94 | 4.04 | 3.94 | 4.04 | 3.94 | 3.94 | 4.04 | 3.94 | 4.04 | 3.94 | 4.04 | 3.94 | 4.04 | 3.94 | 3.94 | 4.04 | 3.94 | 4.04 |

| | | | | | | | | |
|---|---|---|---|---|---|---|---|---|
| DRU52 | 3.01, 3.85 | 3.01, 3.85 | 3.01, 3.85 | 3.01, 3.85 | 3.01, 3.85 | 3.01, 3.85 | 3.01, 3.85 | 3.01, 3.85 |

| | | | | |
|---|---|---|---|---|
| DRU106 | 3.98, 4.69 | 3.94, 4.67 | 3.98, 4.69 | 3.94, 4.67 |

| | | |
|---|---|---|
| DRU242 | 5.1, 5.31 | 5.15, 5.31 |

TABLE 2
PAPR results without single-stream pilots and with single stream pilots for 40 MHz DRU LTF (Alternative 2) based on the proposed methodology

| PAPR | | | | | | | | | | | | | | | | | | |
|---|---|---|---|---|---|---|---|---|---|---|---|---|---|---|---|---|---|---|
| [dB] | 1 | 2 | 3 | 4 | 5 | 6 | 7 | 8 | 9 | 10 | 11 | 12 | 13 | 14 | 15 | 16 | 17 | 18 |
| DRU26 | 3.01, | 2.96, | 3.01, | 2.96, | 3.01, | 3.01, | 2.96, | 3.01, | 2.96, | 3.01, | 2.96, | 3.01, | 2.96, | 3.01, | 3.01, | 2.96, | 3.01, | 2.96, |
| | 3.94 | 4.22 | 3.94 | 4.22 | 3.94 | 3.94 | 4.22 | 3.94 | 4.22 | 3.94 | 4.22 | 3.94 | 4.22 | 3.94 | 3.94 | 4.22 | 3.94 | 4.22 |

| | | | | | | | | |
|---|---|---|---|---|---|---|---|---|
| DRU52 | 3.01, 4.08 | 3.01, 4.08 | 3.01, 4.08 | 3.01, 4.08 | 3.01, 4.08 | 3.01, 4.08 | 3.01, 4.08 | 3.01, 4.08 |

| | | | | |
|---|---|---|---|---|
| DRU106 | 3.98, 4.69 | 3.94, 4.67 | 3.98, 4.69 | 3.94, 4.67 |

| | | |
|---|---|---|
| DRU242 | 5.1, 5.31 | 5.15, 5.31 |

A MATLAB production of the examples provided herein is provided as follows:

clear all
close all
clc
tonesDRU26{1} = [−242:18:−26, 10:18:226];
tonesDRU26{2} = [−233:18:−17, 19:18:235];
tonesDRU26{3} = [−238:18:−22, 14:18:230];
tonesDRU26{4} = [−229:18:−13, 23:18:239];
tonesDRU26{5} = [−225:18:−9, 27:18:243];
tonesDRU26{6} = [−240:18:−24, 12:18:228];
tonesDRU26{7} = [−231:18:−15, 21:18:237];
tonesDRU26{8} = [−236:18:−20, 16:18:232];
tonesDRU26{9} = [−227:18:−11, 25:18:241];
tonesDRU26{10} = [−241:18:−25, 11:18:227];
tonesDRU26{11} = [−232:18:−16, 20:18:236];
tonesDRU26{12} = [−237:18:−21, 15:18:231];
tonesDRU26{13} = [−228:18:−12, 24:18:240];
tonesDRU26{14} = [−234:18:−18, 18:18:234];
tonesDRU26{15} = [−239:18:−23, 13:18:229];
tonesDRU26{16} = [−230:18:−14, 22:18:238];
tonesDRU26{17} = [−235:18:−19, 17:18:233];
tonesDRU26{18} = [−226:18:−10, 26:18:242];
% this skips dru26 5 and dru26 14
tonesDRU52{1} = [−242:9:−17, 10:9:235]; %norm([tonesDRU52{1}.‘-sort([tonesDRU26{1:2],‘ascend’).’])
tonesDRU52{2} = [−238:9:−13, 14:9:239]; %norm([tonesDRU52{2}.‘-sort([tonesDRU26{3:4}],‘ascend’).’])
tonesDRU52{3} = [−240:9:−15, 12:9:237]; %norm([tonesDRU52{3}.‘-sort([tonesDRU26{6:7}],‘ascend’).’])
tonesDRU52{4} = [−236:9:−11, 16:9:241]; %norm([tonesDRU52{4}.‘-sort([tonesDRU26{8:9}],‘ascend’).’])
tonesDRU52{5} = [−241:9:−16, 11:9:236]; %norm([tonesDRU52{5}.‘-sort([tonesDRU26{10:11}],‘ascend’).’])
tonesDRU52{6} = [−237:9:−12, 15:9:240]; %norm([tonesDRU52{6}.‘-sort([tonesDRU26{12:13}],‘ascend’).’])
tonesDRU52{7} = [−239:9:−14, 13:9:238]; %norm([tonesDRU52{7}.‘-sort([tonesDRU26{15:16}],‘ascend’).’])
tonesDRU52{8} = [−235:9:−10, 17:9:242]; %norm([tonesDRU52{8}.‘-sort([tonesDRU26{17:18}],‘ascend’).’])
% this skips dru26 5 and dru26 14
tonesDRU106{1} = sort([tonesDRU26{1:4}, −8 5],‘ascend’);
tonesDRU106{2} = sort([tonesDRU26{6:9}, −6 7],‘ascend’);
tonesDRU106{3} = sort([tonesDRU26{10:13}, −7 6],‘ascend’);
tonesDRU106{4} = sort([tonesDRU26{15:18}, −5 8],‘ascend’);
tonesDRU242{1} = sort([tonesDRU106{1:2}, tonesDRU26{5}, −244 −4 3 9],‘ascend’);
tonesDRU242{2} = sort([tonesDRU106{3:4}, tonesDRU26{14}, −243 −3 4 244],‘ascend’);
%Alternative 1
pilotsDRU26{1} = [−188 64]+0;
pilotsDRU26{2} = [−242 226]+9;
pilotsDRU26{3} = [−188 64]+4;
pilotsDRU26{4} = [−242 226]+13;
pilotsDRU26{5} = [−188 64]+17;
pilotsDRU26{6} = [−188 64]+2;
pilotsDRU26{7} = [−242 226]+11;
pilotsDRU26{8} = [−188 64]+6;
pilotsDRU26{9} = [−242 226]+15;
pilotsDRU26{10} = [−188 64]+1;
pilotsDRU26{11} = [−242 226]+10;
pilotsDRU26{12} = [−188 64]+5;
pilotsDRU26{13} = [−242 226]+14;
pilotsDRU26{14} = [−188 64]+8;
pilotsDRU26{15} = [−188 64]+3;
pilotsDRU26{16} = [−242 226]+12;
pilotsDRU26{17} = [−188 64]+7;
pilotsDRU26{18} = [−242 226]+16;
pilotsDRU52{1} = [−242 −161 82 118];
pilotsDRU52{2} = [−242 −161 82 118]+4;
pilotsDRU52{3} = [−242 −161 82 118]+2;
pilotsDRU52{4} = [−242 −161 82 118]+6;
pilotsDRU52{5} = [−242 −161 82 118]+1;
pilotsDRU52{6} = [−242 −161 82 118]+5;
pilotsDRU52{7} = [−242 −161 82 118]+3;
pilotsDRU52{8} = [−242 −161 82 118]+7;
pilotsDRU106{1} = [−188 −107 109 199];
pilotsDRU106{2} = [−188 −152 109 127]+2;
pilotsDRU106{3} = [−188 −107 109 199]+1;
pilotsDRU106{4} = [−188 −152 109 127]+3;
pilotsDRU242{1} = [−227 −170 −22 −11 64 140 208 223];
pilotsDRU242{2} = [−230 −169 −97 −86 15 65 87 220];
%alternative 2
pilotsDRU26{1} = [−188 64]+0;
pilotsDRU26{2} = [−62 172]+9;
pilotsDRU26{3} = [−188 64]+4;
pilotsDRU26{4} = [−62 172]+13;
pilotsDRU26{5} = [−188 64]+17;
pilotsDRU26{6} = [−188 64]+2;
pilotsDRU26{7} = [−62 172]+11;
pilotsDRU26{8} = [−188 64]+6;
pilotsDRU26{9} = [−62 172]+15;
pilotsDRU26{10} = [−188 64]+1;
pilotsDRU26{11} = [−62 172]+10;
pilotsDRU26{12} = [−188 64]+5;
pilotsDRU26{13} = [−62 172]+14;
pilotsDRU26{14} = [−188 64]+8;
pilotsDRU26{15} = [−188 64]+3;
pilotsDRU26{16} = [−62 172]+12;
pilotsDRU26{17} = [−188 64]+7;
pilotsDRU26{18} = [−62 172]+16;
pilotsDRU52{1} = [−197 −161 118 181];
pilotsDRU52{2} = [−197 −161 118 181]+4;
pilotsDRU52{3} = [−197 −161 118 181]+2;
pilotsDRU52{4} = [−197 −161 118 181]+6;
pilotsDRU52{5} = [−197 −161 118 181]+1;
pilotsDRU52{6} = [−197 −161 118 181]+5;
pilotsDRU52{7} = [−197 −161 118 181]+3;
pilotsDRU52{8} = [−197 −161 118 181]+7;
pilotsDRU106{1} = [−188 −107 109 199];
pilotsDRU106{2} = [−188 −152 109 127]+2;
pilotsDRU106{3} = [−188 −107 109 199]+1;
pilotsDRU106{4} = [−188 −152 109 127]+3;
pilotsDRU242{1} = [−227 −170 −22 −11 64 140 208 223];
pilotsDRU242{2} = [−230 −169 −97 −86 15 65 87 220];
pilotsDRU242{1} = [−227 −170 −22 −11 64 140 208 223];
pilotsDRU242{2} = [−230 −169 −97 −86 15 65 87 220];
Ga13 = [1 1 1 1i −1 1 1 −1i 1 −1 1 −1i 1i];
Gb13 = 1i*conj(fliplr([1 1i −1 −1 −1 1i −1 1 1 −1i −1 1 −1i]));
tones = [−244:244];
masterSequence = zeros(1,numel(tones));
masterSequence(tonesDRU26{1}+245) = [Ga13 Gb13];
masterSequence(tonesDRU26{2}+245) = [Ga13 −Gb13];
masterSequence(tonesDRU26{3}+245) = [Ga13 Gb13];
masterSequence(tonesDRU26{4}+245) = [−Ga13 Gb13];
%
masterSequence(tonesDRU26{5}+245) = [Ga13 Gb13];
%
masterSequence(tonesDRU26{6}+245) = [Ga13 Gb13];
masterSequence(tonesDRU26{7}+245) = [Ga13 −Gb13];
masterSequence(tonesDRU26{8}+245) = [−Ga13 −Gb13];
masterSequence(tonesDRU26{9}+245) = [Ga13 −Gb13];
masterSequence(tonesDRU26{10}+245) = [Ga13 Gb13];
masterSequence(tonesDRU26{11}+245) = [Ga13 −Gb13];
masterSequence(tonesDRU26{12}+245) = [Ga13 Gb13];
masterSequence(tonesDRU26{13}+245) = [−Ga13 Gb13];
%
masterSequence(tonesDRU26{14}+245) = [Ga13 Gb13];
%
masterSequence(tonesDRU26{15}+245) = −[Ga13 Gb13];
masterSequence(tonesDRU26{16}+245) = −[Ga13 −Gb13];
masterSequence(tonesDRU26{17}+245) = −[−Ga13 −Gb13];
masterSequence(tonesDRU26{18}+245) = −[Ga13 −Gb13];
masterSequence([−8:−5,5:8]+245) = [−1i −1i −1i 1i 1i 1i 1i −1i];
masterSequence([−244 −243 −4 −3 3 4 9 244]+245) = [−1 −1i 1i 1 1i 1i 1i 1i];

In another example, a UHR DRU-LFT design may use QPSK in an 80 MHz distribution bandwidth. Consider a DRU tone allocation given in Table 30 below.

TABLE 30
An example of a DRU table for a nested tone allocation (80 MHz)

| 52-tone | DRU1 | DRU2 | DRU3 | DRU4 |
|---|---|---|---|---|
| DRU | [−483:36:−51, | [−475:36:−43, | [−479:36:−47, 21:36:453], | [−471:36:−39, 29:36:461], |
| i = 1:16 | 17:36:449], [−467:36:−35, | 25:36:457], [−459:36:−27, | [−463:36:−31, 37:36:469] | [−455:36:−23, 45:36:477] |
| | 33:36:465] | 41:36:473] | | |
| | DRU5 | DRU6 | DRU7 | DRU8 |
| | [−477:36:−45, | [−469:36:−37, | [−481:36:−49, 19:36:451], | [−473:36:−41, 27:36:459], |
| | 23:36:455], [−461:36:−29, | 31:36:463], [−453:36:−21, | [−465:36:−33, 35:36:467] | [−457:36:−25, 43:36:475] |
| | 39:36:471] | 47:36:479] | | |
| | DRU9 | DRU10 | DRU11 | DRU12 |
| | [−482:36:−50, | [−474:36:−42, | [−478:36:−46, 22:36:454], | [−470:36:−38, 30:36:462], |
| | 18:36:450], [−466:36:−34, | 26:36:458], [−458:36:−26, | [−462:36:−30, 38:36:470] | [−454:36:−22, 46:36:478] |
| | 34:36:466] | 42:36:474] | | |
| | DRU13 | DRU14 | DRU15 | DRU16 |
| | [−476:36:−44, | [−468:36:−36, | [−480:36:−48, 20:36:452], | [−472:36:−40, 28:36:460], |
| | 24:36:456], [−460:36:−28, | 32:36:464], [−452:36:−20, | [−464:36:−32, 36:36:468] | [−456:36:−24, 44:36:476] |
| | 40:36:472] | 48:36:480] | | |
| 106- | DRU1 | DRU2 | DRU3 | DRU4 |
| tone | 52-tone [DRU1~2], | 52-tone [DRU3~4], | 52-tone [DRU5~6], | 52-tone [DRU7~8], |
| DRU | [−495, 485] | [−491, 489] | [−489, 491] | [−493, 487] |
| i = 1:8 | DRU5 | DRU6 | DRU7 | DRU8 |
| | 52-tone [DRU9~10], | 52-tone [DRU11~12], | 52-tone [DRU13~14], | 52-tone [DRU15~16], |
| | [−494, 486] | [−490, 490] | [−488, 492] | [−492, 488] |

| | | |
|---|---|---|
| 242- | DRU1 | DRU2 |
| tone | [−499:4:−19, 17:4:497] | [−497:4:−17, 19:4:499] |
| DRU | DRU3 | DRU4 |
| i = 1:4 | [−498:4:−18, 18:4:498] | [−496:4:−16, 20:4:500] |
| 484- | DRU1 | DRU2 |
| tone | [−499:2:−17, 17:2:499] | [−498:2:−16, 18:2:500] |
| DRU | | |
| i = 1:2 | | |

Table 31 shows the nested tone allocation.

TABLE 31
Nested tone allocation based on Table 30 and the provided notation

| 1^{st} level DRUs | 2nd level DRUs | 3rd level DRUs | 4th level DRUs | 5th level DRUs |
|---|---|---|---|---|
| (R₁ = 26, U₁ = 36) | (R₂ = 52, U₂ = 16) | (R₃ = 106, U₃ = 8) | (R₄ = 242, U₅ = 4) | (R₅ = 484, U₅ = 2) |
| ${T}_{1}^{( 1 )} = [ - 483 : 36 : - 51 , 17 : 36 : 449 ]$ | ${T}_{1}^{( 2 )} = {T}_{1}^{( 1 )} ⋃ {T}_{2}^{( 1 )}$ | ${T}_{1}^{( 3 )} = {T}_{1}^{( 2 )} ⋃ {T}_{2}^{( 2 )} ⋃ {E}_{1}^{( 3 )}$ | ${T}_{1}^{( 4 )} = {T}_{1}^{( 3 )} ⋃ {T}_{2}^{( 3 )} ⋃ {T}_{5}^{( 1 )} ⋃ {E}_{1}^{( 4 )}$ | ${T}_{1}^{( 5 )} = {T}_{1}^{( 4 )} ⋃ {T}_{2}^{( 4 )}$ |
| ${T}_{2}^{( 1 )} = [ - 467 : 36 : - 35 , 33 : 36 : 465 ]$ | | ${E}_{1}^{( 3 )} = \{ - 495 , 485 \}$ | ${E}_{1}^{( 4 )} = \{ - 499 - 487 \; 493 \; 497 \}$ | |
| ${T}_{3}^{( 1 )} = [ - 475 : 36 : - 43 , 25 : 36 : 457 ]$ | ${T}_{2}^{( 2 )} = {T}_{2}^{( 1 )} ⋃ {T}_{4}^{( 1 )}$ | | | |
| ${T}_{4}^{( 1 )} = [ - 459 : 36 : - 27 , 41 : 36 : 473 ]$ | | | | |
| ${T}_{5}^{( 1 )} = [ - 451 : 36 : - 19 \; 49 : 36 : 481 ]$ | | | | |
| ${T}_{6}^{( 1 )} = [ - 479 : 36 : - 47 , 21 : 36 : 453 ]$ | ${T}_{3}^{( 2 )} = {T}_{6}^{( 1 )} ⋃ {T}_{7}^{( 1 )}$ | ${T}_{2}^{( 3 )} = {T}_{3}^{( 2 )} ⋃ {T}_{4}^{( 2 )} ⋃ {E}_{2}^{( 3 )}$ | | |
| ${T}_{7}^{( 1 )} = [ - 463 : 36 : - 31 , 37 : 36 : 469 ]$ | | ${E}_{2}^{( 3 )} = \{ - 491 , 489 \}$ | | |
| ${T}_{8}^{( 1 )} = [ - 471 : 36 : - 39 , 29 : 36 : 461 ]$ | ${T}_{4}^{( 2 )} = {T}_{8}^{( 1 )} ⋃ {T}_{9}^{( 1 )}$ | | | |
| ${T}_{9}^{( 1 )} = [ - 455 : 36 : - 23 , 45 : 36 : 477 ]$ | | | | |
| ${T}_{10}^{( 1 )} = [ - 477 : 36 : - 45 , 23 : 36 : 455 ]$ | ${T}_{5}^{( 2 )} = {T}_{10}^{( 1 )} ⋃ {T}_{11}^{( 1 )}$ | ${T}_{3}^{( 3 )} = {T}_{5}^{( 2 )} ⋃ {T}_{6}^{( 2 )} ⋃ {E}_{3}^{( 3 )}$ | ${T}_{2}^{( 4 )} = {T}_{3}^{( 3 )} ⋃ {T}_{4}^{( 3 )} ⋃ {T}_{14}^{( 1 )} ⋃ {E}_{2}^{( 4 )}$ | |
| ${T}_{11}^{( 1 )} = [ - 461 : 36 : - 29 , 39 : 36 : 471 ]$ | | ${E}_{3}^{( 2 )} = \{ - 489 , 491 \}$ | ${E}_{2}^{( 4 )} = \{ - 497 - 485 \; 495 \; 499 \}$ | |
| ${T}_{12}^{( 1 )} = [ - 469 : 36 : - 37 , 31 : 36 : 463 ]$ | ${T}_{6}^{( 2 )} = {T}_{12}^{( 1 )} ⋃ {T}_{13}^{( 1 )}$ | | | |
| ${T}_{13}^{( 1 )} = [ - 453 : 36 : - 21 , 47 : 36 : 479 ]$ | | | | |
| ${T}_{14}^{( 1 )} = [ - 449 : 36 : - 17 \; 51 : 36 : 483 ]$ | | | | |
| ${T}_{15}^{( 1 )} = [ - 481 : 36 : - 49 , 19 : 36 : 451 ]$ | ${T}_{7}^{( 2 )} = {T}_{15}^{( 1 )} ⋃ {T}_{16}^{( 1 )}$ | ${T}_{4}^{( 3 )} = {T}_{7}^{( 2 )} ⋃ {T}_{8}^{( 2 )} ⋃ {E}_{4}^{( 3 )}$ | | |
| ${T}_{16}^{( 1 )} = [ - 465 : 36 : - 33 , 35 : 36 : 467 ]$ | | ${E}_{4}^{( 2 )} = \{ - 493 , 487 \}$ | | |
| ${T}_{17}^{( 1 )} = [ - 473 : 36 : - 41 , 27 : 36 : 459 ]$ | ${T}_{8}^{( 2 )} = {T}_{17}^{( 1 )} ⋃ {T}_{18}^{( 1 )}$ | | | |
| ${T}_{18}^{( 1 )} = [ - 457 : 36 : - 25 , 43 : 36 : 475 ]$ | | | | |
| ${T}_{19}^{( 1 )} = [ - 482 : 36 : - 50 , 18 : 36 : 450 ]$ | ${T}_{9}^{( 2 )} = {T}_{19}^{( 1 )} ⋃ {T}_{20}^{( 1 )}$ | ${T}_{5}^{( 3 )} = {T}_{9}^{( 2 )} ⋃ {T}_{10}^{( 2 )} ⋃ {E}_{5}^{( 3 )}$ | ${T}_{3}^{( 4 )} = {T}_{5}^{( 3 )} ⋃ {T}_{6}^{( 3 )} ⋃ {T}_{23}^{( 1 )} ⋃ {E}_{3}^{( 4 )}$ | ${T}_{2}^{( 5 )} = {T}_{3}^{( 4 )} ⋃ {T}_{4}^{( 4 )}$ |
| ${T}_{20}^{( 1 )} = [ - 466 : 36 : - 34 , 34 : 36 : 466 ]$ | | ${E}_{5}^{( 2 )} = \{ - 494 , 486 \}$ | ${E}_{3}^{( 4 )} = \{ - 498 - 486 \; 494 \; 498 \}$ | |
| ${T}_{21}^{( 1 )} = [ - 474 : 36 : - 42 , 26 : 36 : 458 ]$ | ${T}_{10}^{( 2 )} = {T}_{21}^{( 1 )} ⋃ {T}_{22}^{( 1 )}$ | | | |
| ${T}_{22}^{( 1 )} = [ - 458 : 36 : - 26 , 42 : 36 : 474 ]$ | | | | |
| ${T}_{23}^{( 1 )} = [ - 450 : 36 : - 18 \; 50 : 36 : 482 ]$ | | | | |
| ${T}_{24}^{( 1 )} = [ - 478 : 36 : - 46 , 22 : 36 : 454 ]$ | ${T}_{11}^{( 2 )} = {T}_{24}^{( 1 )} ⋃ {T}_{25}^{( 1 )}$ | ${T}_{6}^{( 3 )} = {T}_{11}^{( 2 )} ⋃ {T}_{12}^{( 2 )} ⋃ {E}_{6}^{( 3 )}$ | | |
| ${T}_{25}^{( 1 )} = [ - 462 : 36 : - 30 , 38 : 36 : 470 ]$ | | ${E}_{6}^{( 3 )} = \{ - 490 , 490 \}$ | | |
| ${T}_{26}^{( 1 )} = [ - 470 : 36 : - 38 , 30 : 36 : 462 ]$ | ${T}_{12}^{( 2 )} = {T}_{26}^{( 1 )} ⋃ {T}_{27}^{( 1 )}$ | | | |
| ${T}_{27}^{( 1 )} = [ - 454 : 36 : - 22 , 46 : 36 : 478 ]$ | | | | |
| ${T}_{28}^{( 1 )} = [ - 476 : 36 : - 44 , 24 : 36 : 456 ]$ | ${T}_{13}^{( 2 )} = {T}_{28}^{( 1 )} ⋃ {T}_{29}^{( 1 )}$ | ${T}_{7}^{( 3 )} = {T}_{13}^{( 2 )} ⋃ {T}_{14}^{( 2 )} ⋃ {E}_{7}^{( 3 )}$ | ${T}_{4}^{( 4 )} = {T}_{7}^{( 3 )} ⋃ {T}_{8}^{( 3 )} ⋃ {T}_{32}^{( 1 )} ⋃ {E}_{4}^{( 4 )}$ | |
| ${T}_{29}^{( 1 )} = [ - 460 : 36 : - 28 , 40 : 36 : 472 ]$ | | ${E}_{7}^{( 3 )} = \{ - 488 , 492 \}$ | ${E}_{4}^{( 3 )} = \{ 496 - 484 \; 496 \; 500 \}$ | |
| ${T}_{30}^{( 1 )} = [ - 468 : 36 : - 36 , 32 : 36 : 464 ]$ | ${T}_{14}^{( 2 )} = {T}_{30}^{( 1 )} ⋃ {T}_{31}^{( 1 )}$ | | | |
| ${T}_{31}^{( 1 )} = [ - 452 : 36 : - 20 , 48 : 36 : 480 ]$ | | | | |
| ${T}_{32}^{( 1 )} = [ - 448 : 36 : - 16 \; 52 : 36 : 484 ]$ | | | | |
| ${T}_{33}^{( 1 )} = [ - 480 : 36 : - 48 , 20 : 36 : 452 ]$ | ${T}_{15}^{( 2 )} = {T}_{33}^{( 1 )} ⋃ {T}_{34}^{( 1 )}$ | ${T}_{8}^{( 3 )} = {T}_{15}^{( 2 )} ⋃ {T}_{16}^{( 2 )} ⋃ {E}_{8}^{( 3 )}$ | | |
| ${T}_{34}^{( 1 )} = [ - 464 : 36 : - 32 , 36 : 36 : 468 ]$ | | ${E}_{8}^{( 3 )} = \{ - 492 , 488 \}$ | | |
| ${T}_{35}^{( 1 )} = [ - 472 : 36 : - 40 , 28 : 36 : 460 ]$ | ${T}_{16}^{( 2 )} = {T}_{35}^{( 1 )} ⋃ {T}_{36}^{( 1 )}$ | | | |
| ${T}_{36}^{( 1 )} = [ - 456 : 36 : - 24 , 44 : 36 : 476 ]$ | | | | |

As can be seen in Table 31, a higher-level DRU may consist of several lower-level DRUs. Also, DRUs may include some extra tones

$$( i . e . , the ones {E}_{1 - 8}^{( 3 )} and {E}_{1 - 4}^{( 4 )} ) .$$

Similar to the previous cases, we are looking for a master sequence that leads to a low PAPR value for xₛ_{_{l,i}}(t), for all possible l and i, without any exhaustive search for the nested tone allocation in Table 30. Note that the first-level DRUs are not used in the transmission for this example. Hence, our main interest is the cases with l>1.

Consider the following seed GCP: sₐ=(1, 1, 1, 1i, 1, 1, 1, 1i, 1, −1, 1, −1i, 1i), s_{b}=(1 1i−1−1−11−1, 1, 1−1i−11−1i).

Based on the proposed method, w_{a,i} and w_{b,i} for i=1, . . . ,36, at the first level may be chosen as in Table 32 such that they form a CS obeying (1) and (2) when the corresponding sequences are combined at a higher-level DRU.

TABLE 32
An example of choices of w_{a, i} and
w_{b, i} based on proposed solution (80 MHz)

| i | w_{a, i} | w_{b, i} |
|---|---|---|
| 1 | 1 | 1 |
| 2 | 1 | −1 |
| 3 | 1 | 1 |
| 4 | −1 | 1 |
| 5 | 1i | 1 |
| 6 | 1 | 1 |
| 7 | 1 | −1 |
| 8 | −1 | −1 |
| 9 | 1 | −1 |
| 10 | −1 | −1 |
| 11 | −1 | 1 |
| 12 | 1 | 1 |
| 13 | −1 | 1 |
| 14 | 1i | −1 |
| 15 | 1 | 1 |
| 16 | 1 | −1 |
| 17 | 1 | 1 |
| 18 | −1 | 1 |
| 19 | 1 | 1 |
| 20 | 1 | −1 |
| 21 | 1 | 1 |
| 22 | −1 | 1 |
| 23 | 1i | 1 |
| 24 | 1 | 1 |
| 25 | 1 | −1 |
| 26 | −1 | −1 |
| 27 | 1 | −1 |
| 28 | 1 | 1 |
| 29 | 1 | −1 |
| 30 | −1 | −1 |
| 31 | 1 | −1 |
| 32 | −1i | 1 |
| 33 | −1 | −1 |
| 34 | −1 | 1 |
| 35 | −1 | −1 |
| 36 | 1 | −1 |

Table 33 shows the seed GCP, along with the choices of w_{a,i} and w_{b,i}, leads to the CSs (based on (1) and (2)) via: pₛ_{_{1,i}}(z)=p_{w}_{_{a,i}}ₛ_{ₐ}(z³⁶)+p_{w}_{_{b,i}}ₛ_{_{b}}(z³⁶)z⁴⁸³ for the first-level DRUs while preparing GCPs for the second-level.

TABLE 33
The CSs at the
first-level DRUs form GCP for the second-level DRUs (80 MHz)

| | | | Does a GCP |
|---|---|---|---|
| | | | exist for the |
| | | | next level |
| | | | based on the |
| 1^{st}-level DRU tone indices | | Is s_{1,i} | formulas in |
| (26 tones) | m_{1,i} | is CS? | (1) or (2)? |
| ${T}_{1}^{( 1 )} = [ - 483 : 36 : - 51 , 17 : 36 : 449 ]$ | −483 | Yes | Yes |
| ${T}_{2}^{( 1 )} = [ - 467 : 36 : - 35 , 33 : 36 : 465 ]$ | −467 | Yes | |
| ${T}_{3}^{( 1 )} = [ - 475 : 36 : - 43 , 25 : 36 : 457 ]$ | −475 | Yes | Yes |
| ${T}_{4}^{( 1 )} = [ - 459 : 36 : - 27 , 41 : 36 : 473 ]$ | −459 | Yes | |
| ${T}_{5}^{( 1 )} = [ - 451 : 36 : - 19 \; 49 : 36 : 481 ]$ | −451 | Yes | |
| ${T}_{6}^{( 1 )} = [ - 479 : 36 : - 47 , 21 : 36 : 453 ]$ | −479 | Yes | Yes |
| ${T}_{7}^{( 1 )} = [ - 463 : 36 : - 31 , 37 : 36 : 469 ]$ | −463 | Yes | |
| ${T}_{8}^{( 1 )} = [ - 471 : 36 : - 39 , 29 : 36 : 461 ]$ | −471 | Yes | Yes |
| ${T}_{9}^{( 1 )} = [ - 455 : 36 : - 23 , 45 : 36 : 477 ]$ | −455 | Yes | |
| ${T}_{10}^{( 1 )} = [ - 477 : 36 : - 45 , 23 : 36 : 455 ]$ | −477 | Yes | Yes |
| ${T}_{11}^{( 1 )} = [ - 461 : 36 : - 29 , 39 : 36 : 471 ]$ | −461 | Yes | |
| ${T}_{12}^{( 1 )} = [ - 469 : 36 : - 37 , 31 : 36 : 463 ]$ | −469 | Yes | Yes |
| ${T}_{13}^{( 1 )} = [ - 453 : 36 : - 21 , 47 : 36 : 479 ]$ | −453 | Yes | |
| ${T}_{14}^{( 1 )} = [ - 449 : 36 : - 17 \; 51 : 36 : 483 ]$ | −449 | Yes | |
| ${T}_{15}^{( 1 )} = [ - 481 : 36 : - 49 , 19 : 36 : 451 ]$ | −481 | Yes | Yes |
| ${T}_{16}^{( 1 )} = [ - 465 : 36 : - 33 , 35 : 36 : 467 ]$ | −465 | Yes | |
| ${T}_{17}^{( 1 )} = [ - 473 : 36 : - 41 , 27 : 36 : 459 ]$ | −473 | Yes | Yes |
| ${T}_{18}^{( 1 )} = [ - 457 : 36 : - 25 , 43 : 36 : 475 ]$ | −457 | Ye | |
| ${T}_{19}^{( 1 )} = [ - 482 : 36 : - 50 , 18 : 36 : 450 ]$ | −482 | Yes | Yes |
| ${T}_{20}^{( 1 )} = [ - 466 : 36 : - 34 , 34 : 36 : 466 ]$ | −466 | Yes | |
| ${T}_{21}^{( 1 )} = [ - 474 : 36 : - 42 , 26 : 36 : 458 ]$ | −474 | Yes | Yes |
| ${T}_{22}^{( 1 )} = [ - 458 : 36 : - 26 , 42 : 36 : 474 ]$ | −458 | Yes | |
| ${T}_{23}^{( 1 )} = [ - 450 : 36 : - 18 \; 50 : 36 : 482 ]$ | −450 | Yes | |
| ${T}_{24}^{( 1 )} = [ - 478 : 36 : - 46 , 22 : 36 : 454 ]$ | −478 | Yes | Yes |
| ${T}_{25}^{( 1 )} = [ - 462 : 36 : - 30 , 38 : 36 : 470 ]$ | −462 | Yes | |
| ${T}_{26}^{( 1 )} = [ - 470 : 36 : - 38 , 30 : 36 : 462 ]$ | −470 | Yes | Yes |
| ${T}_{27}^{( 1 )} = [ - 454 : 36 : - 22 , 46 : 36 : 478 ]$ | −454 | Yes | |
| ${T}_{28}^{( 1 )} = [ - 476 : 36 : - 44 , 24 : 36 : 456 ]$ | −476 | Yes | Yes |
| ${T}_{29}^{( 1 )} = [ - 460 : 36 : - 28 , 40 : 36 : 472 ]$ | −460 | Yes | |
| ${T}_{30}^{( 1 )} = [ - 468 : 36 : - 36 , 32 : 36 : 464 ]$ | −468 | Yes | Yes |
| ${T}_{31}^{( 1 )} = [ - 452 : 36 : - 20 , 48 : 36 : 480 ]$ | −452 | Yes | |
| ${T}_{32}^{( 1 )} = [ - 448 : 36 : - 16 \; 52 : 36 : 484 ]$ | −448 | Yes | |
| ${T}_{33}^{( 1 )} = [ - 480 : 36 : - 48 , 20 : 36 : 452 ]$ | −480 | Yes | Yes |
| ${T}_{34}^{( 1 )} = [ - 464 : 36 : - 32 , 36 : 36 : 468 ]$ | −464 | Yes | |
| ${T}_{35}^{( 1 )} = [ - 472 : 36 : - 40 , 28 : 36 : 460 ]$ | −472 | Yes | Yes |
| ${T}_{36}^{( 1 )} = [ - 456 : 36 : - 24 , 44 : 36 : 476 ]$ | −456 | Yes | |

Table 34 shows the sequences at the first-level DRUs form CSs (based on (1) and (2)) in the form of pₛ_{_{2,i}}(z)=pₐ(z)+p_{b}(z)z¹⁸ for the second-level DRUs while preparing GCPs for the third level.

TABLE 34
The CSs at the first-level DRUs lead to the CSs for the
second-level DRUs while preparing GCP for the third level (80 MHz)

| | | | Does a GCP exist for the |
|---|---|---|---|
| 2^{nd}-level DRU tone | | Is s_{2,i} | next level based on the |
| indices (52 tones) | m_{2,i} | a CS? | formulas in (1) or (2)? |
| ${T}_{1}^{( 2 )} = {T}_{1}^{( 1 )} ⋃ {T}_{2}^{( 1 )}$ | −483 | Yes | Yes |
| ${T}_{2}^{( 2 )} = {T}_{3}^{( 1 )} ⋃ {T}_{4}^{( 1 )}$ | −475 | Yes | |
| ${T}_{3}^{( 2 )} = {T}_{6}^{( 1 )} ⋃ {T}_{7}^{( 1 )}$ | −479 | Yes | Yes |
| ${T}_{4}^{( 2 )} = {T}_{8}^{( 1 )} ⋃ {T}_{9}^{( 1 )}$ | −471 | Yes | |
| ${T}_{5}^{( 2 )} = {T}_{10}^{( 1 )} ⋃ {T}_{11}^{( 1 )}$ | −477 | Yes | Yes |
| ${T}_{6}^{( 2 )} = {T}_{12}^{( 1 )} ⋃ {T}_{13}^{( 1 )}$ | −469 | Yes | |
| ${T}_{7}^{( 2 )} = {T}_{15}^{( 1 )} ⋃ {T}_{16}^{( 1 )}$ | −481 | Yes | Yes |
| ${T}_{8}^{( 2 )} = {T}_{17}^{( 1 )} ⋃ {T}_{18}^{( 1 )}$ | −473 | Yes | |
| ${T}_{9}^{( 2 )} = {T}_{19}^{( 1 )} ⋃ {T}_{20}^{( 1 )}$ | −482 | Yes | Yes |
| ${T}_{10}^{( 2 )} = {T}_{21}^{( 1 )} ⋃ {T}_{22}^{( 1 )}$ | −474 | Yes | |
| ${T}_{11}^{( 2 )} = {T}_{24}^{( 1 )} ⋃ {T}_{25}^{( 1 )}$ | −478 | Yes | Yes |
| ${T}_{12}^{( 2 )} = {T}_{26}^{( 1 )} ⋃ {T}_{27}^{( 1 )}$ | −470 | Yes | |
| ${T}_{13}^{( 2 )} = {T}_{28}^{( 1 )} ⋃ {T}_{29}^{( 1 )}$ | −476 | Yes | Yes |
| ${T}_{14}^{( 2 )} = {T}_{30}^{( 1 )} ⋃ {T}_{31}^{( 1 )}$ | −468 | Yes | |
| ${T}_{15}^{( 2 )} = {T}_{33}^{( 1 )} ⋃ {T}_{34}^{( 1 )}$ | −480 | Yes | Yes |
| ${T}_{16}^{( 2 )} = {T}_{35}^{( 1 )} ⋃ {T}_{36}^{( 1 )}$ | −472 | Yes | |

Table 35 shows the sequences at the second-level DRUs form CSs (based on (1) and (2)) in the form of pₛ_{_{3,i}}(z)=pₐ(z)+p_{b}(z)z⁸ for the third-level DRUs while preparing GCPs for the fourth level.

TABLE 35
The CSs at the second-level DRUs lead to the CSs for the
third-level DRUs while preparing GCP for the fourth level (80 MHz)

| | | | Does a GCP exist for the |
|---|---|---|---|
| 3rd-level DRU tone indices | | Is s_{3,i} | next level based on the |
| (104 tones out of 106 tones) | m_{3,i} | a CS? | formulas in (1) or (2)? |
| ${T}_{1}^{( 2 )} ⋃ {T}_{2}^{( 2 )}$ | −483 | Yes | Yes |
| ${T}_{3}^{( 2 )} ⋃ {T}_{4}^{( 2 )}$ | −479 | Yes | |
| ${T}_{5}^{( 2 )} ⋃ {T}_{6}^{( 2 )}$ | −477 | Yes | Yes |
| ${T}_{7}^{( 2 )} ⋃ {T}_{8}^{( 2 )}$ | −481 | Yes | |
| ${T}_{9}^{( 2 )} ⋃ {T}_{10}^{( 2 )}$ | −482 | Yes | Yes |
| ${T}_{11}^{( 2 )} ⋃ {T}_{12}^{( 2 )}$ | −478 | Yes | |
| ${T}_{13}^{( 2 )} ⋃ {T}_{14}^{( 2 )}$ | −476 | Yes | Yes |
| ${T}_{15}^{( 2 )} ⋃ {T}_{16}^{( 2 )}$ | −480 | Yes | |

Table 36 shows the sequences at the third-level DRUs form CSs (based on (1) and (2)) in the form of pₛ_{_{3,i}}(z)=pₐ(z)+ρ_{b}(z)z⁴ for the fourth-level DRUs while preparing GCPs for the fifth level.

TABLE 36
The CSs at the third-level DRUs lead to the CSs for the
fourth-level DRUs while preparing GCP for the fifth level (80 MHz)

| 4th-level DRU | | | Does a GCP exist for the |
|---|---|---|---|
| tone indices (208 tones | | Is s_{4,i} | next level based on the |
| out of 242 tones) | m_{4,i} | a CS? | formulas in (1) or (2)? |
| ${T}_{1}^{( 3 )} ⋃ {T}_{2}^{( 2 )} ⋃ {T}_{3}^{( 2 )} ⋃ {T}_{4}^{( 2 )}$ | −483 | Yes | Yes |
| ${T}_{3}^{( 2 )} ⋃ {T}_{4}^{( 2 )} ⋃ {T}_{3}^{( 2 )} ⋃ {T}_{4}^{( 2 )}$ | −481 | Yes | |
| ${T}_{9}^{( 2 )} ⋃ {T}_{10}^{( 2 )} ⋃ {T}_{11}^{( 2 )} ⋃ {T}_{12}^{( 2 )}$ | −482 | Yes | Yes |
| ${T}_{13}^{( 2 )} ⋃ {T}_{14}^{( 2 )} ⋃ {T}_{15}^{( 2 )} ⋃ {T}_{16}^{( 2 )}$ | −480 | Yes | |

Table 37 shows the sequences at the fourth-level DRUs form CSs (based on (1) and (2)) for the fifth-level DRUs in the form of pₛ_{₄ᵢ}(z)=pₐ(z)+p_{b}(z)z². The fifth level is the final level in this example.

TABLE 37
CSs at the
fourth-level DRUs lead to CSs for the fifth-level DRUs (80 MHz)

| 5th-level DRU tone indices | | Is s_{5,i} |
|---|---|---|
| (416 tones out of 484 tones) | m_{5,i} | a CS? |
| ${T}_{1}^{( 3 )} ⋃ {T}_{2}^{( 2 )} ⋃ {T}_{3}^{( 2 )} ⋃ {T}_{4}^{( 2 )} ⋃ {T}_{3}^{( 2 )} ⋃ {T}_{4}^{( 2 )} ⋃ {T}_{3}^{( 2 )} ⋃ {T}_{4}^{( 2 )}$ | −483 | Yes |
| ${T}_{9}^{( 2 )} ⋃ {T}_{10}^{( 2 )} ⋃ {T}_{11}^{( 2 )} ⋃ {T}_{12}^{( 2 )} ⋃ {T}_{13}^{( 2 )} ⋃ {T}_{14}^{( 2 )} ⋃ {T}_{15}^{( 2 )} ⋃ {T}_{16}^{( 2 )}$ | −482 | Yes |

In summary, the master sequence for 40 MHz DRU LTF may be tabulated as follows:

TABLE 38
The values of the master sequence at the specific tones (80 MHz)

| | | | | The values at the tone indices |
|---|---|---|---|---|
| | | | | (the sequence elements are mapped starting |
| i | Tone indices | w_{a,i} | w_{b,i} | from the smallest index to highest tone index) |
| 1 | ${T}_{1}^{( 1 )} = [ - 483 : 36 : - 51 , 17 : 36 : 449 ]$ | 1 | 1 | (w_{a,i} × sₐ, w_{b,i} × s_{b}) |
| 2 | ${T}_{2}^{( 1 )} = [ - 467 : 36 : - 35 , 33 : 36 : 465 ]$ | 1 | −1 | (w_{a,i} × sₐ, w_{b,i} × s_{b}) |
| 3 | ${T}_{3}^{( 1 )} = [ - 475 : 36 : - 43 , 25 : 36 : 457 ]$ | 1 | 1 | (w_{a,i} × sₐ, w_{b,i} × s_{b}) |
| 4 | ${T}_{4}^{( 1 )} = [ - 459 : 36 : - 27 , 41 : 36 : 473 ]$ | −1 | 1 | (w_{a,i} × sₐ, w_{b,i} × s_{b}) |
| 5 | ${T}_{5}^{( 1 )} = [ - 451 : 36 : - 19 \; 49 : 36 : 481 ]$ | 1i | 1 | (w_{a,i} × sₐ, w_{b,i} × s_{b}) |
| 6 | ${T}_{6}^{( 1 )} = [ - 479 : 36 : - 47 , 21 : 36 : 453 ]$ | 1 | 1 | (w_{a,i} × sₐ, w_{b,i} × s_{b}) |
| 7 | ${T}_{7}^{( 1 )} = [ - 463 : 36 : - 31 , 37 : 36 : 469 ]$ | 1 | −1 | (w_{a,i} × sₐ, w_{b,i} × s_{b}) |
| 8 | ${T}_{8}^{( 1 )} = [ - 471 : 36 : - 39 , 29 : 36 : 461 ]$ | −1 | −1 | (w_{a,i} × sₐ, w_{b,i} × s_{b}) |
| 9 | ${T}_{9}^{( 1 )} = [ - 455 : 36 : - 23 , 45 : 36 : 477 ]$ | 1 | −1 | (w_{a,i} × sₐ, w_{b,i} × s_{b}) |
| 10 | ${T}_{10}^{( 1 )} = [ - 477 : 36 : - 45 , 23 : 36 : 455 ]$ | −1 | −1 | (w_{a,i} × sₐ, w_{b,i} × s_{b}) |
| 11 | ${T}_{11}^{( 1 )} = [ - 461 : 36 : - 29 , 39 : 36 : 471 ]$ | −1 | 1 | (w_{a,i} × sₐ, w_{b,i} × s_{b}) |
| 12 | ${T}_{12}^{( 1 )} = [ - 469 : 36 : - 37 , 31 : 36 : 463 ]$ | 1 | 1 | (w_{a,i} × sₐ, w_{b,i} × s_{b}) |
| 13 | ${T}_{13}^{( 1 )} = [ - 453 : 36 : - 21 , 47 : 36 : 479 ]$ | −1 | 1 | (w_{a,i} × sₐ, w_{b,i} × s_{b}) |
| 14 | ${T}_{14}^{( 1 )} = [ - 449 : 36 : - 17 \; 51 : 36 : 483 ]$ | 1i | −1 | (w_{a,i} × sₐ, w_{b,i} × s_{b}) |
| 15 | ${T}_{15}^{( 1 )} = [ - 481 : 36 : - 49 , 19 : 36 : 451 ]$ | 1 | 1 | (w_{a,i} × sₐ, w_{b,i} × s_{b}) |
| 16 | ${T}_{16}^{( 1 )} = [ - 465 : 36 : - 33 , 35 : 36 : 467 ]$ | 1 | −1 | (w_{a,i} × sₐ, w_{b,i} × s_{b}) |
| 17 | ${T}_{17}^{( 1 )} = [ - 473 : 36 : - 41 , 27 : 36 : 459 ]$ | 1 | 1 | (w_{a,i} × sₐ, w_{b,i} × s_{b}) |
| 18 | ${T}_{18}^{( 1 )} = [ - 457 : 36 : - 25 , 43 : 36 : 475 ]$ | −1 | 1 | (w_{a,i} × sₐ, w_{b,i} × s_{b}) |
| 19 | ${T}_{19}^{( 1 )} = [ - 482 : 36 : - 50 , 18 : 36 : 450 ]$ | 1 | 1 | (w_{a,i} × sₐ, w_{b,i} × s_{b}) |
| 20 | ${T}_{20}^{( 1 )} = [ - 466 : 36 : - 34 , 34 : 36 : 466 ]$ | 1 | −1 | (w_{a,i} × sₐ, w_{b,i} × s_{b}) |
| 21 | ${T}_{21}^{( 1 )} = [ - 474 : 36 : - 42 , 26 : 36 : 458 ]$ | 1 | 1 | (w_{a,i} × sₐ, w_{b,i} × s_{b}) |
| 22 | ${T}_{22}^{( 1 )} = [ - 458 : 36 : - 26 , 42 : 36 : 474 ]$ | −1 | 1 | (w_{a,i} × sₐ, w_{b,i} × s_{b}) |
| 23 | ${T}_{23}^{( 1 )} = [ - 450 : 36 : - 18 \; 50 : 36 : 482 ]$ | 1i | 1 | (w_{a,i} × sₐ, w_{b,i} × s_{b}) |
| 24 | ${T}_{24}^{( 1 )} = [ - 478 : 36 : - 46 , 22 : 36 : 454 ]$ | 1 | 1 | (w_{a,i} × sₐ, w_{b,i} × s_{b}) |
| 25 | ${T}_{25}^{( 1 )} = [ - 462 : 36 : - 30 , 38 : 36 : 470 ]$ | 1 | −1 | (w_{a,i} × sₐ, w_{b,i} × s_{b}) |
| 26 | ${T}_{26}^{( 1 )} = [ - 470 : 36 : - 38 , 30 : 36 : 462 ]$ | −1 | −1 | (w_{a,i} × sₐ, w_{b,i} × s_{b}) |
| 27 | ${T}_{27}^{( 1 )} = [ - 454 : 36 : - 22 , 46 : 36 : 478 ]$ | 1 | −1 | (w_{a,i} × sₐ, w_{b,i} × s_{b}) |
| 28 | ${T}_{28}^{( 1 )} = [ - 476 : 36 : - 44 , 24 : 36 : 456 ]$ | 1 | 1 | (w_{a,i} × sₐ, w_{b,i} × s_{b}) |
| 29 | ${T}_{29}^{( 1 )} = [ - 460 : 36 : - 28 , 40 : 36 : 472 ]$ | 1 | −1 | (w_{a,i} × sₐ, w_{b,i} × s_{b}) |
| 30 | ${T}_{30}^{( 1 )} = [ - 468 : 36 : - 36 , 32 : 36 : 464 ]$ | −1 | −1 | (w_{a,i} × sₐ, w_{b,i} × s_{b}) |
| 31 | ${T}_{31}^{( 1 )} = [ - 452 : 36 : - 20 , 48 : 36 : 480 ]$ | 1 | −1 | (w_{a,i} × sₐ, w_{b,i} × s_{b}) |
| 32 | ${T}_{32}^{( 1 )} = [ - 448 : 36 : - 16 \; 52 : 36 : 484 ]$ | −1i | 1 | (w_{a,i} × sₐ, w_{b,i} × s_{b}) |
| 33 | ${T}_{33}^{( 1 )} = [ - 480 : 36 : - 48 , 20 : 36 : 452 ]$ | −1 | −1 | (w_{a,i} × sₐ, w_{b,i} × s_{b}) |
| 34 | ${T}_{34}^{( 1 )} = [ - 464 : 36 : - 32 , 36 : 36 : 468 ]$ | −1 | 1 | (w_{a,i} × sₐ, w_{b,i} × s_{b}) |
| 35 | ${T}_{35}^{( 1 )} = [ - 472 : 36 : - 40 , 28 : 36 : 460 ]$ | −1 | −1 | (w_{a,i} × sₐ, w_{b,i} × s_{b}) |
| 36 | ${T}_{36}^{( 1 )} = [ - 456 : 36 : - 24 , 44 : 36 : 476 ]$ | 1 | −1 | (w_{a,i} × sₐ, w_{b,i} × s_{b}) |
| | Extra tones [−495 485 −491 489 | | | [1 −1 −1 −1 1 1 1 −1 1 −1 −1 −1 −1 −1 −1 1] |
| | −489 491 −493 487 −494 486 | | | (the sequence elements are mapped to the tone |
| | −490 490 −488 492 −492 488] | | | indices with the same order listed for the extra |
| | | | | tones, i.e., no sorting of the extra tones) |
| | Extra tones [−499 −487 493 497 | | | [1 1 1 −1 1 −1 −1 −1 1 1 1 −1 −1 1 1 1] |
| | −497 −485 495 499 −498 −486 | | | (the sequence elements are mapped to the tone |
| | 494 498 −496 −484 496 500] | | | indices with the same order listed for the extra |
| | | | | tones, i.e., no sorting of the extra tones) |

As noted, sₐ=(1, 1, 1, 1i,l,1, 1, 14 1, 1−i,4 1i, S_{b}=(111i−1−1−111i 1, 1, 1−1i−11−1i).

The mast sequence can also be shown as a vector:

DLTF_{-500:500} = [ ...
0 1 1 1 −1 1 1 1 −1 −1 −1 1 −1 1 1 −1 1 1 1 1 −1 1 1 −1 1 1 1 1 −1 −1 −1 1 −1 1 1 1 −1 1 1 −1 1 −1 −1 −1 1 1 1 −1 1 1i 1i 1i −1i
1 1 1 −1 1 1 −1 1 1 1 1 −1 −1 −1 1 −1 1 1 1 −1 1 1 −1 1 −1 −1 −1 1 1 1 −1 1 1i 1i 1i −1i 1 1 1 −1 1 1 −1 1 1 1 1 −1 −1 −1 1 −1 1 1
1 −1 1 1 −1 1 −1 −1 −1 1 1 1 −1 1 1i 1i 1i −1i 1i 1i 1i −1i 1i 1i −1i 1i 1i 1i 1i −1i −1i −1i 1i −1i 1i 1i 1i −1i 1i 1i −1i 1i −1i −1i −1i 1i
1i 1i −1i 1i −1 −1 −1 1 −1 −1 −1 1 −1 −1 1 −1 −1 −1 −1 1 1 1 −1 1 −1 −1 −1 1 −1 −1 1 −1 1 1 1 −1 −1 −1 1 −1 −1 −1i −1i −1i 1i 1 1 1 −1 1
1 −1 1 1 1 1 −1 −1 −1 1 −1 1 1 1 −1 1 1 −1 1 −1 −1 −1 1 1 1 −1 1 1i 1i 1i −1i 1 1 1 −1 1 1 −1 1 1 1 1 −1 −1 −1 1 −1 1 1 1 −1 1 1
−1 1 −1 −1 −1 1 1 1 −1 1 1i 1i 1i −1i −1i −1i −1i 1i −1i −1i 1i −1i −1i −1i −1i 1i 1i 1i −1i 1i −1i −1i −1i 1i −1i −1i 1i −1i 1i 1i 1i −1i −1i −1i
1i −1i 1 1 1 −1 1 1 1 −1 1 1 −1 1 1 1 1 −1 −1 −1 1 −1 1 1 1 −1 1 1 −1 1 −1 −1 −1 1 1 1 −1 1 1i 1i 1i −1i −1 −1 −1 1 −1 −1 1 −1 −1 −1
−1 1 1 1 −1 1 −1 −1 −1 1 −1 −1 1 −1 1 1 1 −1 −1 −1 1 −1 −1i −1i −1i 1i 1 1 1 −1 1 1 −1 1 1 1 1 −1 −1 −1 1 −1 1 1 1 −1 1 1 −1 1 −1
−1 −1 1 1 1 −1 1 1i 1i 1i −1i −1i −1i −1i 1i −1i −1i 1i −1i −1i −1i −1i 1i 1i 1i −1i 1i −1i −1i −1i 1i −1i −1i 1i −1i 1i 1i 1i −1i −1i −1i 1i −1i 1
1 1 −1 1i 1i 1i −1i 1i 1i −1i 1i 1i 1i 1i −1i −1i −1i 1i −1i 1i 1i 1i −1i 1i 1i −1i 1i −1i −1i −1i 1i 1i 1i −1i 1i −1 −1 −1 1 0 0 0 0 0 0 0 0
0 0 0 0 0 0 0 0 0 0 0 0 0 0 0 0 0 0 0 0 0 0 0 0 1 1 1 −1 1 1 −1 1 1 1 1 −1 −1 −1 1 −1 −1 −1 −1 1 −1 −1 1 −1 1 1 1 −1 −1 −1 1 −1
1 1 −1 1 1i 1i 1i −1i 1i 1i −1i 1i 1i 1i 1i −1i −1i −1i 1i −1i −1i −1i −1i 1i −1i −1i 1i −1i 1i 1i 1i −1i −1i −1i 1i −1i 1i 1i −1i 1i −1 −1 −1 1
−1 −1 1 −1 −1 −1 −1 1 1 1 −1 1 1 1 1 −1 1 1 −1 1 −1 −1 −1 1 1 1 −1 1 −1 −1 1 −1 −1 −1 −1 1 −1 −1 1 −1 −1 −1 −1 1 1 1 −1 1 1 1 1 −1
1 1 −1 1 −1 −1 −1 1 1 1 −1 1 −1 −1 1 −1 −1 −1 −1 1 −1 −1 1 −1 −1 −1 −1 1 1 1 −1 1 1 1 1 −1 1 1 −1 1 −1 −1 −1 1 1 1 −1 1 −1 −1 1 −1
1i 1i 1i −1i 1i 1i −1i 1i 1i 1i 1i −1i −1i −1i 1i −1i −1i −1i −1i 1i −1i −1i 1i −1i 1i 1i 1i −1i −1i −1i 1i −1i 1i 1i −1i 1i −1 −1 −1 1 −1 −1 1 −1
−1 −1 −1 1 1 1 −1 1 1 1 1 −1 1 1 −1 1 −1 −1 −1 1 1 1 −1 1 −1 −1 1 −1 1 1 1 −1 1 1 −1 1 1 1 1 −1 −1 −1 1 −1 −1 −1 −1 1 −1 −1 1 −1
1 1 1 −1 −1 −1 1 −1 1 1 −1 1 1 1 1 −1 1 1 −1 1 1 1 1 −1 −1 −1 1 −1 −1 −1 −1 1 −1 −1 1 −1 1 1 1 −1 −1 −1 1 −1 1 1 −1 1 −1i −1i −1i
1i −1i −1i 1i −1i −1i −1i −1i 1i 1i 1i −1i 1i 1i 1i 1i −1i 1i 1i −1i 1i −1i −1i −1i 1i 1i 1i −1i 1i −1i −1i 1i −1i −1 −1 −1 1 −1 −1 1 −1 −1 −1 −1
1 1 1 −1 1 1 1 1 −1 1 1 −1 1 −1 −1 −1 1 1 1 −1 1 −1 −1 1 −1 1 1 1 −1 1 1 −1 1 1 1 1 −1 −1 −1 1 −1 −1 −1 −1 1 −1 −1 1 −1 1 1 1 −1
−1 −1 1 −1 1 1 −1 1 −1i −1i −1i 1i −1i −1i 1i −1i −1i −1i −1i 1i 1i 1i −1i 1i 1i 1i 1i −1i 1i 1i −1i 1i −1i −1i −1i 1i 1i 1i −1i 1i −1i −1i 1i −1i
−1 −1 −1 1 −1 −1 1 −1 1 1 −1 1 −1 −1 −1 1]

Note that this sequence may be multiplied with a coefficient on the unit circle, such as e^{jπ/4} or e^{-jπ/4}, to rotate the elements so that the elements of the sequence are in a specific constellation, e.g., QPSK modulation like e^{jπ/4}×{1, 1i, −1, −1i}. The values on the extra tone indices may be chosen to minimize PAPR further via random search.

A pilot plan may be used in an example. For example, for this tone plan, pilot tone indices may be chosen as in Table 39.

TABLE 39
Pilot indices (80 MHz)

| | Single stream pilot indices for DRU transmission over 80 MHz, |
|---|---|
| DRU size | pilot tones starting from smallest i to larger i |
| DRU52, i = | [−339 −195 161 305], [−331 −187 169 313], [−335 −191 165 309] [−327 −183 173 317] |
| {1, . . . , 16} | [−333 −189 167 311] |
| | [−325 −181 175 319] [−337 −193 163 307] [−329 −185 171 315] [−338 −194 162 306] |
| | [−330 −186 170 314] |
| | [−334 −190 166 310] [−326 −182 174 318] [−332 −188 168 312] [−324 −180 176 320] |
| | [−336 −192 164 308] |
| | [−328 −184 172 316] |
| DRU106, i = | [−375 −87 69 321], [−427 −103 181 253], [−425 −101 183 255], [−373 −85 71 323], |
| {1, . . . , 8} | [−374 −86 70 322], [−426 −102 182 254], [−424 −100 184 256], [−372 −84 72 324] |
| DRU242, i = | [−475 −439 −295 25 41 313 421 457], [−473 −421 −293 −133 27 279 315 475], |
| {1, 2, 3, 4} | [−474 −438 −294 26 42 314 422 458], [−472 −420 −292 −132 28 280 316 476] |
| DRU484, i = | [−483 −477 −437 −339 −333 −293 −195 −189 −149 −117 27 125 171 315 413 459] |
| {1, 2, 3, 4} | [−482 −476 −436 −338 −332 −292 −194 −188 −148 −116 28 126 172 316 414 460] |

PAPR and CM results for this design are given as follows:

TABLE 40
PAPR results for 80 MHz DRU LTF based on the proposed methodology
(with and without taking the pilots into account)

| PAPR | | | | | | | | | | | | | | | | |
|---|---|---|---|---|---|---|---|---|---|---|---|---|---|---|---|---|
| [dB] | 1 | 2 | 3 | 4 | 5 | 6 | 7 | 8 | 9 | 10 | 11 | 12 | 13 | 14 | 15 | 16 |
| DRU52 | 3.01, | 2.98, | 3.01, | 2.98, | 3.01, | 2.98, | 3.01, | 2.98, | 3.01, | 2.98, | 3.01, | 2.98, | 3.01, | 2.98, | 3.01, | 2.98, |
| | 4.8 | 4.72 | 4.8 | 4.72 | 4.8 | 4.72 | 4.8 | 4.72 | 4.8 | 4.72 | 4.8 | 4.72 | 4.8 | 4.72 | 4.8 | 4.72 |

| | | | | | | | | |
|---|---|---|---|---|---|---|---|---|
| DRU106 | 3.78, 4.6 | 3.72, 4.71 | 3.72, 4.71 | 3.78, 4.6 | 3.01 | 3.01 | 3.01 | 3.01 |

| | | | | |
|---|---|---|---|---|
| DRU242 | 5, 4.99 | 5.33, 5.13 | 5, 4.99 | 5.33, 5.13 |

| | | |
|---|---|---|
| DRU484 | 5.24, 5.35 | 5.24, 5.35 |

The MATLAB implementation is also given as a reference below.

clear all
close all
clc
tonesDRU26{1} = [−483:36:−51, 17:36:449].′;
tonesDRU26{2} = [−467:36:−35, 33:36:465].′;
tonesDRU26{3} = [−475:36:−43, 25:36:457].′;
tonesDRU26{4} = [−459:36:−27, 41:36:473].′;
tonesDRU26{5} = [−451:36:−19 49:36:481].′;
tonesDRU26{6} = [−479:36:−47, 21:36:453].′;
tonesDRU26{7} = [−463:36:−31, 37:36:469].′;
tonesDRU26{8} = [−471:36:−39, 29:36:461].′;
tonesDRU26{9} = [−455:36:−23, 45:36:477].′;
tonesDRU26{10} = [−477:36:−45, 23:36:455].′;
tonesDRU26{11} = [−461:36:−29, 39:36:471].′;
tonesDRU26{12} = [−469:36:−37, 31:36:463].′;
tonesDRU26{13} = [−453:36:−21, 47:36:479].′;
tonesDRU26{14} = [−449:36:−17 51:36:483].′;
tonesDRU26{15} = [−481:36:−49, 19:36:451].′;
tonesDRU26{16} = [−465:36:−33, 35:36:467].′;
tonesDRU26{17} = [−473:36:−41, 27:36:459].′;
tonesDRU26{18} = [−457:36:−25, 43:36:475].′;
tonesDRU26{19} = [−482:36:−50, 18:36:450].′;
tonesDRU26{20} = [−466:36:−34, 34:36:466].′;
tonesDRU26{21} = [−474:36:−42, 26:36:458].′;
tonesDRU26{22} = [−458:36:−26, 42:36:474].′;
tonesDRU26{23} = [−450:36:−18 50:36:482].′;
tonesDRU26{24} = [−478:36:−46, 22:36:454].′;
tonesDRU26{25} = [−462:36:−30, 38:36:470].′;
tonesDRU26{26} = [−470:36:−38, 30:36:462].′;
tonesDRU26{27} = [−454:36:−22, 46:36:478].′;
tonesDRU26{28} = [−476:36:−44, 24:36:456].′;
tonesDRU26{29} = [−460:36:−28, 40:36:472].′;
tonesDRU26{30} = [−468:36:−36, 32:36:464].′;
tonesDRU26{31} = [−452:36:−20, 48:36:480].′;
tonesDRU26{32} = [−448:36:−16 52:36:484].′;
tonesDRU26{33} = [−480:36:−48, 20:36:452].′;
tonesDRU26{34} = [−464:36:−32, 36:36:468].′;
tonesDRU26{35} = [−472:36:−40, 28:36:460].′;
tonesDRU26{36} = [−456:36:−24, 44:36:476].′;
pilotsDRU52{1} = [ −339 −195 161 305 ]+0;
pilotsDRU52{2} = [ −339 −195 161 305 ]+8;
pilotsDRU52{3} = [ −339 −195 161 305 ]+4;
pilotsDRU52{4} = [ −339 −195 161 305 ]+12;
pilotsDRU52{5} = [ −339 −195 161 305 ]+6;
pilotsDRU52{6} = [ −339 −195 161 305 ]+14;
pilotsDRU52{7} = [ −339 −195 161 305 ]+2;
pilotsDRU52{8} = [ −339 −195 161 305 ]+10;
pilotsDRU52{9} = [ −339 −195 161 305 ]+1;
pilotsDRU52{10} = [ −339 −195 161 305 ]+9;
pilotsDRU52{11} = [ −339 −195 161 305 ]+5;
pilotsDRU52{12} = [ −339 −195 161 305 ]+13;
pilotsDRU52{13} = [ −339 −195 161 305 ]+7;
pilotsDRU52{14} = [ −339 −195 161 305 ]+15;
pilotsDRU52{15} = [ −339 −195 161 305 ]+3;
pilotsDRU52{16} = [ −339 −195 161 305 ]+11;
pilotsDRU106{1} = [ −375 −87 69 321];
pilotsDRU106{2} = [ −427 −103 181 253];
pilotsDRU106{3} = [ −427 −103 181 253]+2;
pilotsDRU106{4} = [ −375 −87 69 321]+2;
pilotsDRU106{5} = [ −375 −87 69 321]+1;
pilotsDRU106{6} = [ −427 −103 181 253]+1;
pilotsDRU106{7} = [ −427 −103 181 253]+3;
pilotsDRU106{8} = [ −375 −87 69 321]+3;
pilotsDRU242{1} = [−475 −439 −295 25 41 313 421 457];
pilotsDRU242{2} = [−473 −421 −293 −133 27 279 315 475];
pilotsDRU242{3} = [−475 −439 −295 25 41 313 421 457]+1;
pilotsDRU242{4} = [−473 −421 −293 −133 27 279 315 475]+1;
pilotsDRU484{1} = [−483 −477 −437 −339 −333 −293 −195 −189 −149 −117
27 125 171 315 413 459];
pilotsDRU484{2} = [−483 −477 −437 −339 −333 −293 −195 −189 −149 −117
27 125 171 315 413 459]+1;
Ga13 = [1 1 1 1i −1 1 1 −1i 1 −1 1 −1i 1i];
Gb13 = [1 1i −1 −1 −1 1i −1 1 1 −1i −1 1 −1i];
tones = [−500:500];
masterSequence = zeros(1,numel(tones));
masterSequence(tonesDRU26{1}+501) = [Ga13 Gb13];
masterSequence(tonesDRU26{2}+501) = [Ga13 −Gb13];
masterSequence(tonesDRU26{3}+501) = [Ga13 Gb13];
masterSequence(tonesDRU26{4}+501) = [−Ga13 Gb13];
%
masterSequence(tonesDRU26{5}+501) = [1i*Ga13 Gb13];
%
masterSequence(tonesDRU26{6}+501) = [Ga13 Gb13];
masterSequence(tonesDRU26{7}+501) = [Ga13 −Gb13];
masterSequence(tonesDRU26{8}+501) = [−Ga13 −Gb13];
masterSequence(tonesDRU26{9}+501) = [Ga13 −Gb13];
masterSequence(tonesDRU26{10}+501) = −[Ga13 Gb13];
masterSequence(tonesDRU26{11}+501) = −[Ga13 −Gb13];
masterSequence(tonesDRU26{12}+501) = −[−Ga13 −Gb13];
masterSequence(tonesDRU26{13}+501) = −[Ga13 −Gb13];
masterSequence(tonesDRU26{14}+501) = [1i*Ga13 −Gb13];
masterSequence(tonesDRU26{15}+501) = [Ga13 Gb13];
masterSequence(tonesDRU26{16}+501) = [Ga13 −Gb13];
masterSequence(tonesDRU26{17}+501) = [Ga13 Gb13];
masterSequence(tonesDRU26{18}+501) = [−Ga13 Gb13];
masterSequence(tonesDRU26{19}+501) = [Ga13 Gb13];
masterSequence(tonesDRU26{20}+501) = [Ga13 −Gb13];
masterSequence(tonesDRU26{21}+501) = [Ga13 Gb13];
masterSequence(tonesDRU26{22}+501) = [−Ga13 Gb13];
%
masterSequence(tonesDRU26{23}+501) = [1i*Ga13 Gb13];
%
masterSequence(tonesDRU26{24}+501) = [Ga13 Gb13];
masterSequence(tonesDRU26{25}+501) = [Ga13 −Gb13];
masterSequence(tonesDRU26{26}+501) = [−Ga13 −Gb13];
masterSequence(tonesDRU26{27}+501) = [Ga13 −Gb13];
masterSequence(tonesDRU26{28}+501) = [Ga13 Gb13];
masterSequence(tonesDRU26{29}+501) = [Ga13 −Gb13];
masterSequence(tonesDRU26{30}+501) = [−Ga13 −Gb13];
masterSequence(tonesDRU26{31}+501) = [Ga13 −Gb13];
%
masterSequence(tonesDRU26{32}+501) = [−1i*Ga13 Gb13];
%
masterSequence(tonesDRU26{33}+501) = −[Ga13 Gb13];
masterSequence(tonesDRU26{34}+501) = −[Ga13 −Gb13];
masterSequence(tonesDRU26{35}+501) = −[Ga13 Gb13];
masterSequence(tonesDRU26{36}+501) = −[−Ga13 Gb13];
extra106 = [−495 485 −491 489 −489 491 −493 487 −494 486 −490 490 −488 492 −
492 488].′;
masterSequence(extra106+501) = [1 −1 −1 −1 1 1 1 −1 1 −1 −1 −1 −1 −1 −1 1];
extra242 = [−499 −487 493 497 −497 −485 495 499 −498 −486 494 498 −
496 −484 496 500];
masterSequence(extra242+501) = [1 1 1 −1 1 −1 −1 −1 1 1 1 −1 −1 1 1 1];

An example provided herein includes optimal DRU-LTF sequences with support to single stream pilots. Single stream pilot refers to referring to an LTF mode in 802.11 in which the same pilot sequence is applied to all spatial time streams for a given resource allocation. Another LTF mode in 802, 11 is masked LTF sequence in which the pilots as well as the data subcarriers of the LTF is masked by the same P matrix. In single stream pilots, the data subcarriers of the LTF are multiplied by the P matrix while the pilot tones are multiplied by the R matrix which is derived from the P matrix according to the following equation.

$${[ {R}_{E H T - L T F} ]}_{m , n} = {[ {P}_{E H T - L T F} ]}_{1 , n} 1 \leq m , n \leq {N}_{E H T - L T F} \qquad Eq . 18$$

Accordingly, the optimal/suboptimal LTF sequences that will result in the best possible PAPR given single stream pilot mode is applied needs to be found. In what follows, we disclose such new sequences considering different tone plan examples.

In one example, the search methodology for the optimal component LTF sequences, given that single stream pilot mode is applied, may be defined as follows. For each sequence of length 26 (original sequence), another sequence of length 26 is generated by multiplying the pilot values by the matrix R (SSP sequence). The PAPR is computed for the original sequence and the SSP sequence. The sequence that results in the smallest PAPR for both the original sequence, and the SSP sequence is chosen as the optimal component sequence for this specific DRU. The above steps are repeated for each one of the nine DRUs of size 26DRU20.

TABLE 41
Tone Plan 1 (DBW = 20 MHz)

| 26-tone DRU | DRU1 | DRU2 | DRU3 | DRU4 | DRU5 |
|---|---|---|---|---|---|
| | [−120:9:−12, | [−116:9:−8, | [−118:9:−10, | [−114:9:−6, | [−112:9:−4, |
| | 6:9:114] | 10:9:118] | 8:9:116] | 12:9:120] | 5:9:113] |
| | DRU6 | DRU7 | DRU8 | DRU9 | |
| | [−119:9:−11, | [−115:9:−7, | [−117:9:−9, | [−113:9:−5, | |
| | 7:9:115] | 11:9:119] | 9:9:117] | 4:9:112] | |

| | | |
|---|---|---|
| 52-tone DRU | DRU1 | DRU2 |
| | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone | DRU1 | DRU2 |
| DRU | 26-tone [DRU1~4], [−3, 3] | 26-tone [DRU6~9], [−2, 2] |

In an example, the optimal LTF sequences for 26DRU20 considering an exemplary tone plan 1 (see Table 41) is listed in Table 42 and the mapping of the optimal sequences to the nine 26DRU20 is listed in Table 43.

TABLE 42
Exemplary Optimal DRU LTF Sequences for 26DRU20 (Tone Plan 1)

| Optimal | |
|---|---|
| Sequence | |
| Number | Optimal LTF Sequence |
| LTF26DRU20_1 | −1, −1, 1, 1, −1, −1, −1, −1, 1, 1, −1, −1, 1, −1, 1, −1, 1, −1, −1, 1, −1, 1, 1, 1, 1, 1 |
| LTF26DRU20_2 | −1, −1, −1, 1, 1, 1, 1, 1, −1, −1, 1, −1, −1, 1, −1, −1, −1, 1, 1, −1, 1, −1, 1, 1, −1, 1 |
| LTF26DRU20_3 | −1, −1, 1, 1, −1, −1, −1, 1, −1, −1, −1, 1, −1, −1, −1, −1, 1, 1, 1, 1, −1, 1, −1, −1, 1, −1 |
| LTF26DRU20_4 | −1, 1, 1, −1, 1, 1, −1, −1, 1, −1, 1, −1, 1, 1, 1, −1, −1, 1, 1, 1, −1, −1, −1, −1, −1, −1 |
| LTF26DRU20_5 | −1, −1, −1, −1, −1, 1, −1, 1, 1, −1, 1, 1, −1, 1, −1, 1, −1, 1, 1, 1, −1, −1, 1, 1, 1, −1 |
| LTF26DRU20_6 | −1, −1, 1, 1, −1, −1, 1, −1, −1, −1, 1, −1, 1, −1, −1, 1, −1, 1, −1, −1, 1, −1, 1, 1, 1, 1 |
| LTF26DRU20_7 | −1, −1, −1, −1, −1, −1, 1, 1, 1, −1, −1, 1, 1, 1, −1, 1, −1, 1, −1, −1, 1, 1, −1, 1, 1, −1 |
| LTF26DRU20_8 | −1, −1, −1, 1, 1, 1, −1, 1, 1, 1, 1, 1, −1, −1, 1, 1, −1, 1, 1, −1, 1, −1, 1, 1, −1, 1 |

TABLE 43
Exemplary Optimal DRU LTF Sequence Mapping
for 26DRU20 for (Tone Plan 1)

| | Optimal LTF Sequence (Tone |
|---|---|
| 26DRU20 | Plan 1) |
| 1 | LTF26DRU20_1 |
| 2 | LTF26DRU20_2 |
| 3 | LTF26DRU20_3 |
| 4 | LTF26DRU20_4 |
| 5 | LTF26DRU20_5 |
| 6 | LTF26DRU20_6 |
| 7 | LTF26DRU20_2 |
| 8 | LTF26DRU20_7 |
| 9 | LTF26DRU20_8 |

In an example, the optimal LTF sequences for 52DRU20 considering an exemplary tone plan 1 (see Table 41) is listed in Table 45 and the mapping of the optimal sequences to the four 52DRU20 is listed in Table 46.

In another example, the optimal LTF sequences for 52DRU20 may be constructed by combining the most common optimal sequence for 26DRU20, namely, LTF26DRU20_1 (see Table 42) with the optimal sequences in Table 44.

TABLE 44
Exemplary Optimal DRU Component LTF Sequences for 52DRU20 for Tone Plan 1

| Optimal Sequence | |
|---|---|
| Number | Optimal LTF Sequence |
| LTF26DRU20_9 | 1, 1, −1, 1, −1, 1, 1, −1, 1, −1, −1, −1, 1, −1, 1, −1, −1, −1, 1, −1, −1, −1, 1, 1, 1, −1 |
| LTF26DRU20_10 | 1, −1, −1, −1, −1, 1, 1, −1, −1, 1, −1, 1, 1, 1, −1, 1, 1, 1, 1, −1, 1, 1, 1, 1, 1, 1 |
| LTF26DRU20_11 | −1, 1, −1, 1, 1, −1, 1, −1, −1, −1, 1, −1, 1, −1, −1, −1, 1, −1, −1, −1, 1, 1, −1, −1, 1, −1 |
| LTF26DRU20_12 | −1, 1, −1, −1, 1, −1, 1, 1, 1, −1, 1, −1, 1, 1, 1, 1, 1, 1, 1, 1, −1, −1, 1, 1, 1, −1 |

TABLE 45
Exemplary Optimal DRU LTF Sequences
for 52DRU20 for Tone Plan 1

| Optimal Sequence | |
|---|---|
| Number | Optimal LTF Sequence |
| LTF52DRU20_1 | {LTF26DRU20_2, LTF26DRU20_9} |
| LTF52DRU20_2 | {LTF26DRU20_2, LTF26DRU20_10} |
| LTF52DRU20_3 | {LTF26DRU20_2, LTF26DRU20_11} |
| LTF52DRU20_4 | {LTF26DRU20_2, LTF26DRU20_12} |

TABLE 46
Exemplary Optimal DRU LTF Sequence
Mapping for 52DRU20 for Tone Plan 1

| | Optimal LTF Sequence (Tone |
|---|---|
| 52DRU20 | Plan 1) |
| 1 | LTF52DRU20_1 |
| 2 | LTF52DRU20_2 |
| 3 | LTF52DRU20_3 |
| 4 | LTF52DRU20_4 |

In an example, the optimal LTF sequences for 106DRU20 considering an exemplary tone plan 1 (see Table 41) is listed in Table 48 and the mapping of the optimal sequences to the two 106DRU20 is listed in Table 49.

In another example, the optimal LTF sequences for 106DRU20 may be constructed by combining sequences from Tables (Table 42, Table 44, and Table 47) as listed in Table 48.

TABLE 47
Exemplary Optimal DRU Component LTF Sequences for 106DRU20 for Tone Plan 1

| Optimal Sequence | |
|---|---|
| Number | Optimal LTF Sequence |
| LTF26DRU20_13 | 1, 1, 1, 1, 1, −1, 1, −1, 1, −1, 1, 1, −1, −1, −1, −1, 1, −1, 1, 1, −1, 1, −1, −1, −1, −1 |
| LTF26DRU20_14 | −1, 1, −1, −1, −1, −1, 1, 1, 1, −1, 1, −1, 1, 1, −1, −1, −1, −1, 1, −1, −1, 1, −1, −1, 1, 1 |
| LTF26DRU20_15 | 1, −1, −1, 1, 1, 1, 1, −1, −1, 1, 1, −1, −1, 1, −1, −1, −1, 1, −1, −1, 1, 1, 1, 1, −1, −1 |

TABLE 48
Exemplary Optimal DRU LTF Sequences for 106DRU20 for Tone Plan 1

| Optimal Sequence | |
|---|---|
| Number | Optimal LTF Sequence |
| LTF106DRU20_1 | {LTF26DRU20_2, LTF26DRU20_9, LTF26DRU20_13, LTF26DRU20_14}, {1, −1} |
| LTF106DRU20_2 | {LTF26DRU20_2, LTF26DRU20_9, LTF26DRU20_13, LTF26DRU20_15}, {−1, −1} |

TABLE 49
Exemplary Optimal DRU LTF Sequence Mapping
for 106DRU20 for Tone Plan 1

| | Optimal LTF Sequence (Tone |
|---|---|
| 106DRU20 | Plan 1) |
| 1 | LTF106DRU20_1 |
| 2 | LTF106DRU20_2 |

TABLE 50
Tone Plan 2

| 26-tone DRU | DRU1 | DRU2 | DRU3 | DRU4 | DRU5 |
|---|---|---|---|---|---|
| | [−120:9:−12, | [−115:9:−7, | [−118:9:−10, | [−113:9:−5, | [−117:9:−9, |
| | 6:9:114] | 11:9:119] | 8:9:116] | 4:9:112] | 9:9:117] |
| | DRU6 | DRU7 | DRU8 | DRU9 | |
| | [−112:9:−4, | [−116:9:−8, | [−119:9:−11, | [−114:9:−6, | |
| | 5:9:113] | 10:9:118] | 7:9:115] | 12:9:120] | |

| | | |
|---|---|---|
| 52-tone DRU | DRU1 | DRU2 |
| | 26-tone [DRU1, DRU2] | 26-tone [DRU3, DRU4] |
| | DRU3 | DRU4 |
| | 26-tone [DRU6, DRU7] | 26-tone [DRU8, DRU9] |
| 106-tone | DRU1 | DRU2 |
| DRU | 26-tone [DRU1~4], [−3, 2] | 26-tone [DRU6~9], [−2, 3] |

In an example, the optimal LTF sequences for 26DRU20 considering an exemplary tone plan 2 (see Table 50) is listed in Table 51 and the mapping of the optimal sequences to the nine 26DRU20 is listed in Table 52.

TABLE 51
Exemplary Optimal DRU LTF Sequences for 26DRU20 (Tone Plan 2)

| Optimal | |
|---|---|
| Sequence | |
| Number | Optimal LTF Sequence |
| LTF26DRU20_1 | −1, −1, −1, 1, 1, 1, 1, 1, −1, −1, 1, −1, −1, 1, −1, −1, −1, 1, 1, −1, 1, −1, 1, 1, −1, 1 |
| LTF26DRU20_2 | −1, −1, −1, −1, −1, −1, 1, 1, 1, −1, −1, 1, 1, 1, −1, 1, −1, 1, −1, −1, 1, 1, −1, 1, 1, −1 |
| LTF26DRU20_3 | −1, −1, −1, −1, 1, −1, 1, 1, −1, 1, −1, 1, 1, −1, 1, −1, 1, 1, 1, −1, 1, 1, −1, −1, 1, 1 |
| LTF26DRU20_4 | −1, −1, −1, 1, 1, 1, −1, 1, 1, 1, 1, 1, −1, −1, 1, 1, −1, 1, 1, −1, 1, −1, 1, 1, −1, 1 |
| LTF26DRU20_5 | −1, −1, 1, −1, −1, 1, −1, −1, 1, 1, 1, 1, 1, 1, −1, 1, −1, 1, 1, 1, −1, −1, 1, 1, 1, −1 |
| LTF26DRU20_6 | −1, −1, −1, 1, 1, 1, 1, 1, −1, −1, −1, 1, 1, −1, −1, 1, −1, 1, −1, −1, −1, 1, −1, −1, 1, −1 |
| LTF26DRU20_7 | −1, −1, 1, 1, −1, −1, 1, −1, −1, −1, 1, −1, 1, −1, −1, 1, −1, 1, −1, −1, 1, −1, 1, 1, 1, 1 |
| LTF26DRU20_8 | −1, −1, 1, 1, 1, −1, −1, 1, 1, 1, 1, 1, 1, 1, −1, −1, 1, 1, −1, 1, 1, −1, 1, −1, 1, −1 |

TABLE 52
Exemplary Optimal DRU LTF Sequence Mapping
for 26DRU20 for (Tone Plan 2)

| | Optimal LTF Sequence (Tone |
|---|---|
| 26DRU20 | Plan 2) |
| 1 | LTF26DRU20_1 |
| 2 | LTF26DRU20_2 |
| 3 | LTF26DRU20_3 |
| 4 | LTF26DRU20_4 |
| 5 | LTF26DRU20_5 |
| 6 | LTF26DRU20_6 |
| 7 | LTF26DRU20_7 |
| 8 | LTF26DRU20_8 |
| 9 | LTF26DRU20_1 |

In an example, the optimal LTF sequences for 52DRU20 considering an exemplary tone plan 2 (see Table 50) is listed in Table 54 and the mapping of the optimal sequences to the four 52DRU20 is listed in Table 55.

In another example, the optimal LTF sequences for 52DRU20 may be constructed by combining the most common optimal sequence for 26DRU20, namely, LTF26DRU20_1 (see Table 51) with the optimal sequences in Table 53.

TABLE 53
Exemplary Optimal DRU Component LTF Sequences for 52DRU20 for Tone Plan 2

| Optimal Sequence | |
|---|---|
| Number | Optimal LTF Sequence |
| LTF26DRU20_9 | −1, −1, −1, −1, −1, −1, −1, 1, −1, −1, −1, −1, −1, 1, −1, −1, 1, −1, 1, −1, 1, 1, 1, −1, 1, −1 |
| LTF26DRU20_10 | −1, 1, −1, −1, −1, −1, 1, 1, −1, −1, −1, −1, 1, 1, −1, 1, 1, 1, 1, 1, −1, 1, 1, 1, 1, 1 |
| LTF26DRU20_11 | 1, 1, −1, −1, 1, −1, −1, 1, −1, −1, −1, −1, 1, −1, −1, −1, 1, −1, 1, −1, 1, −1, 1, −1, 1, 1 |
| LTF26DRU20_12 | 1, −1, 1, −1, −1, 1, 1, −1, −1, −1, −1, 1, −1, −1, −1, 1, −1, −1, −1, −1, −1, −1, −1, −1, 1, −1 |

TABLE 54
Exemplary Optimal DRU LTF Sequences
for 52DRU20 for Tone Plan 2

| Optimal Sequence | |
|---|---|
| Number | Optimal LTF Sequence (Tone Plan 2) |
| LTF52DRU20_1 | {LTF26DRU20_1, LTF26DRU20_9} |
| LTF52DRU20_2 | {LTF26DRU20_1, LTF26DRU20_10} |
| LTF52DRU20_3 | {LTF26DRU20_1, LTF26DRU20_11} |
| LTF52DRU20_4 | {LTF26DRU20_1, LTF26DRU20_12} |

TABLE 55
Exemplary Optimal DRU LTF Sequence
Mapping for 52DRU20 for Tone Plan 2

| | Optimal LTF Sequence (Tone |
|---|---|
| 52DRU20 | Plan 2) |
| 1 | LTF52DRU20_1 |
| 2 | LTF52DRU20_2 |
| 3 | LTF52DRU20_3 |
| 4 | LTF52DRU20_4 |

In an example, the optimal LTF sequences for 106DRU20 considering an exemplary tone plan 2 (see Table 50) is listed in Table 57 and the mapping of the optimal sequences to the two 106DRU20 is listed in Table 58.

In another example, the optimal LTF sequences for 106DRU20 may be constructed by combining sequences from Tables (Table 51, Table 53, and Table 56) as listed in Table 57.

TABLE 56
Exemplary Optimal DRU Component LTF Sequences for 106DRU20 for Tone Plan 2

| Optimal Sequence | |
|---|---|
| Number | Optimal LTF Sequence |
| LTF26DRU20_13 | −1, −1, −1, 1, 1, −1, −1, −1, 1, 1, −1, −1, −1, 1, −1, −1, 1, −1, 1, 1, 1, −1, −1, −1, 1, 1 |
| LTF26DRU20_14 | −1, 1, −1, 1, 1, −1, −1, 1, 1, −1, 1, −1, 1, −1, 1, 1, −1, −1, −1, −1, 1, −1, −1, −1, 1, 1 |
| LTF26DRU20_15 | 1, −1, 1, −1, −1, 1, 1, 1, −1, 1, −1, −1, 1, −1, 1, 1, 1, −1, 1, 1, 1, 1, −1, 1, −1, −1 |
| LTF26DRU20_16 | −1, −1, 1, −1, 1, −1, 1, −1, 1, −1, 1, 1, 1, 1, 1, −1, 1, 1, −1, 1, 1, 1, 1, −1, −1, −1 |

TABLE 57
Exemplary Optimal DRU LTF Sequences for 106DRU20 for Tone Plan 2

| Optimal Sequence | |
|---|---|
| Number | Optimal LTF Sequence (Tone Plan 2) |
| LTF106DRU20_1 | {LTF26DRU20_1, LTF26DRU20_9, LTF26DRU20_14, LTF26DRU20_15}, {−1, 1} |
| LTF106DRU20_2 | {LTF26DRU20_1, LTF26DRU20_9, LTF26DRU20_14, LTF26DRU20_16}, {1, 1} |

TABLE 58
Exemplary Optimal DRU LTF Sequence Mapping
for 106DRU20 for Tone Plan 2

| | Optimal LTF Sequence (Tone |
|---|---|
| 106DRU20 | Plan 2) |
| 1 | LTF106DRU20_1 |
| 2 | LTF106DRU20_2 |

TABLE 59
Tone Plan 3

| 26-tone DRU | DRU1 | DRU2 | DRU3 | DRU4 | DRU5 |
|---|---|---|---|---|---|
| | [−242:18:−26, | [−233:18:−17, | [−238:18:−22, | [−229:18:−13, | [−225:18:−9, |
| | 10:18:226] | 19:18:235] | 14:18:230] | 23:18:239] | 27:18:243] |
| | DRU6 | DRU7 | DRU8 | DRU9 | DRU10 |
| | [−240:18:−24, | [−231:18:−15, | [−236:18:−20, | [−227:18:−11, | [−241:18:−25, |
| | 12:18:228] | 21:18:237] | 16:18:232] | 25:18:241] | 11:18:227] |
| | DRU11 | DRU12 | DRU13 | DRU14 | DRU15 |
| | [−232:18:−16, | [−237:18:−21, | [−228:18:−12, | [−234:18:−18, | [−239:18:−23, |
| | 20:18:236] | 15:18:231] | 24:18:240] | 18:18:234] | 13:18:229] |
| | DRU16 | DRU17 | DRU18 | | |
| | [−230:18:−14, | [−235:18:−19, | [−226:18:−10, | | |
| | 22:18:238] | 17:18:233] | 26:18:242] | | |
| 52-tone DRU | DRU1 | DRU2 | DRU3 | DRU4 | DRU5 |
| | [−242:9:−17, | [−238:9:−13, | [−240:9:−15, | [−236:9:−11, | [−241:9:−16, |
| | 10:9:235] | 14:9:239] | 12:9:237] | 16:9:241] | 11:9:236] |
| | DRU6 | DRU7 | DRU8 | | |
| | [−237:9:−12, | [−239:9:−14, | [−235:9:−10, | | |
| | 15:9:240] | 13:9:238] | 17:9:242] | | |
| 106-tone | DRU1 | DRU2 | DRU3 | DRU4 | |
| DRU | 26−tone | 26−tone | 26−tone | 26−tone | |
| | [DRU1~4], | [DRU6~9], | [DRU10~13], | [DRU15~18], | |
| | [−8, 5] | [−6, 7] | [−7, 6] | [−5, 8] | |

In an example, the optimal LTF sequences for 26DRU40 considering an exemplary tone plan 3 (see Table 59) is listed in Table 60 and the mapping of the optimal sequences to the eighteen 26DRU40 is listed in Table 61.

TABLE 60
Exemplary Optimal DRU LTF Sequences for 26DRU40 (Tone Plan 3)

| Optimal Sequence | |
|---|---|
| Number | Optimal LTF Sequence |
| LTF26DRU40_1 | −1, −1, −1, −1, −1, −1, 1, −1, −1, 1, −1, 1, 1, −1, −1, −1, 1, 1, 1, −1, 1, 1, −1, −1, −1, 1 |
| LTF26DRU40_2 | −1, −1, 1, −1, −1, 1, −1, −1, 1, 1, 1, 1, 1, 1, −1, 1, −1, 1, 1, 1, −1, −1, 1, 1, 1, −1 |
| LTF26DRU40_3 | −1, −1, −1, 1, −1, −1, −1, 1, −1, −1, −1, 1, −1, −1, −1, 1, 1, 1, 1, 1, −1, 1, −1, −1, 1, −1 |
| LTF26DRU40_4 | −1, −1, 1, 1, −1, −1, 1, −1, −1, −1, 1, −1, 1, −1, −1, 1, −1, 1, −1, −1, 1, −1, 1, 1, 1, 1 |
| LTF26DRU40_5 | −1, −1, −1, −1, −1, −1, 1, 1, −1, −1, −1, 1, 1, 1, −1, 1, −1, 1, −1, −1, 1, −1, −1, 1, 1, −1 |
| LTF26DRU40_6 | −1, −1, −1, −1, 1, −1, −1, −1, 1, 1, 1, 1, −1, −1, −1, 1, 1, 1, −1, 1, 1, −1, −1, 1, −1, 1 |
| LTF26DRU40_7 | −1, −1, −1, 1, 1, 1, 1, 1, −1, −1, 1, −1, −1, 1, −1, −1, −1, 1, 1, −1, 1, −1, 1, 1, −1, 1 |
| LTF26DRU40_8 | −1, −1, −1, −1, 1, −1, 1, 1, −1, 1, −1, 1, 1, −1, 1, −1, 1, 1, 1, −1, 1, 1, −1, −1, 1, 1 |
| LTF26DRU40_9 | −1, −1, −1, 1, 1, 1, 1, −1, 1, −1, −1, 1, −1, −1, −1, −1, 1, −1, −1, −1, 1, −1, −1, 1, 1, −1 |
| LTF26DRU40_10 | −1, −1, 1, 1, 1, −1, −1, 1, 1, 1, 1, 1, 1, 1, −1, −1, 1, 1, −1, 1, 1, −1, 1, −1, 1, −1 |
| LTF26DRU40_11 | −1, −1, −1, −1, −1, 1, −1, 1, 1, −1, 1, −1, 1, −1, 1, 1, −1, −1, 1, 1, 1, 1, −1, −1, 1, 1 |

TABLE 61
Exemplary Optimal DRU LTF Sequence Mapping
for 26DRU40 for (Tone Plan 3)

| | Optimal LTF Sequence (Tone |
|---|---|
| 26DRU40 | Plan 3) |
| 1 | LTF26DRU40_1 |
| 2 | LTF26DRU40_2 |
| 3 | LTF26DRU40_3 |
| 4 | LTF26DRU40_4 |
| 5 | LTF26DRU40_5 |
| 6 | LTF26DRU40_4 |
| 7 | LTF26DRU40_1 |
| 8 | LTF26DRU40_5 |
| 9 | LTF26DRU40_3 |
| 10 | LTF26DRU40_6 |
| 11 | LTF26DRU40_7 |
| 12 | LTF26DRU40_8 |
| 13 | LTF26DRU40_9 |
| 14 | LTF26DRU40_7 |
| 15 | LTF26DRU40_9 |
| 16 | LTF26DRU40_10 |
| 17 | LTF26DRU40_11 |
| 18 | LTF26DRU40_8 |

In an example, the optimal LTF sequences for 52DRU40 considering an exemplary tone plan 3 (see Table 59) is listed in Table 63 and the mapping of the optimal sequences to the eight 52DRU40 is listed in Table 64.

In another example, the optimal LTF sequences for 52DRU40 may be constructed by combining the most common optimal sequence for 26DRU40, namely, LTF26DRU40_1 (see Table 60) with the optimal sequences in Table 62.

TABLE 62
Exemplary Optimal DRU Component LTF Sequences for 52DRU40 for Tone Plan 3

| Optimal Sequence | |
|---|---|
| Number | Optimal LTF Sequence |
| LTF26DRU40_12 | 1, −1, 1, −1, −1, 1, 1, 1, −1, 1, −1, 1, −1, 1, −1, −1, −1, 1, −1, −1, 1, −1, 1, 1, 1, −1 |
| LTF26DRU40_13 | 1, −1, −1, −1, −1, 1, 1, −1, 1, −1, 1, −1, 1, −1, 1, −1, −1, −1, 1, −1, −1, −1, −1, 1, 1, 1 |
| LTF26DRU40_14 | −1, 1, 1, −1, 1, 1, 1, 1, −1, 1, −1, −1, −1, 1, −1, 1, 1, 1, −1, 1, −1, 1, 1, 1, −1, −1 |
| LTF26DRU40_15 | 1, −1, −1, −1, −1, 1, 1, 1, −1, 1, −1, 1, −1, −1, −1, −1, −1, 1, 1, −1, 1, 1, 1, −1, 1, 1 |
| LTF26DRU40_16 | 1, −1, −1, 1, −1, 1, 1, 1, −1, −1, −1, 1, −1, 1, −1, 1, −1, 1, −1, −1, 1, −1, −1, 1, 1, −1 |
| LTF26DRU40_17 | 1, −1, 1, −1, 1, −1, −1, −1, 1, −1, −1, −1, −1, 1, 1, 1, −1, 1, −1, 1, −1, 1, 1, −1, −1, 1 |
| LTF26DRU40_18 | 1, −1, 1, −1, −1, −1, 1, −1, 1, −1, 1, 1, −1, 1, −1, −1, −1, 1, −1, −1, −1, −1, −1, 1, 1, 1 |
| LTF26DRU40_19 | 1, −1, 1, −1, −1, −1, 1, 1, 1, −1, −1, −1, −1, 1, −1, 1, −1, 1, −1, 1, 1, −1, −1, 1, −1, −1 |

TABLE 63
Exemplary Optimal DRU LTF Sequences
for 52DRU40 for Tone Plan 3

| Optimal Sequence | |
|---|---|
| Number | Optimal LTF Sequence (Tone Plan 3) |
| LTF52DRU40_1 | {LTF26DRU40_1, LTF26DRU40_12} |
| LTF52DRU40_2 | {LTF26DRU40_1, LTF26DRU40_13} |
| LTF52DRU40_3 | {LTF26DRU40_1, LTF26DRU40_14} |
| LTF52DRU40_4 | {LTF26DRU40_1, LTF26DRU40_15} |
| LTF52DRU40_5 | {LTF26DRU40_1, LTF26DRU40_16} |
| LTF52DRU40_6 | {LTF26DRU40_1, LTF26DRU40_17} |
| LTF52DRU40_7 | {LTF26DRU40_1, LTF26DRU40_18} |
| LTF52DRU40_8 | {LTF26DRU40_1, LTF26DRU40_19} |

TABLE 64
Exemplary Optimal DRU LTF Sequence
Mapping for 52DRU40 for Tone Plan 3

| | Optimal LTF Sequence (Tone |
|---|---|
| 52DRU40 | Plan 3) |
| 1 | LTF52DRU40_1 |
| 2 | LTF52DRU40_2 |
| 3 | LTF52DRU40_3 |
| 4 | LTF52DRU40_4 |
| 5 | LTF52DRU40_5 |
| 6 | LTF52DRU40_6 |
| 7 | LTF52DRU40_7 |
| 8 | LTF52DRU40_8 |

In an example, the optimal LTF sequences for 106DRU40 considering an exemplary tone plan 3 (see Table 59) is listed in Table 66 and the mapping of the optimal sequences to the two 106DRU40 is listed in Table 67.

In another example, the optimal LTF sequences for 106DRU40 may be constructed by combining sequences from Tables (Table 60, Table 62, and Table 65) as listed in Table 66.

TABLE 65
Exemplary Optimal DRU Component LTF Sequences for 106DRU40 for Tone Plan 3

| Optimal Sequence | |
|---|---|
| Number | Optimal LTF Sequence |
| LTF26DRU40_20 | 1, −1, 1, −1, −1, 1, −1, −1, 1, 1, −1, −1, 1, −1, 1, 1, −1, −1, −1, −1, −1, −1, 1, 1, 1, −1 |
| LTF26DRU40_21 | 1, −1, 1, 1, 1, −1, 1, −1, 1, 1, 1, 1, 1, −1, −1, 1, 1, −1, 1, 1, 1, −1, −1, −1, 1, 1 |
| LTF26DRU40_22 | 1, −1, 1, −1, −1, 1, 1, −1, 1, −1, 1, −1, −1, −1, −1, 1, −1, −1, 1, −1, 1, 1, −1, −1, −1, 1 |
| LTF26DRU40_23 | 1, 1, 1, −1, 1, 1, 1, −1, −1, 1, 1, −1, −1, −1, −1, 1, −1, 1, −1, 1, 1, 1, 1, −1, −1, 1 |
| LTF26DRU40_24 | −1, −1, 1, −1, 1, 1, 1, −1, −1, −1, 1, −1, −1, −1, −1, 1, 1, 1, 1, −1, 1, 1, −1, 1, −1, 1 |

TABLE 66
Exemplary Optimal DRU LTF Sequences for 106DRU40 for Tone Plan 3

| Optimal Sequence | |
|---|---|
| Number | Optimal LTF Sequence |
| LTF106DRU40_1 | {LTF26DRU40_1, LTF26DRU40_18, LTF26DRU40_20, LTF26DRU40_21}, {−1, 1} |
| LTF106DRU40_2 | {LTF26DRU40_1, LTF26DRU40_18, LTF26DRU40_20, LTF26DRU40_22}, {1, 1} |
| LTF106DRU40_3 | {LTF26DRU40_1, LTF26DRU40_18, LTF26DRU40_20, LTF26DRU40_23}, {−1, 1} |
| LTF106DRU40_4 | {LTF26DRU40_1, LTF26DRU40_18, LTF26DRU40_20, LTF26DRU40_24}, {1, 1} |

TABLE 67
Exemplary Optimal DRU LTF Sequence Mapping
for 106DRU40 for Tone Plan 3

| 106DRU40 | Tone Plan 3 |
|---|---|
| 1 | LTF106DRU40_1 |
| 2 | LTF106DRU40_2 |
| 3 | LTF106DRU40_3 |
| 4 | LTF106DRU40_4 |

TABLE 68
Tone Plan 4

| | | | | |
|---|---|---|---|---|
| 52- | DRU1 | DRU2 | DRU3 | DRU4 |
| tone | [−483:36:−51, | [−475:36:−43, | [−479:36:−47, | [−471:36:−39, |
| DRU | 17:36:449], | 25:36:457], | 21:36:453], | 29:36:461], |
| | [−467:36:−35, | [−459:36:−27, | [−463:36:−31, | [−455:36:−23, |
| | 33:36:465] | 41:36:473] | 37:36:469] | 45:36:477] |
| | DRU5 | DRU6 | DRU7 | DRU8 |
| | [−477:36:−45, | [−469:36:−37, | [−481:36:−49, | [−473:36:−41, |
| | 23:36:455], | 31:36:463], | 19:36:451], | 27:36:459], |
| | [−461:36:−29, | [−453:36:−21, | [−465:36:−33, | [−457:36:−25, |
| | 39:36:471] | 47:36:479] | 35:36:467] | 43:36:475] |
| | DRU9 | DRU10 | DRU11 | DRU12 |
| | [−482:36:−50, | [−474:36:−42, | [−478:36:−46, | [−470:36:−38, |
| | 18:36:450], | 26:36:458], | 22:36:454], | 30:36:462], |
| | [−466:36:−34, | [−458:36:−26, | [−462:36:−30, | [−454:36:−22, |
| | 34:36:466] | 42:36:474] | 38:36:470] | 46:36:478] |
| | DRU13 | DRU14 | DRU15 | DRU16 |
| | [−476:36:−44, | [−468:36:−36, | [−480:36:−48, | [−472:36:−40, |
| | 24:36:456], | 32:36:464], | 20:36:452], | 28:36:460], |
| | [−460:36:−28, | [−452:36:−20, | [−464:36:−32, | [−456:36:−24, |
| | 40:36:472] | 48:36:480] | 36:36:468] | 44:36:476] |
| 106- | DRU1 | DRU2 | DRU3 | DRU4 |
| tone | 52-tone | 52-tone | 52-tone | 52-tone |
| DRU | [DRU1~2], | [DRU3~4], | [DRU5~6], | [DRU7~8], |
| | [−495, 485] | [−491, 489] | [−489, 491] | [−493, 487] |
| | DRU5 | DRU6 | DRU7 | DRU8 |
| | 52-tone | 52-tone | 52-tone | 52-tone |
| | [DRU9~10], | [DRU11~12], | [DRU13~14], | [DRU15~16], |
| | [−494, 486] | [−490,490] | [−488,492] | [−492,488] |

TABLE 69
Exemplary Optimal DRU LTF Sequences for 26DRU80 (Tone Plan 4)

| Optimal Sequence | |
|---|---|
| Number | Optimal LTF Sequence |
| LTF26DRU80_1 | −1, −1, −1, 1, −1, 1, 1, 1, −1, 1, −1, −1, 1, −1, 1, −1, −1, −1, −1, 1, −1, −1, −1, −1, 1, 1 |
| LTF26DRU80_2 | −1, −1, 1, −1, −1, 1, −1, −1, 1, −1, −1, 1, 1, 1, −1, 1, 1, 1, −1, 1, −1, 1, −1, 1, 1, 1 |
| LTF26DRU80_3 | −1, 1, 1, −1, 1, 1, −1, −1, −1, −1, −1, −1, 1, 1, −1, −1, 1, −1, −1, 1, −1, 1, −1, −1, −1, 1 |
| LTF26DRU80_4 | −1, −1, 1, −1, 1, −1, −1, 1, 1, −1, −1, 1, 1, −1, 1, 1, −1, −1, 1, 1, 1, 1, 1, 1, −1, −1 |
| LTF26DRU80_5 | 1, −1, 1, 1, −1, −1, 1, −1, 1, 1, 1, −1, −1, 1, 1, −1, −1, 1, −1, −1, −1, −1, 1, −1, −1, −1 |
| LTF26DRU80_6 | 1, 1, −1, 1, 1, 1, −1, −1, 1, 1, −1, 1, 1, −1, 1, −1, −1, 1, 1, −1, −1, −1, 1, −1, 1, −1 |
| LTF26DRU80_7 | 1, −1, −1, −1, −1, 1, 1, 1, −1, 1, −1, −1, −1, 1, −1, −1, −1, 1, 1, −1, 1, 1, −1, 1, 1, −1 |
| LTF26DRU80_8 | 1, 1, −1, −1, −1, 1, 1, −1, −1, 1, 1, −1, 1, −1, −1, 1, 1, −1, 1, −1, 1, −1, 1, 1, 1, −1 |
| LTF26DRU80_9 | 1, 1, 1, −1, −1, 1, −1, 1, 1, 1, −1, 1, −1, 1, −1, −1, −1, 1, 1, −1, −1, 1, 1, −1, 1, 1 |
| LTF26DRU80_10 | 1, 1, 1, −1, 1, 1, 1, −1, −1, −1, 1, 1, 1, 1, 1, 1, 1, −1, −1, 1, −1, 1, −1, −1, 1, −1 |
| LTF26DRU80_11 | 1, −1, 1, 1, −1, 1, 1, 1, 1, −1, −1, 1, −1, 1, −1, −1, 1, 1, −1, −1, 1, −1, −1, 1, 1, −1 |
| LTF26DRU80_12 | 1, −1, 1, 1, −1, 1, 1, 1, −1, 1, 1, 1, −1, −1, −1, 1, 1, 1, −1, 1, 1, −1, −1, 1, 1, −1 |
| LTF26DRU80_13 | 1, −1, −1, 1, 1, −1, 1, 1, −1, 1, −1, −1, −1, −1, −1, −1, −1, 1, −1, −1, 1, 1, −1, −1, −1, 1 |
| LTF26DRU80_14 | 1, 1, −1, −1, −1, −1, 1, 1, 1, −1, 1, 1, 1, −1, 1, 1, 1, −1, 1, 1, −1, 1, 1, 1, 1, −1 |

In an example, the optimal LTF sequences for 52DRU80 considering an exemplary tone plan 4 (see Table 68) is listed in Table 70 and the mapping of the optimal sequences to the sixteen 52DRU80 is listed in Table 71.

TABLE 70
Exemplary Optimal DRU LTF Sequences
for 52DRU80 for Tone Plan 4

| Optimal Sequence | |
|---|---|
| Number | Optimal LTF Sequence (Tone Plan 4) |
| LTF52DRU80_1 | {LTF26DRU80_1, LTF26DRU80_2} |
| LTF52DRU80_2 | {LTF26DRU80_1, LTF26DRU80_3} |
| LTF52DRU80_3 | {LTF26DRU80_1, LTF26DRU80_4} |
| LTF52DRU80_4 | {LTF26DRU80_1, LTF26DRU80_5} |
| LTF52DRU80_5 | {LTF26DRU80_1, LTF26DRU80_6} |
| LTF52DRU80_6 | {LTF26DRU80_1, LTF26DRU80_7} |
| LTF52DRU80_7 | {LTF26DRU80_1, LTF26DRU80_8} |
| LTF52DRU80_8 | {LTF26DRU80_1, LTF26DRU80_9} |
| LTF52DRU80_9 | {LTF26DRU80_1, LTF26DRU80_10} |
| LTF52DRU80_10 | {LTF26DRU80_1, LTF26DRU80_11} |
| LTF52DRU80_11 | {LTF26DRU80_1, LTF26DRU80_12} |
| LTF52DRU80_12 | {LTF26DRU80_1, LTF26DRU80_13} |
| LTF52DRU80_13 | {LTF26DRU80_1, LTF26DRU80_14} |

TABLE 71
Exemplary Optimal DRU LTF Sequence
Mapping for 52DRU80 for Tone Plan 4

| 52DRU80 | Optimal LTF Sequence (Tone Plan 4) |
|---|---|
| 1 | LTF52DRU80_1 |
| 2 | LTF52DRU80_2 |
| 3 | LTF52DRU80_3 |
| 4 | LTF52DRU80_4 |
| 5 | LTF52DRU80_5 |
| 6 | LTF52DRU80_6 |
| 7 | LTF52DRU80_7 |
| 8 | LTF52DRU80_8 |
| 9 | LTF52DRU80_4 |
| 10 | LTF52DRU80_9 |
| 11 | LTF52DRU80_10 |
| 12 | LTF52DRU80_11 |
| 13 | LTF52DRU80_12 |
| 14 | LTF52DRU80_3 |
| 15 | LTF52DRU80_6 |
| 16 | LTF52DRU80_13 |

In an example, the optimal LTF sequences for 106DRU80 considering an exemplary tone plan 4 (see Table 68) is listed in Table 73 and the mapping of the optimal sequences to the eight 106DRU80 is listed in Table 74.

In another example, the optimal LTF sequences for 106DRU80 may be constructed by combining sequences from Tables (Table 69 and Table 72) as listed in Table 73.

TABLE 72
Exemplary Optimal DRU Component LTF Sequences for 106DRU80 for Tone Plan 4

| Optimal Sequence | |
|---|---|
| Number | Optimal LTF Sequence |
| LTF26DRU80_15 | 1, −1, −1, 1, 1, −1, 1, 1, 1, −1, 1, −1, 1, 1, 1, 1, 1, 1, 1, −1, −1, −1, 1, 1, 1, −1 |
| LTF26DRU80_16 | 1, 1, −1, 1, 1, 1, 1, −1, 1, −1, −1, 1, −1, −1, −1, −1, 1, 1, 1, −1, 1, 1, −1, −1, 1, −1 |
| LTF26DRU80_17 | 1, −1, −1, −1, 1, −1, 1, −1, −1, −1, −1, 1, −1, 1, 1, 1, 1, 1, 1, −1, −1, 1, −1, 1, −1, −1 |
| LTF26DRU80_18 | −1, −1, −1, 1, −1, −1, −1, 1, 1, −1, −1, 1, −1, −1, −1, −1, −1, −1, 1, 1, 1, 1, −1, 1, 1, −1 |
| LTF26DRU80_19 | 1, −1, −1, −1, 1, −1, 1, −1, −1, −1, 1, −1, −1, −1, −1, −1, 1, 1, 1, 1, −1, 1, 1, −1, −1, −1 |
| LTF26DRU80_20 | 1, −1, −1, −1, 1, −1, −1, 1, −1, −1, 1, 1, 1, −1, −1, 1, −1, 1, 1, 1, 1, 1, 1, −1, −1, 1 |
| LTF26DRU80_21 | 1, 1, −1, −1, −1, −1, 1, −1, −1, −1, −1, −1, 1, −1, 1, −1, 1, −1, 1, 1, 1, 1, −1, 1, 1, 1 |
| LTF26DRU80_22 | −1, 1, 1, −1, 1, −1, −1, −1, 1, 1, −1, 1, 1, −1, 1, −1, −1, 1, 1, 1, −1, 1, −1, 1, 1, 1 |
| LTF26DRU80_23 | 1, −1, −1, −1, 1, 1, 1, −1, −1, −1, 1, −1, −1, −1, −1, 1, 1, 1, 1, −1, 1, 1, 1, 1, −1, 1 |

TABLE 73
Exemplary Optimal DRU LTF Sequences for 106DRU80 for Tone Plan 4

| Optimal Sequence | |
|---|---|
| Number | Optimal LTF Sequence |
| LTF106DRU80_1 | {LTF26DRU80_1, LTF26DRU80_3, LTF26DRU80_15, LTF26DRU80_16}, {1, 1} |
| LTF106DRU80_2 | {LTF26DRU80_1, LTF26DRU80_3, LTF26DRU80_15, LTF26DRU80_17}, {1, 1} |
| LTF106DRU80_3 | {LTF26DRU80_1, LTF26DRU80_3, LTF26DRU80_15, LTF26DRU80_18}, {1, 1} |
| LTF106DRU80_4 | {LTF26DRU80_1, LTF26DRU80_3, LTF26DRU80_15, LTF26DRU80_19}, {−1, 1} |
| LTF106DRU80_5 | {LTF26DRU80_1, LTF26DRU80_3, LTF26DRU80_15, LTF26DRU80_20}, {1, 1} |
| LTF106DRU80_6 | {LTF26DRU80_1, LTF26DRU80_3, LTF26DRU80_15, LTF26DRU80_21}, {1, 1} |
| LTF106DRU80_7 | {LTF26DRU80_1, LTF26DRU80_3, LTF26DRU80_15, LTF26DRU80_22}, {−1, 1} |
| LTF106DRU80_8 | {LTF26DRU80_1, LTF26DRU80_3, LTF26DRU80_15, LTF26DRU80_23}, {1, 1} |

TABLE 74
Exemplary Optimal DRU LTF Sequence Mapping
for 106DRU80 for Tone Plan 4

| 106DRU80 | Tone Plan 4 |
|---|---|
| 1 | LTF106DRU80_1 |
| 2 | LTF106DRU80_2 |
| 3 | LTF106DRU80_3 |
| 4 | LTF106DRU80_4 |
| 5 | LTF106DRU80_5 |
| 6 | LTF106DRU80_6 |
| 7 | LTF106DRU80_7 |
| 8 | LTF106DRU80_8 |

TABLE 75
Tone Plan 5

| 52-tone | DRU1 | DRU2 | DRU3 | DRU4 |
|---|---|---|---|---|
| DRU | [−495:56:−271, | [−487:56:−263, | [−491:56:−267, | [−483:56:−259, |
| | −479:56:−255, | −471:56:−247, | −475:56:−251, | −467:56:−243, |
| | −455:56:−287, | −447:56:−279, | −451:56:−283, | −443:56:−275, |
| | −239:56:−71, | −231:56:−63, | −235:56:−67, | −227:56:−59, |
| | −215:56:−47, | −207:56:−39, | −211:56:−43, | −203:56:−35, |
| | −199:56:−31, | −191:56:−23, | −195:56:−27, | −187:56:−19, |
| | 17:56:241, | 25:56:249, | 21:56:245, | 29:56:253, |
| | 33:56:257, | 41:56:265, | 37:56:261, | 45:56:269, |
| | 57:56:225, | 65:56:233, | 61:56:229, | 69:56:237, |
| | 273:56:441, | 281:56:449, | 277:56:445, | 285:56:453, |
| | 297:56:465, | 305:56:473, | 301:56:469, | 309:56:477, |
| | 313:56:481] | 321:56:489] | 317:56:485] | 325:56:493] |
| | DRU5 | DRU6 | DRU7 | DRU8 |
| | [−489:56:−265, | [−481:56:−257, | [−493:56:−269, | [−485:56:−261, |
| | −473:56:−249, | −465:56:−241, | −477:56:−253, | −469:56:−245, |
| | −449:56:−281, | −441:56:−273, | −453:56:−285, | −445:56:−277, |
| | −233:56:−65, | −225:56:−57, | −237:56:−69, | −229:56:−61, |
| | −209:56:−41, | −201:56:−33, | −213:56:−45, | −205:56:−37, |
| | −193:56:−25, | −185:56:−17, | −197:56:−29, | −189:56:−21, |
| | 23:56:247, | 31:56:255, | 19:56:243, | 27:56:251, |
| | 39:56:263, | 47:56:271, | 35:56:259, | 43:56:267, |
| | 63:56:231, | 71:56:239, | 59:56:227, | 67:56:235, |
| | 279:56:447, | 287:56:455, | 275:56:443, | 283:56:451, |
| | 303:56:471, | 311:56:479 | 299:56:467, | 307:56:475, |
| | 319:56:487] | 327:56:495] | 315:56:483] | 323:56:491] |
| | DRU9 | DRU10 | DRU11 | DRU12 |
| | [−494:56:−270, | [−486:56:−262, | [−490:56:−266, | [−482:56:−258, |
| | −478:56:−254, | −470:56:−246, | −474:56:−250, | −466:56:−242, |
| | −454:56:−286, | −446:56:−278, | −450:56:−282, | −442:56:−274, |
| | −238:56:−70, | −230:56:− 62, | −234:56:−66, | −226:56:−58, |
| | −214:56:−46, | −206:56:−38, | −210:56:−42, | −202:56:−34, |
| | −198:56:−30, | −190:56:−22, | −194:56:−26, | −186:56:−18, |
| | 18:56:242, | 26:56:250, | 22:56:246, | 30:56:254, |
| | 34:56:258, | 42:56:266, | 38:56:262, | 46:56:270, |
| | 58:56:226, | 66:56:234, | 62:56:230, | 70:56:238, |
| | 274:56:442, | 282:56:450, | 278:56:446, | 286:56:454, |
| | 298:56:466, | 306:56:474, | 302:56:470, | 310:56:478, |
| | 314:56:482] | 322:56:490] | 318:56:486] | 326:56:494] |
| | DRU13 | DRU14 | DRU15 | DRU16 |
| | [−488:56:−264, | [−480:56:−256, | [−492:56:−268, | [−484:56:−260, |
| | −472:56:−248, | −464:56:−240, | −476:56:−252, | −468:56:−244, |
| | −448:56:−280, | −440:56:−272, | −452:56:−284, | −444:56:−276, |
| | −232:56:−64, | −224:56:−56, | −236:56:−68, | −228:56:−60, |
| | −208:56:−40, | −200:56:−32, | −212:56:−44, | −204:56:−36, |
| | −192:56:−24, | −184:56:−16, | −196:56:−28, | −188:56:−20, |
| | 24:56:248, | 32:56:256, | 20:56:244, | 28:56:252, |
| | 40:56:264, | 48:56:272, | 36:56:260, | 44:56:268, |
| | 64:56:232, | 72:56:240, | 60:56:228, | 68:56:236, |
| | 280:56:448, | 288:56:456, | 276:56:444, | 284:56:452, |
| | 304:56:472, | 312:56:480, | 300:56:468, | 308:56:476, |
| | 320:56:488] | 328:56:496] | 316:56:484] | 324:56:492] |
| 106-tone | DRU1 | DRU2 | DRU3 | DRU4 |
| DRU | [52-tone DRU1, 52- | [52-tone DRU3, 52- | [52-tone DRU5, 52- | [52-tone DRU7, 52- |
| | tone DRU2, −463, | tone DRU4, −459, | tone DRU6, −457, | tone DRU8, −461, |
| | 457] | 461] | 463] | 459] |
| | DRU5 | DRU6 | DRU7 | DRU8 |
| | [52-tone DRU9, 52- | [52-tone DRU11, 52- | [52-tone DRU13, 52- | [52-tone DRU15, 52- |
| | tone DRU10, −462, | tone DRU12, −458, | tone DRU14, −456, | tone DRU16, −460, |
| | 458] | 462] | 464] | 460] |

TABLE 76
Exemplary Optimal DRU LTF Sequences for 26DRU80 (Tone Plan 5)

| Optimal Sequence | |
|---|---|
| Number | Optimal LTF Sequence |
| LTF26DRU80_1 | −1, −1, −1, −1, −1, 1, 1, −1, −1, −1, 1, −1, −1, 1, 1, 1, −1, 1, 1, −1, 1, −1, −1, −1, 1, −1 |
| LTF26DRU80_2 | −1, 1, −1, 1, −1, −1, −1, 1, −1, 1, −1, −1, −1, −1, 1, −1, −1, −1, −1, 1, −1, −1, 1, 1, 1, 1 |
| LTF26DRU80_3 | 1, 1, 1, 1, −1, 1, 1, 1, −1, −1, −1, 1, −1, 1, −1, 1, 1, −1, 1, −1, −1, −1, 1, 1, 1, −1 |
| LTF26DRU80_4 | −1, 1, 1, 1, 1, −1, −1, −1, 1, −1, −1, −1, −1, −1, 1, −1, 1, −1, 1, −1, −1, −1, −1, 1, 1, −1 |
| LTF26DRU80_5 | 1, −1, −1, −1, −1, 1, −1, 1, −1, −1, −1, 1, −1, 1, −1, −1, −1, 1, −1, −1, 1, 1, 1, 1, 1, −1 |
| LTF26DRU80_6 | 1, 1, −1, −1, −1, −1, 1, −1, −1, 1, −1, 1, 1, −1, −1, −1, 1, −1, 1, −1, −1, −1, 1, −1, 1, −1 |
| LTF26DRU80_7 | 1, 1, −1, 1, −1, 1, 1, 1, −1, −1, −1, −1, −1, 1, −1, −1, 1, −1, 1, −1, −1, −1, 1, 1, 1, −1 |
| LTF26DRU80_8 | −1, 1, 1, −1, 1, −1, 1, −1, 1, −1, −1, −1, 1, 1, 1, 1, −1, −1, 1, 1, −1, 1, −1, −1, 1, 1 |
| LTF26DRU80_9 | −1, −1, −1, −1, 1, 1, 1, −1, 1, −1, 1, 1, 1, −1, 1, −1, 1, −1, −1, 1, 1, 1, 1, 1, 1, 1 |
| LTF26DRU80_10 | 1, 1, −1, 1, −1, 1, −1, −1, 1, 1, −1, −1, −1, −1, 1, 1, 1, −1, −1, −1, −1, −1, −1, −1, −1, 1 |
| LTF26DRU80_11 | −1, −1, 1, −1, −1, 1, −1, 1, 1, −1, −1, 1, 1, 1, −1, 1, −1, −1, −1, 1, 1, 1, 1, 1, 1, 1 |
| LTF26DRU80_12 | −1, −1, −1, 1, −1, −1, −1, −1, 1, −1, 1, −1, −1, 1, 1, −1, 1, −1, 1, 1, −1, −1, −1, 1, −1, 1 |
| LTF26DRU80_13 | 1, −1, −1, 1, 1, 1, 1, −1, −1, 1, −1, 1, −1, 1, −1, −1, 1, 1, −1, 1, −1, 1, −1, −1, −1, −1 |

In an example, the optimal LTF sequences for 52DRU80 considering an exemplary tone plan 5 (see Table 75) is listed in Table 77 and the mapping of the optimal sequences to the sixteen 52DRU80 is listed in Table 78.

TABLE 77
Exemplary Optimal DRU LTF Sequences
for 52DRU80 for Tone Plan 5

| Optimal Sequence | |
|---|---|
| Number | Optimal LTF Sequence (Tone Plan 5) |
| LTF52DRU80_1 | {LTF26DRU80_1, LTF26DRU80_2} |
| LTF52DRU80_2 | {LTF26DRU80_1, LTF26DRU80_3} |
| LTF52DRU80_3 | {LTF26DRU80_1, LTF26DRU80_4} |
| LTF52DRU80_4 | {LTF26DRU80_1, LTF26DRU80_5} |
| LTF52DRU80_5 | {LTF26DRU80_1, LTF26DRU80_6} |
| LTF52DRU80_6 | {LTF26DRU80_1, LTF26DRU80_7} |
| LTF52DRU80_7 | {LTF26DRU80_1, LTF26DRU80_8} |
| LTF52DRU80_8 | {LTF26DRU80_1, LTF26DRU80_9} |
| LTF52DRU80_9 | {LTF26DRU80_1, LTF26DRU80_10} |
| LTF52DRU80_10 | {LTF26DRU80_1, LTF26DRU80_11} |
| LTF52DRU80_11 | {LTF26DRU80_1, LTF26DRU80_12} |
| LTF52DRU80_12 | {LTF26DRU80_1, LTF26DRU80_13} |

TABLE 78
Exemplary Optimal DRU LTF Sequence
Mapping for 52DRU80 for Tone Plan 5

| 52DRU80 | Optimal LTF Sequence (Tone Plan 5) |
|---|---|
| 1 | LTF52DRU80_1 |
| 2 | LTF52DRU80_2 |
| 3 | LTF52DRU80_3 |
| 4 | LTF52DRU80_4 |
| 5 | LTF52DRU80_5 |
| 6 | LTF52DRU80_6 |
| 7 | LTF52DRU80_7 |
| 8 | LTF52DRU80_8 |
| 9 | LTF52DRU80_4 |
| 10 | LTF52DRU80_9 |
| 11 | LTF52DRU80_10 |
| 12 | LTF52DRU80_7 |
| 13 | LTF52DRU80_11 |
| 14 | LTF52DRU80_12 |
| 15 | LTF52DRU80_6 |
| 16 | LTF52DRU80_1 |

In an example, the optimal LTF sequences for 106DRU80 considering an exemplary tone plan 5 (see Table 75) is listed in Table 80 and the mapping of the optimal sequences to the eight 106DRU80 is listed in Table 81.

In another example, the optimal LTF sequences for 106DRU80 may be constructed by combining sequences from Tables (Table 76 and Table 79) as listed in Table 80.

TABLE 79
Exemplary Optimal DRU Component LTF Sequences for 106DRU80 for Tone Plan 5

| Optimal Sequence | |
|---|---|
| Number | Optimal LTF Sequence |
| LTF26DRU80_14 | 1, −1, 1, 1, −1, −1, −1, 1, −1, 1, 1, −1, −1, 1, 1, −1, −1, 1, −1, 1, −1, −1, 1, −1, −1, −1 |
| LTF26DRU80_15 | −1, −1, 1, 1, 1, 1, −1, 1, 1, 1, −1, 1, −1, 1, 1, −1, 1, 1, −1, −1, 1, 1, 1, 1, 1, 1 |
| LTF26DRU80_16 | −1, −1, 1, 1, 1, 1, 1, 1, −1, 1, 1, 1, 1, 1, −1, −1, 1, 1, −1, −1, 1, −1, 1, 1, −1, −1 |
| LTF26DRU80_17 | −1, −1, −1, 1, 1, −1, −1, 1, −1, −1, 1, −1, 1, 1, −1, −1, 1, 1, −1, 1, −1, −1, 1, 1, −1, 1 |
| LTF26DRU80_18 | −1, 1, 1, 1, 1, −1, −1, 1, −1, −1, 1, −1, 1, 1, −1, −1, 1, 1, −1, 1, −1, −1, 1, −1, −1, 1 |
| LTF26DRU80_19 | −1, −1, 1, 1, −1, 1, −1, 1, 1, −1, −1, −1, −1, −1, −1, −1, 1, 1, −1, −1, −1, −1, 1, 1, 1, 1 |
| LTF26DRU80_20 | −1, −1, −1, 1, −1, 1, −1, 1, −1, −1, −1, 1, 1, 1, −1, −1, 1, 1, 1, 1, −1, 1, 1, 1, −1, 1 |
| LTF26DRU80_21 | −1, −1, 1, 1, 1, 1, −1, 1, 1, 1, −1, 1, −1, 1, 1, −1, 1, 1, −1, 1, 1, 1, 1, 1, −1, 1 |
| LTF26DRU80_22 | −1, −1, −1, 1, −1, −1, −1, 1, −1, 1, 1, −1, 1, −1, −1, −1, −1, −1, 1, 1, 1, −1, 1, 1, −1, 1 |

TABLE 80
Exemplary Optimal DRU LTF Sequences
for 106DRU80 for Tone Plan 5

| Optimal Sequence | |
|---|---|
| Number | Optimal LTF Sequence |
| LTF106DRU80_1 | {LTF26DRU80_14, LTF26DRU80_15}, {1, −1} |
| LTF106DRU80_2 | {LTF26DRU80_14, LTF26DRU80_16}, {1, −1} |
| LTF106DRU80_3 | {LTF26DRU80_14, LTF26DRU80_17}, {1, −1} |
| LTF106DRU80_4 | {LTF26DRU80_14, LTF26DRU80_18}, {−1, −1} |
| LTF106DRU80_5 | {LTF26DRU80_14, LTF26DRU80_19}, {−1, 1} |
| LTF106DRU80_6 | {LTF26DRU80_14, LTF26DRU80_20}, {−1, −1} |
| LTF106DRU80_7 | {LTF26DRU80_14, LTF26DRU80_21}, {1, −1} |
| LTF106DRU80_8 | {LTF26DRU80_14, LTF26DRU80_22}, {1, 1} |

TABLE 81
Exemplary Optimal DRU LTF Sequence Mapping
for 106DRU80 for Tone Plan 5

| 106DRU80 | Tone Plan 5 |
|---|---|
| 1 | LTF106DRU80_1 |
| 2 | LTF106DRU80_2 |
| 3 | LTF106DRU80_3 |
| 4 | LTF106DRU80_4 |
| 5 | LTF106DRU80_5 |
| 6 | LTF106DRU80_6 |
| 7 | LTF106DRU80_7 |
| 8 | LTF106DRU80_8 |

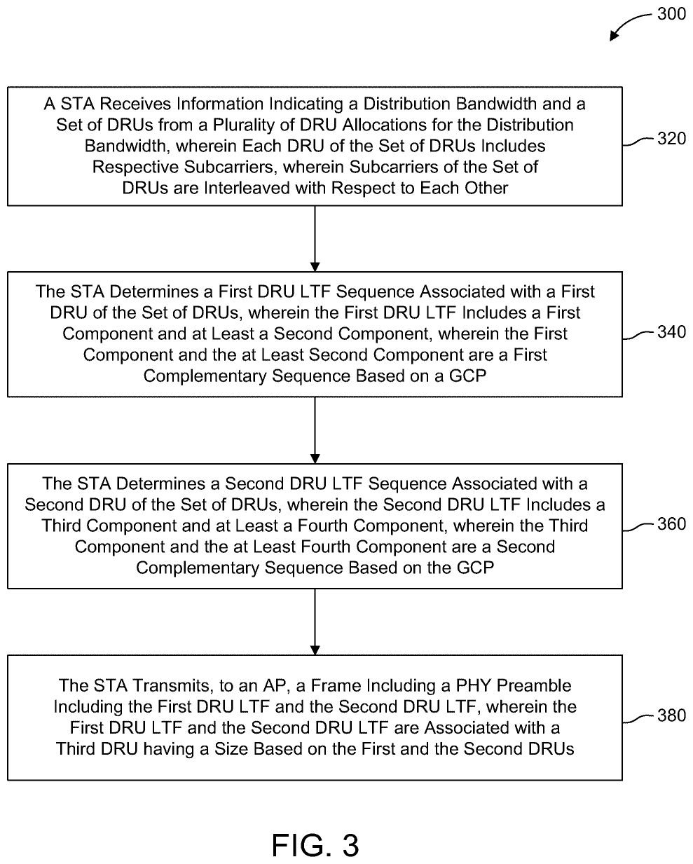

FIG. 3 is a flowchart diagram illustrating an example of a determination and transmission of a DRU LTF sequence using CSs. In an example in flowchart diagram 300, a STA receives information indicating a distribution bandwidth and a set of DRUs from a plurality of DRU allocations for the distribution bandwidth 320. Further, each DRU of the set of DRUs includes respective subcarriers. Also, subcarriers of the set of DRUs are interleaved with respect to each other. Additionally or alternatively, the STA is a non-AP STA. Additionally or alternatively, an AP transmits, to the STA, the information indicating the distribution bandwidth and the set of DRUs from the plurality of DRU allocations for the distribution bandwidth.

The STA determines a first DRU long training field (LTF) sequence associated with a first DRU of the set of DRUs 340. In addition, the first DRU LTF sequence includes a first component and at least a second component. Moreover, the first component and the at least second component are a first complementary sequence based on a GCP. Further, the STA determines a second DRU LTF sequence associated with a second DRU of the set of DRUs 360. Also, the second DRU LTF sequence includes a third component and at least a fourth component. Additionally, the third component and the at least fourth component are a second complementary sequence based on the GCP.

Moreover, the STA transmits, to an AP, a frame including a physical layer (PHY) preamble including the first DRU LTF sequence and the second DRU LTF sequence 380. Further, the first DRU LTF sequence and the second DRU LTF sequence are associated with a third DRU having a size based on the first and the second DRUs.

Additionally or alternatively, the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}). Further, the second complementary sequence based on the GCP comprises a seed GCP including complimentary seed sequences (sₐ, s_{b}). Also, each of the complimentary seed sequences is respectively multiplied by a second complex number (w_{a,2}) and a third complex number (w_{b,2}). Moreover, the first and the second complementary sequences are a complementary pair.

Additionally or alternatively, sₐ=(1, 1, 1, 1i, −1, 1, 1, −1i, 1, −1, 1,−1i,1i) and s_{b}=(1 1i−1−1−11i−1 11−1i−1 1−1i). Additionally or alternatively, the distribution bandwidth is 20 Mhz. Additionally or alternatively, the distribution bandwidth is 40 Mhz. Additionally or alternatively, the distribution bandwidth is 80 Mhz.

Additionally or alternatively, the first DRU is a 26-tone DRU. Additionally or alternatively, the second DRU is a 26-tone DRU. Additionally or alternatively, the third DRU is a 52-tone DRU.

Additionally or alternatively, the first DRU is a 52-tone DRU. Additionally or alternatively, the second DRU is a 52-tone DRU. Additionally or alternatively, the third DRU is a 106-tone DRU.

Further, the AP transmits, to the STA, the information indicating the distribution bandwidth and the set of DRUs from the plurality of DRU allocations for the distribution bandwidth. Also, the AP receives the frame including a physical layer (PHY) preamble including the first DRU LTF sequence and the second DRU LTF sequence. Additionally or alternatively, the AP further transmits to the STA based on receipt of the frame, including the first DRU LTF sequence and the second DRU LTF sequence.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1 , 1 , 1, −1, −1, −1, −1, 1, 1, −1, −1, 1, −1, 1, −1, 1, −1,−1, 1, −1, 1, 1, 1, 1, 1; −1−1−1, 1, 1, 11, 1,−1, −1, 1, −1, −1, 1,−1, −1, −1, 1, 1, −1, 1, −1, 1, 1, −1, 1; 1, 1, 1−, 1−, 1, 1−1, 1−1, 1, 1, 1, 1−1−11, 1, 1−1, −1, 1, −1, 1, −1, 1, 1, 1, −1, −1, 1, 1, 1, −1, −1, −1,−1, −1,−1; −1 1−, 11−111−11−1−1−1−1, −1, 1, −1, −1,−1, 1, −1, 1, −1, −1, 1,−1, 1, −1, −1, 1, −1, 1, 1, 1, 1; −1 1−, 1, 1−1 1−1−1 11−; and −1, −1, −1, 1, 1, 1, −1, 1, 1, 1, 1, 1, −1, −1, 1, 1, −1, 1, 1, −1, 1, −1, 1, 1, −1, 1. The determined DRU allocation includes 26 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: 1, 1, −1, 1, −1, 1, 1, −1, 1, −1, −1,−1, 1, −1, 1, −1, −1,−1, 1, −1, −1, −1, 1, 1, 1, −1; 11, 1−1,−1, 1, −1, 1, 1, 1, −1, 1, 1, 1, 1, −1, 1, 1, 1, 1, 1,1; −1 1−1, 1, 1, 1, 1−1, 1−11−, 1−1−, 1, 1, 1−, 1 1−1; and −1, 1−1, 1, 1, 1, −1, 1, −1, 1, 1, 1, 1, 1, 1, 1−1−1, 1, 1, 1, −1. The determined DRU allocation includes 52 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: 1, 1, 1, 1, 1, −1, 1,−1, 1, −1, 1, 1, −1, −1, −1,−1, 1, −1, 1, 1, −1, 1, −1, −1, −1,−1; −1, 1−1−1, −1,−1, 1, 1, 1, −1, 1, −1, 1, 1, −1, −1, −1,−1, 1, −1, −1, 1, −1,−1, 1, 1; and 1, −1,−1, 1, 1, 1, 1, −1,−1, 1, 1, −1,−1, 1, −1, −1, −1, 1, −1, −1, 1, 1, 1, 1, −1, −1. The determined DRU allocation includes 106 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1, −1, 1, 1, 1, 1, 1, −1, −1, 1, −1,−1, 1, −1, −1, −1, 1, 1, −1, 1, −1, 1, 1, −1, 1; −1−1−1−1, −1,−1, and −1−1, 1, 1, 1−1−1, 1, 1, 1, −1, 1, −1, 1, −1,−1, 1, 1, −1, 1, 1, −11−1, −, 1, 1, 1, 1, −1, 1, 1, 1, 1, 1, −1, −1, 1, 1, −1, 1, 1, −1, 1, −1, 1, 1, −1, 1, −1 1−, 1 1−, 1, 1, 1, 1, 1, 1, 1−1 1, 1, 1−, 1, 1, 1, 1−; −1, −1,−1 and 1, −1, 1, 1, 1, −1, −1, 1, 1, −1, −1, 1, −1, 1, −1, −1,−1, 1, −1, 1, 1−1, 1, −1, 1 1.

The determined DRU allocation includes 26 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1, −1, −1,−1, −1,−1, 1, −1, −1, −1,−1, −1, 1, −1, −1, 1,−1, 1, −1, 1, 1, 1, −1, 1, −1; −1, −1, −1,−1, 1, 1, −,−, −1, −1, 1, 1, 1, 1, −1, 1, 1, 1, 1, 1, 1, −1, 1−1, 1, 1, 1, 1, 1,1; 1, 1, −1, 1−1, 1, 1−1, 1, −1, 1, 1, 1, 1, −1, 11, 1, −1, 11, −1, 1; and 1, −1, 1,−1, −1, 1, 1, 1, 1−1, 1, 1−1, 1, −1, −1, −1,−1, −1, −1, 1−1.

The determined DRU allocation includes 52 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 20 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1, −1, 1, 1, −1, −1, −1, 1, 1, −1, −1, −1, 1,−1, −1, 1, −1, 1, 1, 1, −1, −1, −1, 1, 1; −1, 1−1, 1, 1−1,−1, 1, 1, −1, 1, −1, 1, −1, 1, 1, −1, −1, −1,−1, 1, −1, −1, −1, 1, 1; 1−1, 1 1−, 1 1−1 1, 1, 1, 1−1 ; and −1, 1, 1, −1, 1, −1, 1, −1, 1, 1, 1, 1, 1, −1, 1, 1, −1, 1, 1, 1, 1, −1, −1, −1. The determined DRU allocation includes 106 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 40 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1, −1, −1,−1, −1, 1, −1, −1, 1,−1, 1, 1, −1, −1, −1, 1, 1, 1, −1, 1, 1, −1, −1, −1, 1; −1−1, 1−1−1, 1,−1, −1, 1, 1, 1, 1, 1, 1, −1, 1, −1, 1, 1, 1, −1, −1, 1, 1, 1, −1; −1, 1, 1−1, 1−1−, 1, 1−1, 1−1, 1, 1, 1, 1, 1−1, 11−; −1, 1, 1−, 1, 1, −1, −1, −1, 1,−1, 1, −1, −1, 1, −1, 1, −1, −1, 1,−1, 1, 1, 1, 1; −1, 1, 11, 1, 1, 1, 1 1, 1, 1−1 1−, 1 1−, 1 11−; −1, −1,−1, −1, 1, −1, −1,−1, 1, 1, 1, 1, −1, −1, −1, 1, 1, 1, −1, 1, 1, −1, −1, 1, −1, 1; −1−1, 1, 1, 1, 1−1−1−, 1, 1, 1−1, 1, 1; −1,−1, −1, −1, 1, −1, 1, 1, −1, 1, −1, 1, 1, −1, 1, −1, 1, 1, 1, −1, 1, 1, −1, −1, 1, 1; −1−1, 1, 1, 1, 11−, 1, 1−1, 1−, 1, 1−1, 1−1−1, 1, 1, 1 1, 1, 1. The determined DRU allocation includes 26 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 40 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: 1, −1, 1, −1, −1, 1, 1, 1, −1, 1, −1, 1, −1, 1, −1, −1, −1, 1,−1, −1, 1,−1, 1, 1, 1, −1; 1−1−1−1−1, 1, 1,−1, 1, −1, 1, −1, 1, −1, 1, −1, −1, −1, 1, −1, −1, −1,−1, 1, 1, 1; −1, 1, 1, 1, 1, 1, 1, 1−1−, 11−1, 1, 1, 11−1, 1, 1, 1−; 1−, 1−, and 1, −1, 1, −1, −1,−1, 1, 1, 1, −1, −1, −1,−1, 1, −1, 1, −1, 1, −1, 1, 1, −1, −1, 1, −1,−1. The determined DRU allocation includes 52 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 40 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: 1, −1, 1, 1, 1, −1, 1,−1, −1, 1, 1, −1, −1, −1,−1, 1, −1, 1, −1, 1, 1, −1, −1, −1, 1; and −1, −1, 1, −1, 1, 1, 1, −1, −1, −1, 1,−1, −1, −1, −1, 1, 1, 1, 1, −1, 1, 1, −1, 1, −1, 1. The determined DRU allocation includes 106 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 80 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: −1, −1, −1, 1, −1, 1, 1, 1, −1, 1, −1, −1, 1,−1, 1, −1, −1, −1,−1, 1, −1, −1, −1,−1, 1, 1; −1, −1, 1, −1, −1, 1,−1,−1, 1, −1, −1, 1, 1, 1, −1, 1, 1, 1, −1, 1, −1, 1, −1, 1, 1, 1; −1 11−1, 1, 1, 1−, 1−, 1−1, 1, 1, 1−1−11−, 1; −1, 1, 1−, 1, −1, 1, 1, −1, −1, 1, 1, −1, 1, 1, −1, −1, 1, 1, 1, 1, 1, 1, −1,−1; 1, 1, 1, 1−, 11−1, 1, 1, 1−1, 1, 1, 1−1−, 1−1−, 11, 1, 1; and 1, 1, −1, 1, 1, −1, 1, 1, 1, 1, 1, −1, 1, 1, 1, −1, 1, 1, −1, 1, −1, 1, 1, −1. The determined DRU allocation includes 26 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 80 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of: 1, −1,−1, 1, 1, −1, 1, 1, 1, −1, 1, −1, 1, 1, 1, 1, 1, 1, 1, −1, −1, −1, 1, 1, 1, −1; 1, 1, −1, 1, 1, 1, 1, −1, 1, −1,−1, 1, −1, −1, −1,−1, 1, 1, 1, −1, 1, 1, −1, −1, 1, −1; 1, 1−, 11−1−, 1−1, 1, 1, 1, 1, 1,1−, 11−1−; −1, 1−, 1, 1, 1, −1,−1, 1, −1, −1, −1,−1, −1,−1, 1, 1, 1, 1, −1, 1, 1, −1; 1−, 1−1 1−, 1−1, 1−, 1, 1, 1, 1, 1−1, 1, 1, 1−, 1, 1−, 1, 1, −1,−1, 1, −1,−1, 1, 1, 1, −1,−1, 1, −1, 1, 1, 1, 1, 1, 1, −1, −1, 1; 11−, 1−, 1, 1−1, 1−, 1−11−1 11, 1, 1−1, 1, 1; −1, 1, 1, The determined DRU allocation includes 106 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 80 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of:−1, −1, −1, −1,−1, 1, 1, −1, −1, −1, 1,−1, −1, 1, 1, 1, −1, 1, 1, −1, 1, −1, −1,−1, 1, −1; −1, 1−1, 1−1−1,−1, 1, −1, 1, −1, −1,−1, −1, 1, −1, −1,−1, −1, 1, −1, −1, 1, 1, 1, 1; 1−1, 1, 1, 1, 11−1, 1, 1, 1−1, 1, 1, 1, 1−, 1−1−; −1, 1, 1, 1, 1, −1, −1, 1, −1,−1, −1, −1, −1, 1,−1, 1, −1, 1, −1, −1,−1, −1, 1, 1, −1; 1, 1−, 1−11−, 1−11−, 1−1−1, 1, 1, 1, 11, 1, −1, −1, 1−1, 1, −1, −1, 1, −1,−, 1, −1, −1, −1, 1,−1, 1, −1, −1, −1,−1, −1, −1, −1,−; −1, 1, 1−1−1, −11,−1−11, 1 1, −, 1−1, 1, 1, 1, 1, 1, 1, 1, 1, 1; −1, −1, −1, 1, −1,−1, −1, −1, 1, −1, 1, −1, −1, 1, 1, −1, 1, −1, 1, 1, −1, −1, −1, 1,−1, 1; and 1, −1, −1, 1, 1, 1, 1, −1, −1, 1, −1, 1, −1, 1, −1,−1, 1, 1, −1, 1,−11−1, −1−1−1. The determined DRU allocation includes 26 subcarriers.

According to one example, a method or apparatus for use in a non-AP STA (or AP STA) includes determining a DRU allocation from a plurality of DRU allocations, where each of the plurality of DRU allocations includes respective subcarriers where subcarriers of the determined DRU allocation are interleaved with subcarriers of one or more other DRU allocations of the plurality of DRU allocations, across a distribution bandwidth of 80 Mhz. The method further includes transmitting a frame, to an AP (or a non-AP STA), using the determined DRU allocation, where the frame includes a PHY preamble including a DRU LTF sequence, such that the DRU LTF includes an LTF sequence selected from the group consisting of:1, −1, 1, 1, −1, −1, −1, 1,−1, 1, 1, −1, −1, 1, 1, −1, −1, 1, −1, 1, −1, −1, 1,−1, −1,−1; −1, −1, 1, 1, 1, 1,−1, 1, 1, 1, −1, 1, −1, 1, 1, −1, 1, 1, −1, −1, 1, 1, 1, 1, 1,1; −1, 1, 1, 1, 1, 1,1−1, 1, 1, 1, 1−1, 1, 1, 1−1, 1, 1−, 1, 1−1, 1, 1, 1−, 1, 1, −1, −1, 1, −1, 1, 1, −1, −1, 1, 1, −1, 1, −1, −1, 1, 1, −1, 1; −1 11, 1, 1−, 1 1−, 11−1, 1, 1, 1−1, 1, 1, 1, 1−1, 11−, 11−1−1, 1, 1, 1, 1, −1, 1, 1, −1, −1, −1,−1, −1, −1, −1, 1, 1, −1, −1, −1,−1, 1, 1, 1, 1; −1, 11−11−, 1−1, 1, 1, 1−1, 1, 1, 1, 11, 1, 1; −1,−1, 1, 1, 1, 1, 1, −1, 1, 1, 1, −1, 1, 1−1, 1, 1, 1, 1−1, 1, 1, 1, 1−1, 1, 1, 1, 1, 1,1−1, 1; and −1, −1−1, −1, −1, 1, 1−1, −1, −1, −1, 1, 1, 1, 1−1, −1, −1, 1. The determined DRU allocation includes 106 subcarriers.

According to an example, a method or apparatus for use in a non-AP STA (or AP STA) includes (1) determining a distribution bandwidth and a DRU allocation from a plurality of DRU allocations in a tone plan, where each of the plurality of DRU allocations includes respective subcarriers, whereby subcarriers of the determined DRU allocation are interleaved with subcarriers of one or more other DRU allocations of the plurality of DRU allocations, across the distribution bandwidth; (2) determining a first DRU LTF sequence of length 26 for the determined DRU allocation, wherein the first DRU LTF sequence includes data subcarrier tones and pilot subcarrier tones; (3) determining, from the first DRU LTF sequence, a second DRU LTF sequence of length 26 for the determined DRU allocation, wherein the second DRU LTF sequence includes data subcarrier tones that are the same as the data subcarrier tones of the first DRU LTF sequence and pilot subcarrier tones that are a phase inverted version of the pilot subcarrier tones of the first DRU LTF sequence; and (4) transmitting a frame, to an AP (or a non-AP STA), using the determined DRU allocation, the frame including a PHY preamble including the first and the second DRU LTF sequences, where the first or the second DRU LTF sequences include a smallest PARP compared to other DRU LTF sequences of length 26.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a non-access point (AP) station (STA), the method comprising:
receiving information indicating a distribution bandwidth and a set of distributed resource units (DRUs) from a plurality of DRU allocations for the distribution bandwidth, wherein each DRU of the set of DRUs includes respective subcarriers, wherein subcarriers of the set of DRUs are interleaved with respect to each other;
determining a first DRU long training field (LTF) sequence associated with a first DRU of the set of DRUs, wherein the first DRU LTF sequence includes a first component and at least a second component, wherein the first component and the at least second component are a first complementary sequence based on a Golay complementary pair (GCP);
determining a second DRU LTF sequence associated with a second DRU of the set of DRUs, wherein the second DRU LTF sequence includes a third component and at least a fourth component, wherein the third component and the at least fourth component are a second complementary sequence based on the GCP; and
transmitting, to an AP, a frame including a physical layer (PHY) preamble including the first DRU LTF sequence and the second DRU LTF sequence, wherein the first DRU LTF sequence and the second DRU LTF sequence are associated with a third DRU having a size based on the first and the second DRUs.

2. The method of claim 1, wherein:
the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}); and
the second complementary sequence based on the GCP comprises a seed GCP including complimentary seed sequences (sₐ, s_{b}), wherein each of the complimentary seed sequences is respectively multiplied by a second complex number (w_{a,2}) and a third complex number (w_{b,2});
wherein the first and the second complementary sequences are a complementary pair.

3. The method of claim 2, wherein sₐ=(1, 1, 1, 1i, −1, 1, 1, −1i,1, −1, 1,−1i,1i) and s_{b}=(1 1i−1−1−11i−1 11−1i−1 1−1i).

4. The method of claim 1, wherein the distribution bandwidth is one of 20 megahertz (Mhz), 40 MHz, or 80 MHz.

5. The method of claim 1, wherein the first DRU is a 26-tone DRU, the second DRU is a 26-tone DRU, and the third DRU is a 52-tone DRU.

6. A method for use in an AP, the method comprising:
transmitting, to a non-AP station (STA), information indicating a distribution bandwidth and a set of distributed resource units (DRUs) from a plurality of DRU allocations for the distribution bandwidth, wherein each DRU of the set of DRUs includes respective subcarriers, wherein subcarriers of the set of DRUs are interleaved with respect to each other; and
receiving, from the non-AP STA, a frame including a physical layer (PHY) preamble including a first DRU LTF sequence and a second DRU LTF sequence, wherein the first DRU LTF sequence and the second DRU LTF sequence are associated with a third DRU having a size based on the first and the second DRUs; wherein the first DRU LTF sequence is associated with a first DRU of the set of DRUs, wherein the first DRU LTF sequence includes a first component and at least a second component, wherein the first component and the at least second component are a first complementary sequence based on a Golay complementary pair (GCP); wherein the second DRU LTF sequence is associated with a second DRU of the set of DRUs, wherein the second DRU LTF sequence includes a third component and at least a fourth component, wherein the third component and the at least fourth component are a second complementary sequence based on the GCP.

7. The method of claim 6, wherein:
the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}); and
the second complementary sequence based on the GCP comprises a seed GCP including complimentary seed sequences (sₐ, s_{b}), wherein each of the complimentary seed sequences is respectively multiplied by a second complex number (w_{a,2}) and a third complex number (w_{b,2});
wherein the first and the second complementary sequences are a complementary pair.

8. The method of claim 7, wherein sₐ=(1, 1, 1, 1i, −1, 1, 1, −1i,1, −1, 1,−1i,1i) and s_{b}=(1 1i−1−1−11i−1 11−1i−1 1−1i).

9. The method of claim 6, wherein the distribution bandwidth is one of 20 megahertz (Mhz), 40 MHz, or 80 MHz.

10. The method of claim 6, wherein the first DRU is a 26-tone DRU, the second DRU is a 26-tone DRU, and the third DRU is a 52-tone DRU.

11. A non-access point (AP) station (STA) comprising:
a processor; and
a transceiver operatively coupled to the processor; wherein:
the transceiver is configured to receive information indicating a distribution bandwidth and a set of distributed resource units (DRUs) from a plurality of DRU allocations for the distribution bandwidth, wherein each DRU of the set of DRUs includes respective subcarriers, wherein subcarriers of the set of DRUs are interleaved with respect to each other;
the processor is configured to determine a first DRU long training field (LTF) sequence associated with a first DRU of the set of DRUs, wherein the first DRU LTF sequence includes a first component and at least a second component, wherein the first component and the at least second component are a first complementary sequence based on a Golay complementary pair (GCP);
the processor is configured to determine a second DRU LTF sequence associated with a second DRU of the set of DRUs, wherein the second DRU LTF sequence includes a third component and at least a fourth component, wherein the third component and the at least fourth component are a second complementary sequence based on the GCP; and
the transceiver and the processor are configured to transmit, to an AP, a frame including a physical layer (PHY) preamble including the first DRU LTF sequence and the second DRU LTF sequence, wherein the first DRU LTF sequence and the second DRU LTF sequence are associated with a third DRU having a size based on the first and the second DRUs.

12. The non-AP STA of claim 11, wherein:
the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}); and
the second complementary sequence based on the GCP comprises a seed GCP including complimentary seed sequences (sₐ, s_{b}), wherein each of the complimentary seed sequences is respectively multiplied by a second complex number (w_{a,2}) and a third complex number (w_{b,2});
wherein the first and the second complementary sequences are a complementary pair.

13. The method of claim 12, wherein sₐ=(1, 1, 1, 1i, −1, 1, 1, −1i,1, −1, 1,−1i,1i) and s_{b}=(1 1i−1−1−11i−1 11−1i−1 1−1i).

14. The method of claim 11, wherein the distribution bandwidth is one of 20 megahertz (Mhz), 40 MHz, or 80 MHz.

15. The method of claim 11, wherein the first DRU is a 26-tone DRU, the second DRU is a 26-tone DRU, and the third DRU is a 52-tone DRU.

16. An access point (AP) comprising:
a processor; and
a transceiver operatively coupled to the processor; wherein:
the processor and the transceiver are configured to transmit, to a non-AP station (STA), information indicating a distribution bandwidth and a set of distributed resource units (DRUs) from a plurality of DRU allocations for the distribution bandwidth, wherein each DRU of the set of DRUs includes respective subcarriers, wherein subcarriers of the set of DRUs are interleaved with respect to each other; and
the transceiver is configured to receive, from the non-AP STA, a frame including a physical layer (PHY) preamble including a first DRU LTF sequence and a second DRU LTF sequence, wherein the first DRU LTF sequence and the second DRU LTF sequence are associated with a third DRU having a size based on the first and the second DRUs; wherein the first DRU LTF sequence is associated with a first DRU of the set of DRUs, wherein the first DRU LTF sequence includes a first component and at least a second component, wherein the first component and the at least second component are a first complementary sequence based on a Golay complementary pair (GCP); wherein the second DRU LTF sequence is associated with a second DRU of the set of DRUs, wherein the second DRU LTF sequence includes a third component and at least a fourth component, wherein the third component and the at least fourth component are a second complementary sequence based on the GCP.

17. The AP of claim 16, wherein:
the first complementary sequence based on the GCP comprises a seed GCP including complimentary seed sequences (sₐ, s_{b}), wherein each of the complimentary seed sequences is respectively multiplied by a first complex number (w_{a, 1}) and a second complex number (w_{b, 1}); and
the second complementary sequence based on the GCP comprises a seed GCP including complimentary seed sequences (sₐ, s_{b}), wherein each of the complimentary seed sequences is respectively multiplied by a second complex number (w_{a,2}) and a third complex number (w_{b,2});
wherein the first and the second complementary sequences are a complementary pair.

18. The AP of claim 17, wherein sₐ=(1, 1, 1, 1i, −1, 1, 1, −1i,1, −1, 1,−1i,1i) and s_{b}=(1 1i−1−1−11i−1 11−1i−1 1−1i).

19. The AP of claim 16, wherein the distribution bandwidth is one of 20 megahertz (Mhz), 40 MHz, or 80 MHz.

20. The AP of claim 16, wherein the first DRU is a 26-tone DRU, the second DRU is a 26-tone DRU, and the third DRU is a 52-tone DRU.
